(19) United States
(12) Patent Application Publication
(10) Pub. No.: US 2014/0360744 A1
(43) Pub. Date: Dec. 11, 2014

(54) HANDHELD PNEUMATIC TOOLS HAVING PRESSURE REGULATOR

(71) Applicant: Campbell Hausfeld / Scott Fetzer Company, Harrison, OH (US)

(72) Inventor: Bobby Lynn Lawrence, Palmetto, FL (US)

(73) Assignee: Campbell Hausfeld / Scott Fetzer Company, Harrison, OH (US)

(21) Appl. No.: 14/279,789

(22) Filed: May 16, 2014

Related U.S. Application Data
(60) Provisional application No. 61/831,367, filed on Jun. 5, 2013.

(51) Int. Cl. B25B 21/02; B25B 23/145; B25B 23/14; B25D 9/12; B25D 9/16

(52) U.S. Cl. CPC B25B 21/02; B25D 9/12; B25D 9/16; B25B 23/1405; B25B 23/1453
USPC 173/109; 173/218

(57) ABSTRACT

A handheld pneumatic tool includes an air supply port and a pressure regulator. The pressure regulator is configured to regulate the pressurized air and discharge regulated, pressurized air at a substantially constant pressure.

### REFERENCE TO RELATED APPLICATION

This application claims priority of U.S. provisional patent application Ser. No. 61/831,367, entitled HANDHELD PNEUMATIC TOOLS HAVING PRESSURE REGULATOR, filed Jun. 5, 2013, and hereby incorporates this provisional patent application by reference herein in its entirety.

### TECHNICAL FIELD

This application relates generally to a handheld pneumatic tool for applying torque to an object.

### BACKGROUND

A handheld impact driver has a rotary vane motor and a torquing member for driving a fastener to a desired torque value.

### SUMMARY

In accordance with one embodiment, a handheld impact driver comprises an air supply port, a manifold assembly positioned downstream of the air supply port, and a pressure regulator positioned downstream of the manifold assembly. The air supply port is configured for connection to an external source of pressurized air. The manifold assembly comprises a manifold, and the manifold defines a manifold inlet port. The manifold inlet port is in selective fluid communication with the air supply port. The pressure regulator comprises a housing and a diaphragm assembly movably coupled with the housing. The housing and the diaphragm assembly cooperate to define a discharge chamber. The housing at least partially defines an inlet chamber, and the inlet chamber and the discharge chamber are in at least intermittent fluid communication. When the manifold assembly is in a first configuration, the manifold inlet port is in fluid communication with the inlet chamber defined by the pressure regulator to permit the flow of pressurized air to the inlet chamber. The pressure regulator is operable to regulate the pressurized air and discharge regulated, pressurized air at a substantially constant, predetermined pressure. When the manifold assembly is in a second configuration, the pressure regulator is bypassed.

In accordance with another embodiment, a handheld impact driver comprises an air supply port, a manifold assembly positioned downstream of the air supply port, a pressure regulator positioned downstream of the manifold assembly, a rotary vane motor, a torquing member, a needle valve, and indicia associated with the needle valve. The air supply port is configured for connection to an external source of pressurized air. The manifold assembly comprises a manifold, and the manifold defines a manifold inlet port. The manifold inlet port is in selective communication with the air supply port. The pressure regulator comprises a regulator valve assembly and is operable for discharging regulated, pressurized air at a substantially constant, predetermined pressure. The rotary vane motor comprises a rotor, and the torquing member is drivingly coupled with the rotor of the rotary vane motor. The needle valve comprises a restricting member that is downstream of the regulator valve assembly and upstream of the rotary vane motor. The needle valve facilitates control of a flow rate of regulated, pressured air discharging from the pressure regulator at a substantially constant, predetermined pressure. The regulated, pressurized air operably impinges upon the rotor, causing the rotor and the torquing member to rotate in a first direction. The indicia associated with the needle valve provide an indication of an available torque for application to a work piece by the torquing member.

In accordance with yet another embodiment, a handheld impact driver comprises an air supply port, a manifold assembly positioned downstream of the air supply port, a pressure regulator positioned downstream of the manifold assembly, a rotary vane motor positioned downstream of the pressure regulator, a torquing member, and a collar. The air supply port is configured for connection to an external source of pressurized air. The manifold assembly comprises a manifold, and the manifold defines a manifold inlet port. The manifold inlet port is in selective fluid communication with the air supply port. The pressure regulator comprises a regulator valve assembly and is operable for discharging regulated, pressurized air at a substantially constant, predetermined pressure. The rotary vane motor comprises a rotor, and the torquing member is drivingly coupled with the rotor of the rotary vane motor. The collar is rotatably coupled with the manifold and is operable for facilitating selective control of a direction of rotation of the torquing member and selective control of an available torque output of the torquing member.

In accordance with still another embodiment, a handheld pneumatic tool comprises an air supply port, a manifold assembly positioned downstream of the air supply port, and a pressure regulator positioned downstream of the manifold assembly. The air supply port is configured for connection to an external source of pressurized air. The manifold assembly comprises a manifold. The manifold defines a manifold inlet port. The manifold inlet port is in selective fluid communication with the air supply port. The pressure regulator comprises a housing, a diaphragm assembly, and at least one Belleville spring. The housing and the diaphragm assembly cooperate to define a discharge chamber. The housing at least partially defines an inlet chamber. The manifold inlet port is in selective fluid communication with the inlet chamber. The diaphragm assembly is movable relative to the housing in response to at least a first biasing force exerted by the at least one Belleville spring on the diaphragm assembly and a differential pressure across the diaphragm assembly. The inlet chamber and the discharge chamber are in at least intermittent fluid communication. The pressure regulator operably discharges regulated, pressurized air at a substantially constant pressure from the discharge chamber.

In accordance with still another embodiment, a handheld impact driver comprises an air supply port, a manifold assembly, an end cap, and a pressure regulator. The air supply port is configured for connection to an external source of pressurized air. The manifold assembly is positioned downstream of the air supply port. The manifold assembly comprises a manifold. The manifold defines a manifold inlet port. The manifold inlet port is in selective fluid communication with the air supply port. The pressure regulator is positioned downstream of the manifold assembly. The pressure regulator comprises a housing and a diaphragm assembly. The diaphragm assembly is movably coupled with the housing and the end cap. The end cap and the diaphragm assembly cooperate to define a discharge chamber. The housing at least partially defines an inlet chamber. The inlet chamber and the discharge chamber are in at least intermittent fluid communication. When the manifold assembly is in a first configuration, the manifold inlet port is in fluid communication with the inlet chamber defined by the pressure regulator to permit the flow of pressurized air to the inlet chamber, the pressure regulator being operable to regulate the pressurized air and discharge regulated, pressurized air at a substantially constant, predetermined pressure. When the manifold assembly is in a second configuration, the pressure regulator is bypassed.

In accordance with still another embodiment, a handheld pneumatic tool comprises a hollow hand grip, a trigger valve assembly, a trigger and a regulator assembly. The trigger valve assembly comprises a trigger valve that is movable between one of a closed position and an opened position. The trigger is coupled with the trigger valve. The trigger is configured to facilitate selective operation of the trigger valve in one of the closed position and the opened position. The regulator assembly is disposed within the hollow hand grip. The regulator assembly is upstream of the trigger valve and is configured to discharge pressurized regulated air to the trigger valve assembly.

### BRIEF DESCRIPTION OF THE DRAWINGS

It is believed that certain embodiments will be better understood from the following description taken in conjunction with the accompanying drawings in which:

FIG. 1 is a front perspective view depicting a handheld impact driver in accordance with one embodiment;

FIG. 2 is a cross-sectional view taken along the line 2-2 in FIG. 1, wherein certain components of the handheld impact driver have been removed for clarity of illustration;

FIG. 3 is a partially exploded front perspective view depicting some of the parts of the handheld impact driver of FIG. 1;

FIG. 4 is a front elevational view of a rotary vane motor of the handheld impact driver of FIG. 1, wherein a front cap has been removed for clarity of illustration;

FIG. 5 is a rear elevational view of the rotary vane motor of FIG. 4;

FIG. 6 is a front perspective view of a manifold assembly, a pressure regulator, and a collar, according to one embodiment;

FIG. 7 is an exploded front perspective view depicting some of the parts of FIG. 6;

FIG. 8 is a front elevational view depicting one of the parts of FIGS. 6 and 7;

FIG. 9 is an upper rear perspective view of the part of FIG. 8;

FIG. 10 is a lower front perspective view of the part of FIG. 8;

FIG. 11 is an upper front perspective view of the part of FIG. 8;

FIG. 12 is an upper front perspective view depicting others of the parts of FIGS. 6 and 7;

FIG. 13 is an upper rear perspective view of the parts of FIG. 12;

FIG. 14 is a cross-sectional view taken along the line 14-14 in FIG. 12;

FIG. 15 is a cross-sectional view taken along the line 15-15 in FIG. 12;

FIG. 16 is a cross-sectional view taken along the line 16-16 in FIG. 12;

FIG. 17 is an exploded front perspective view depicting others of the parts of FIG. 6;

FIG. 18 is a cross-sectional view taken along the line 18-18 in FIG. 6 with a valve plug shown in an opened position;

FIG. 19 is similar to FIG. 18 but with the valve plug shown in a closed position;

FIG. 20 is a cross-sectional view taken along the line 20-20 in FIG. 6;

FIG. 21 is a rear perspective view depicting another part of FIG. 6;

FIG. 22 is a front perspective view of the part of FIG. 21;

FIG. 23 is a cross-sectional view taken along the line 23-23 in FIG. 6 with upper and lower porting valves shown in respective regulating positions;

FIG. 24 is similar to FIG. 23 but with the upper and lower porting valves shown in respective bypass positions;

FIG. 25 is a front perspective view depicting yet another one of the parts of FIGS. 6 and 7;

FIG. 26 is a cross-sectional view taken along the line 26-26 in FIG. 1 with a collar shown in a first position;

FIG. 27 is similar to FIG. 26 but with the collar shown in a second position;

FIG. 28 is a cross-sectional view taken along the line 28-28 in FIG. 25;

FIG. 29 is a side elevational view depicting some of the parts of FIG. 6 with other parts removed for clarity of illustration;

FIG. 30 is a front perspective view of a collar, according to another embodiment;

FIG. 31 is a cross-sectional view depicting a handheld impact driver in accordance with another embodiment;

FIG. 32 is a front perspective view of a manifold assembly, a pressure regulator, and a collar, according to one embodiment;

FIG. 33 is an exploded front perspective view depicting some of the parts of FIG. 32;

FIG. 34 is a front plan view depicting some of the parts of FIGS. 32 and 33;

FIG. 35 is rear plan view of the parts of FIG. 34;

FIG. 36 is a perspective cross-sectional view taken along the line 36-36 in FIG. 35;

FIG. 37 is a side elevation cross-sectional view of FIG. 36;

FIG. 38 is a lower front perspective view depicting some of the parts of FIGS. 32 and 33;

FIG. 39 is an upper front perspective view of the part of FIG. 38;

FIG. 40 is a side front perspective view of the part of FIG. 38;

FIG. 41 is a rear perspective view of the part of FIG. 38 and another of the parts from FIGS. 32 and 33;

FIG. 42 is a side elevation cross-sectional view taken along the line 42-42 in FIG. 41;

FIG. 43 is a rear perspective view of the parts of FIG. 41;

FIG. 44 is a perspective view depicting some of the parts of FIG. 33;

FIG. 45 is a cross-sectional view depicting some of the parts of FIG. 31;

FIG. 46 is a front perspective view depicting some of the parts of FIGS. 31 and 45;

FIG. 47 is a rear perspective view depicting another one of the parts of FIGS. 31 and 45;

FIG. 48 is a front upper perspective view depicting another one of the parts of

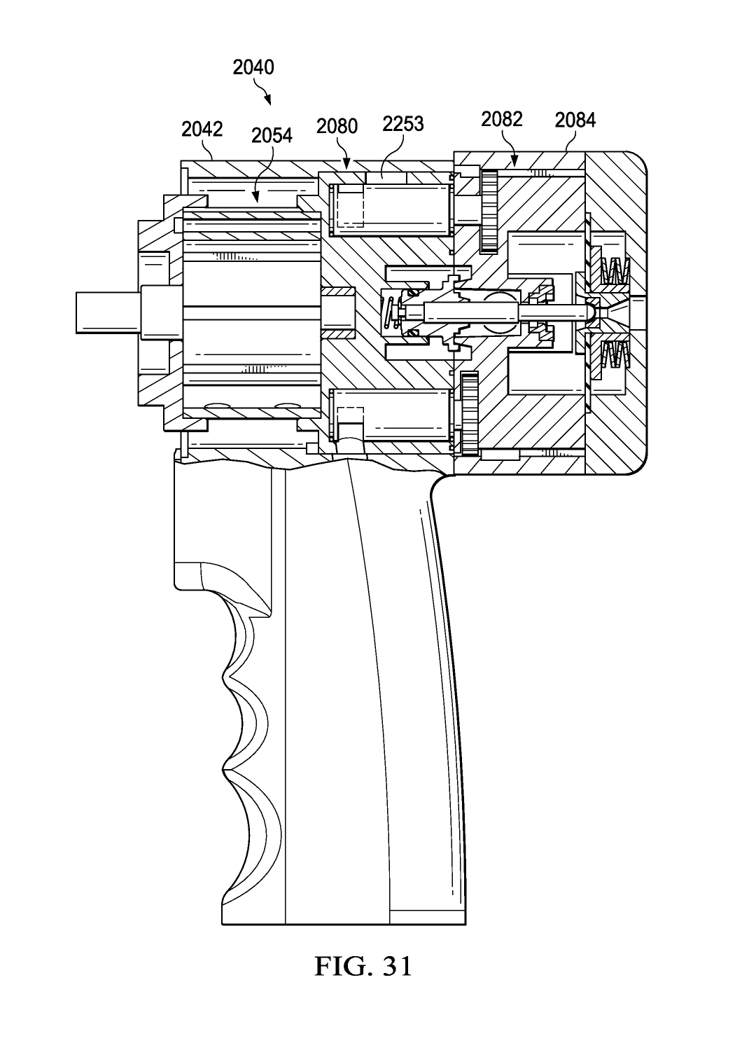

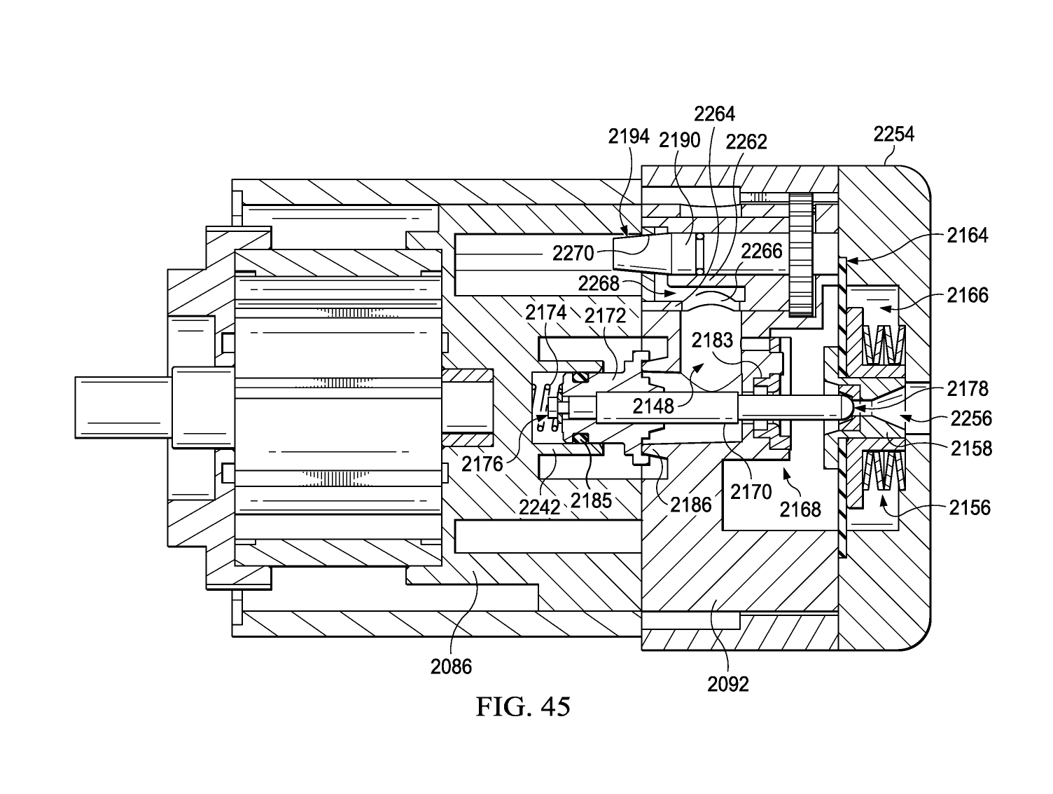

FIGS. 31 and 45;

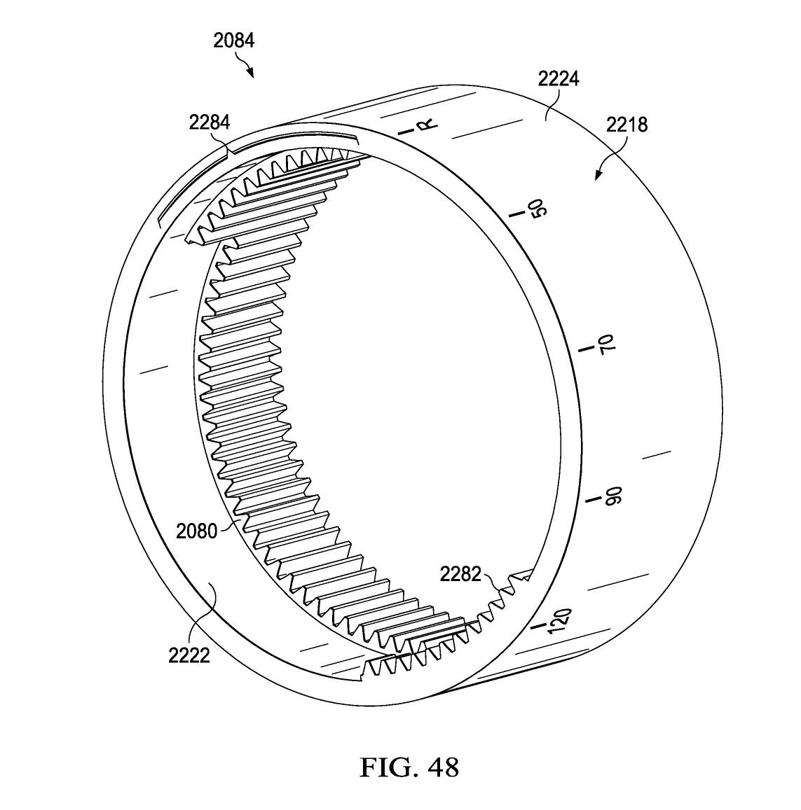

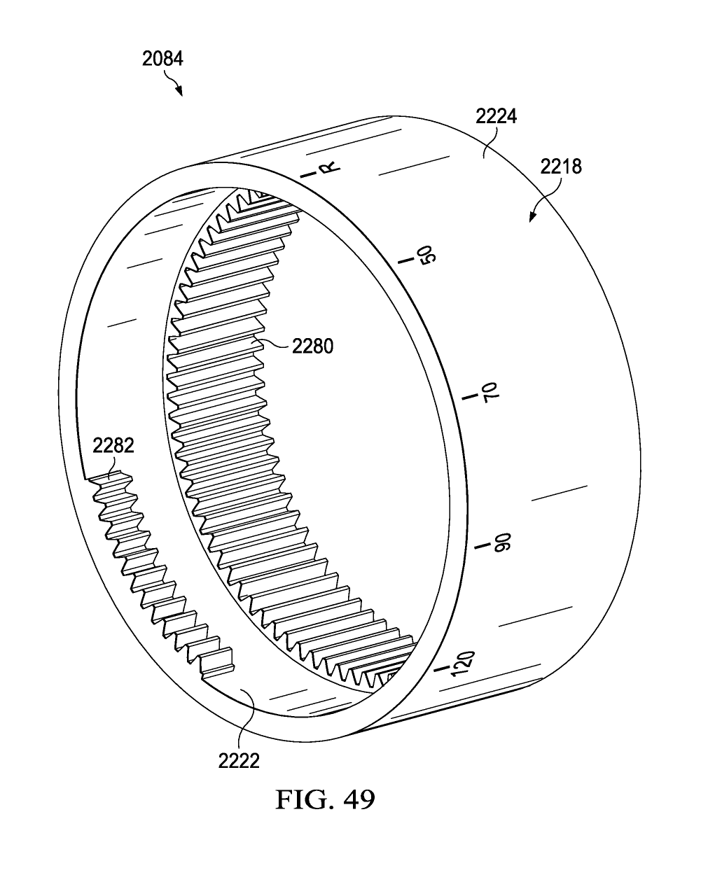

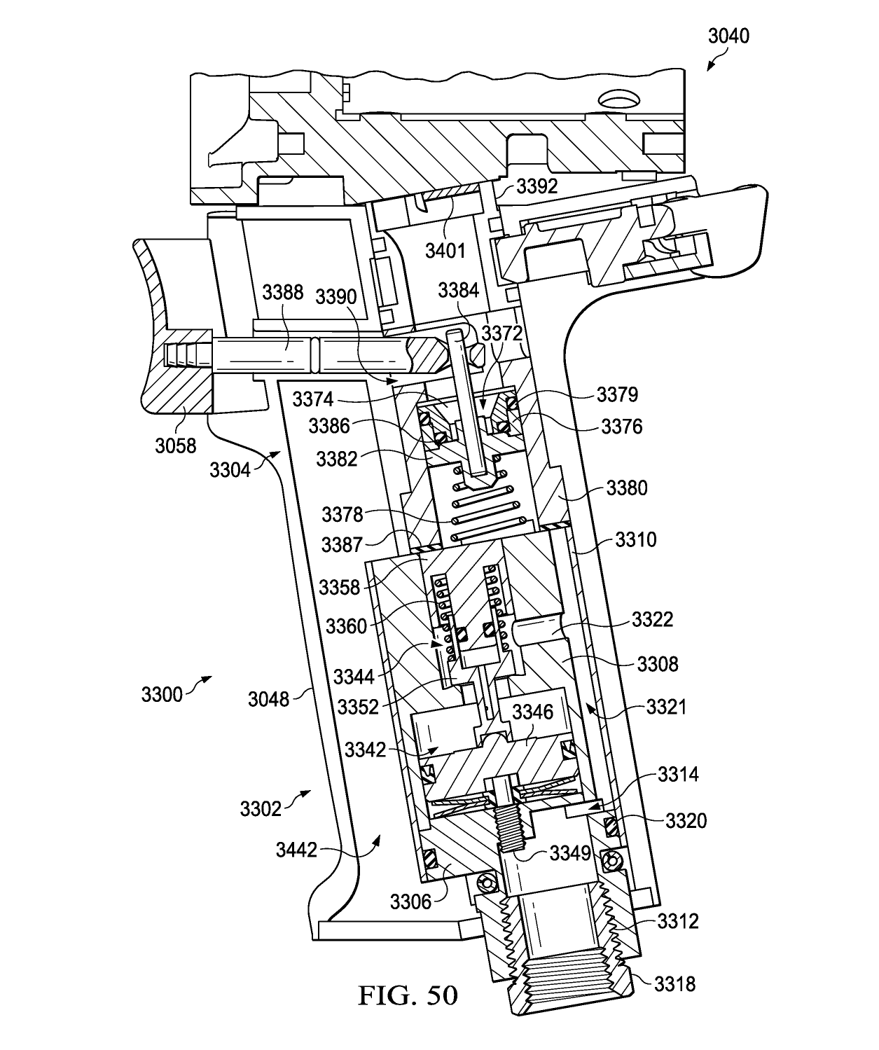

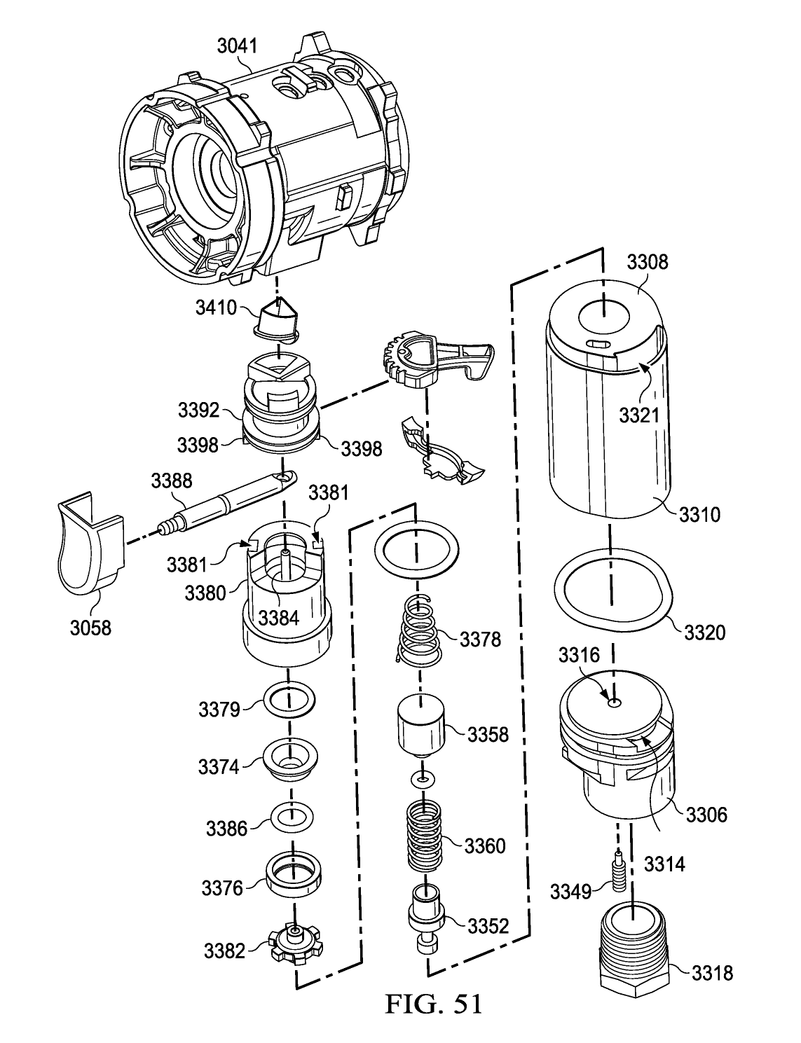

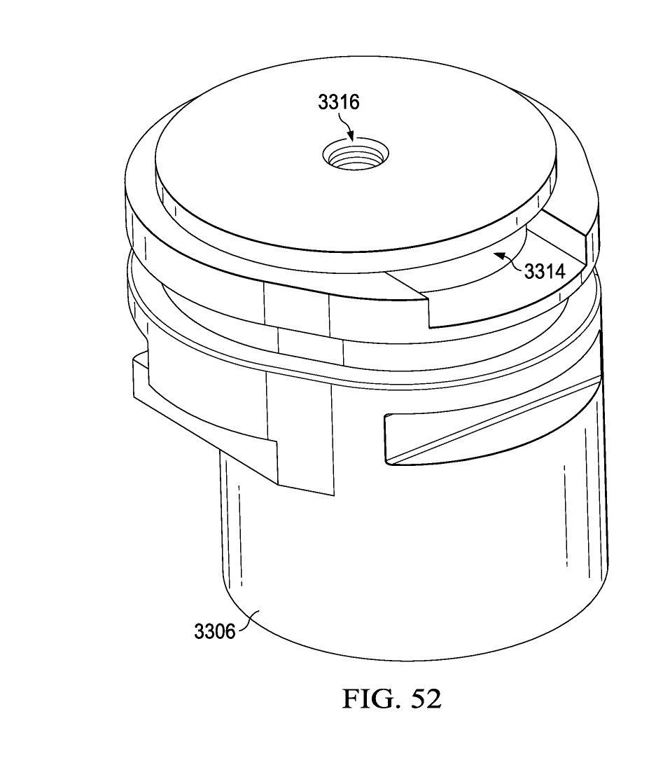

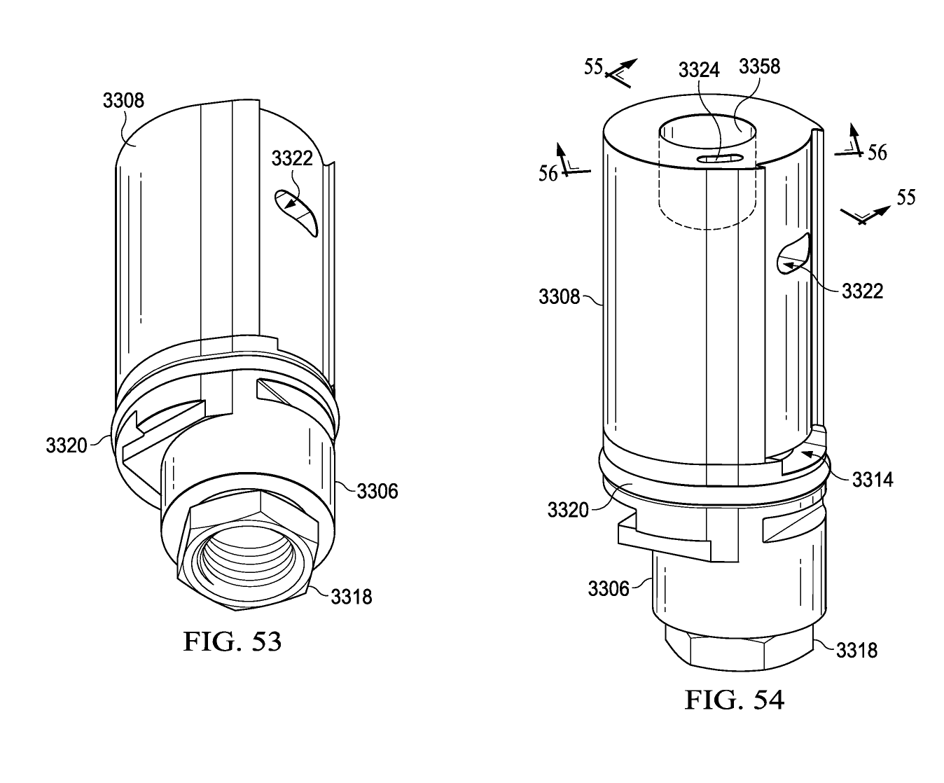

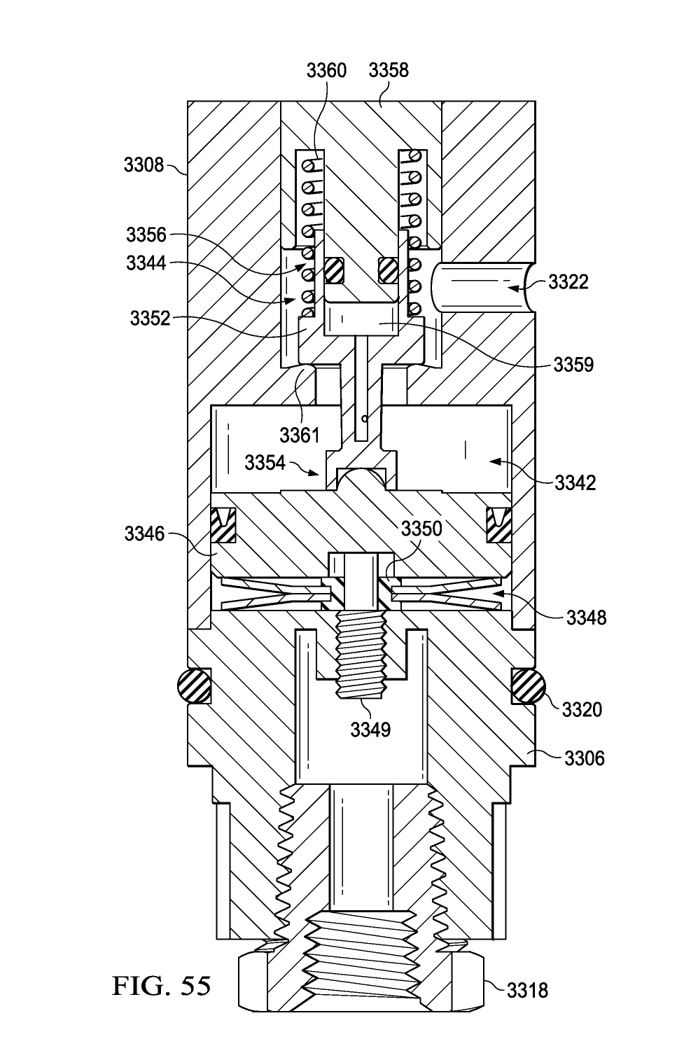

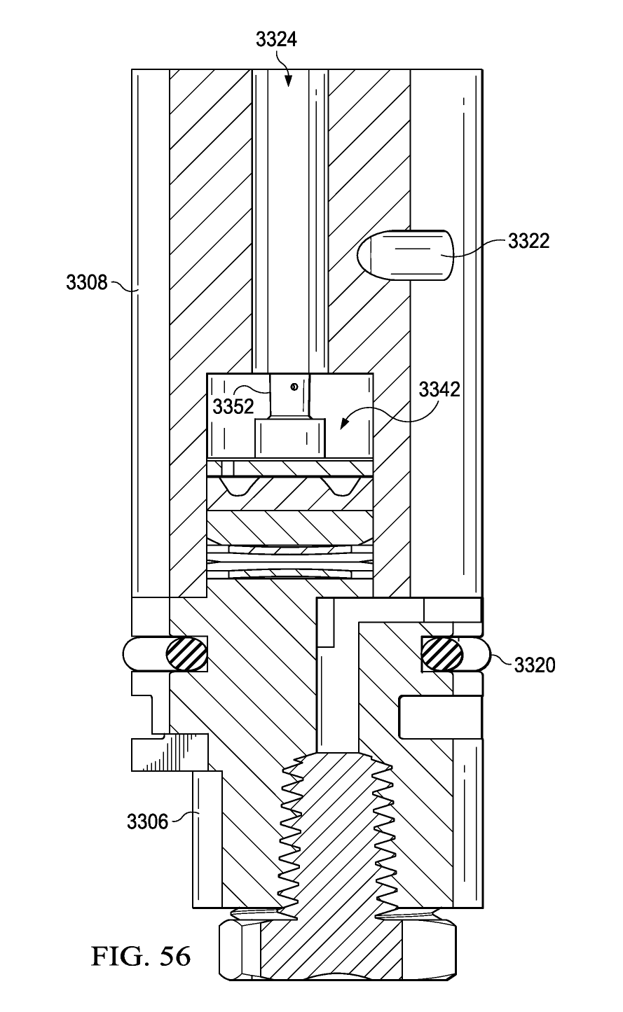

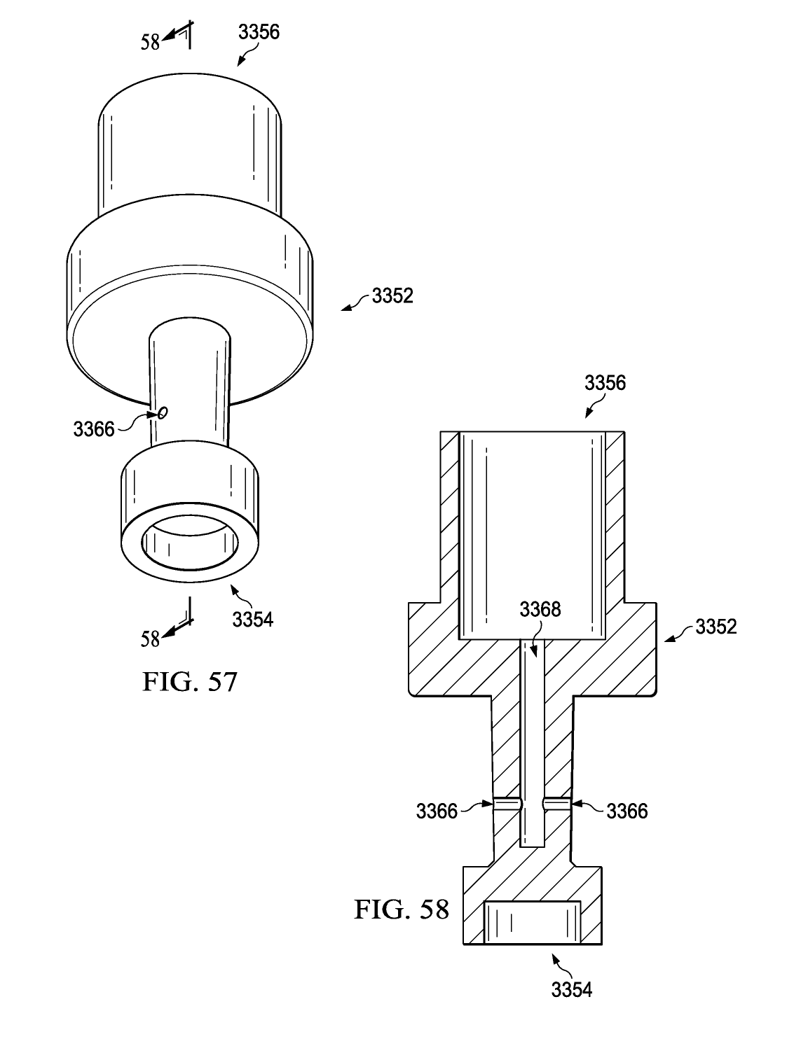

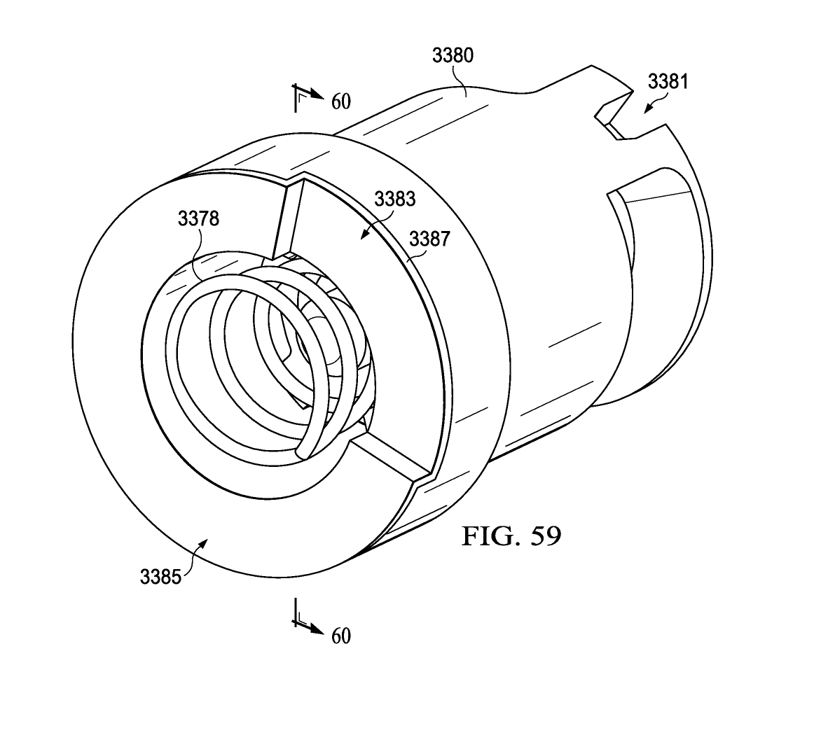

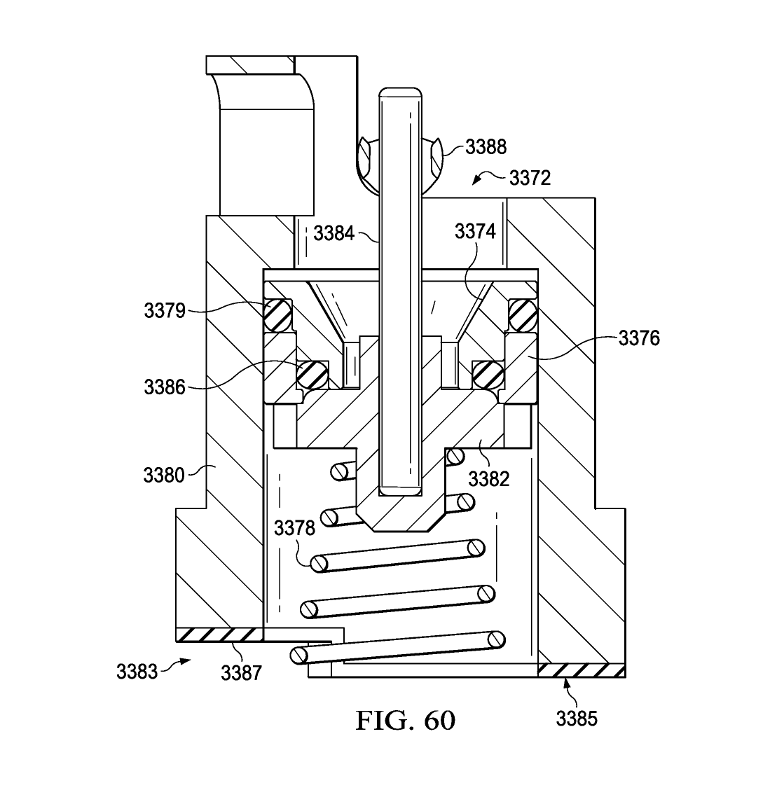

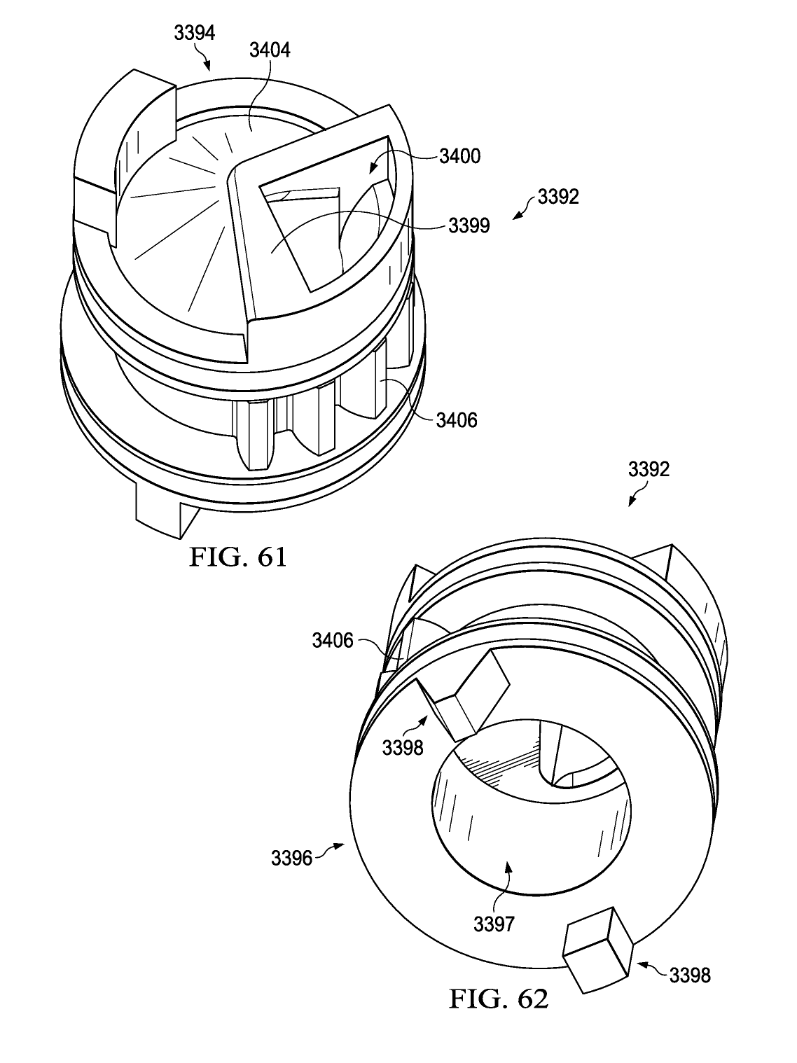

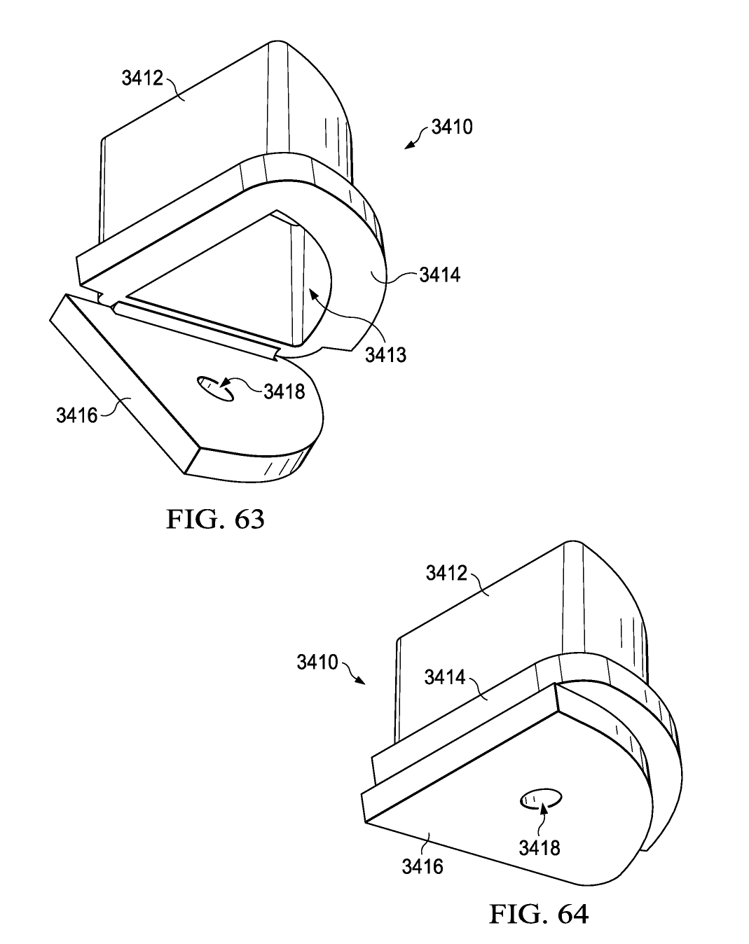

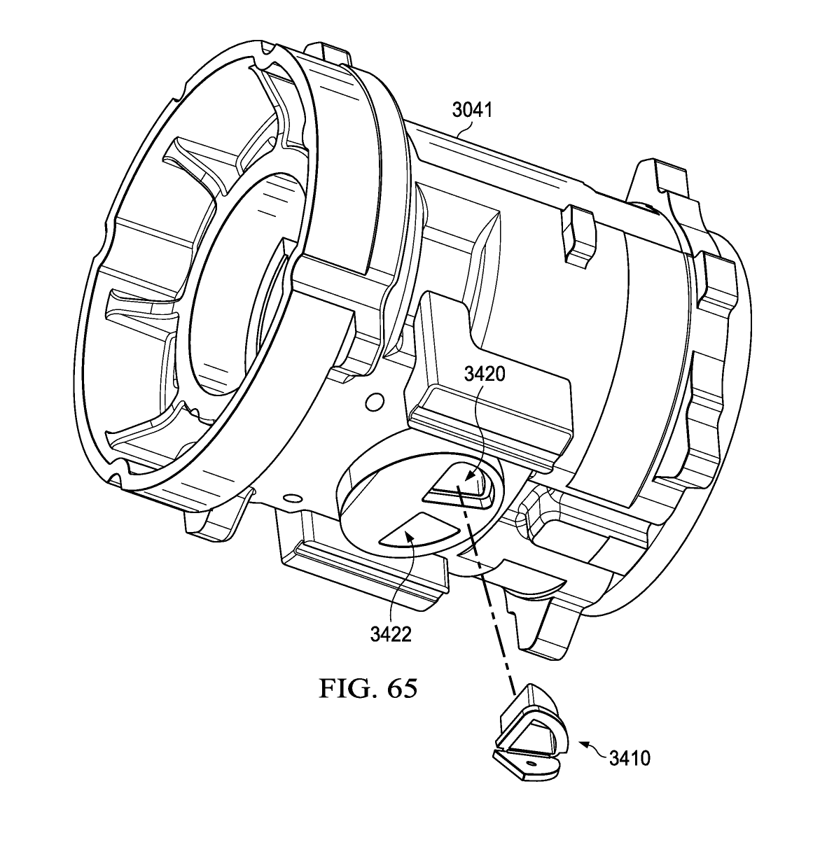

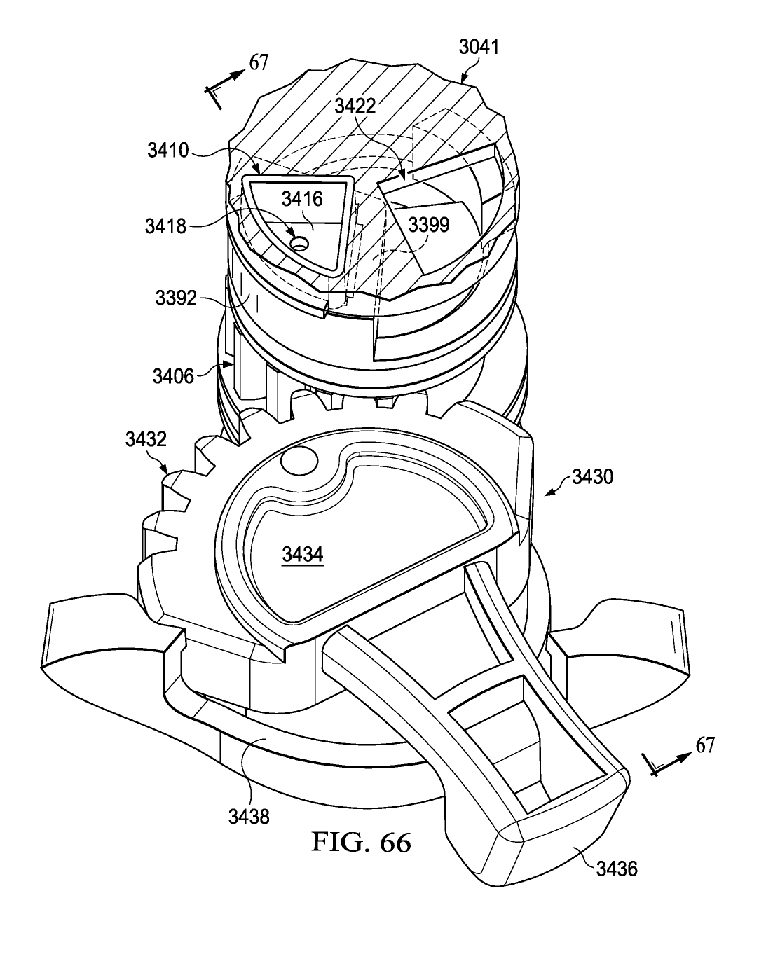

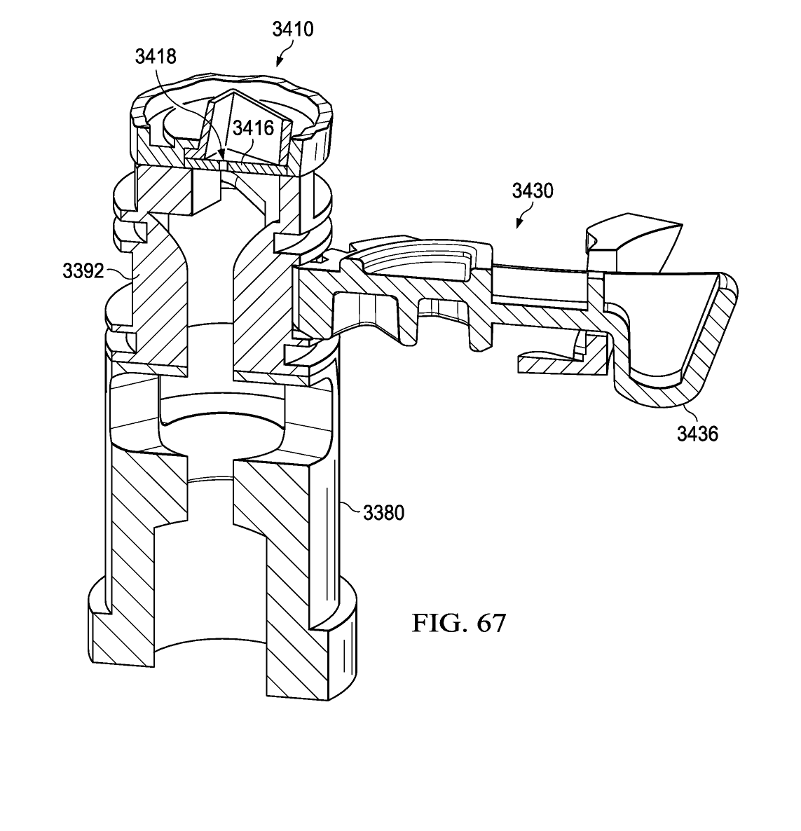

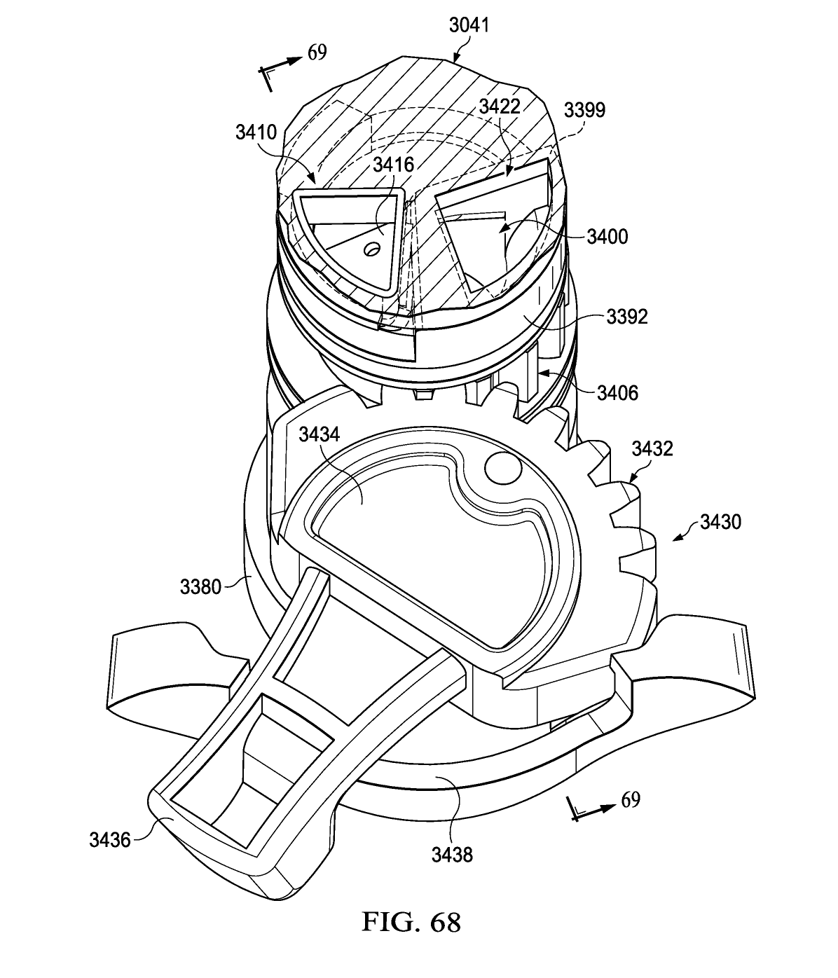

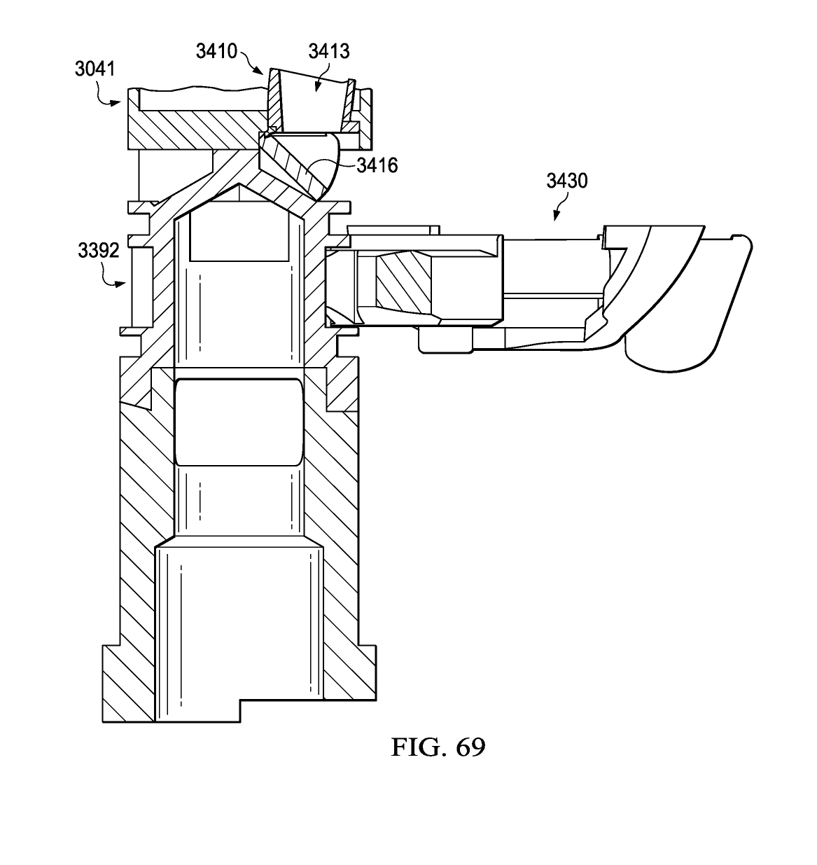

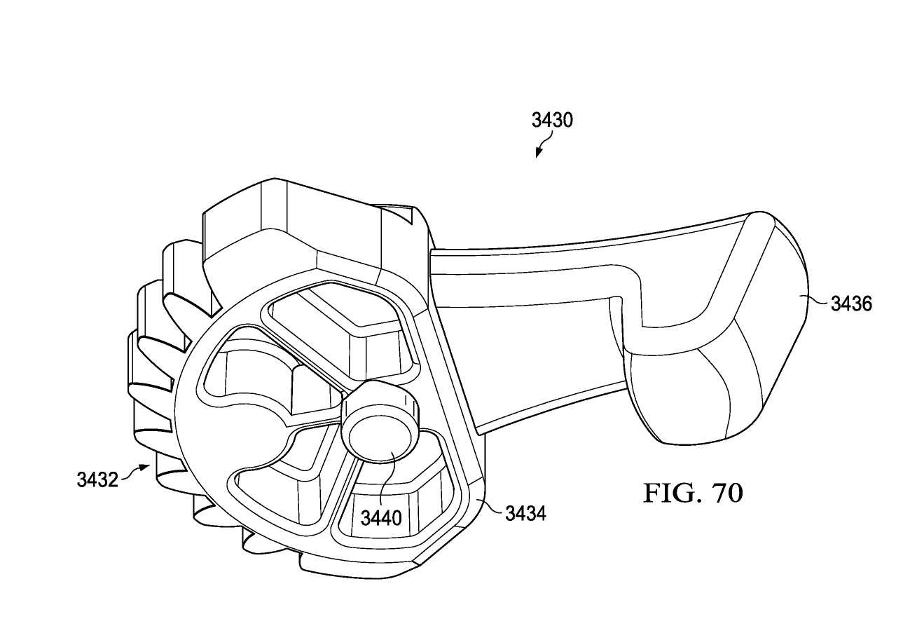

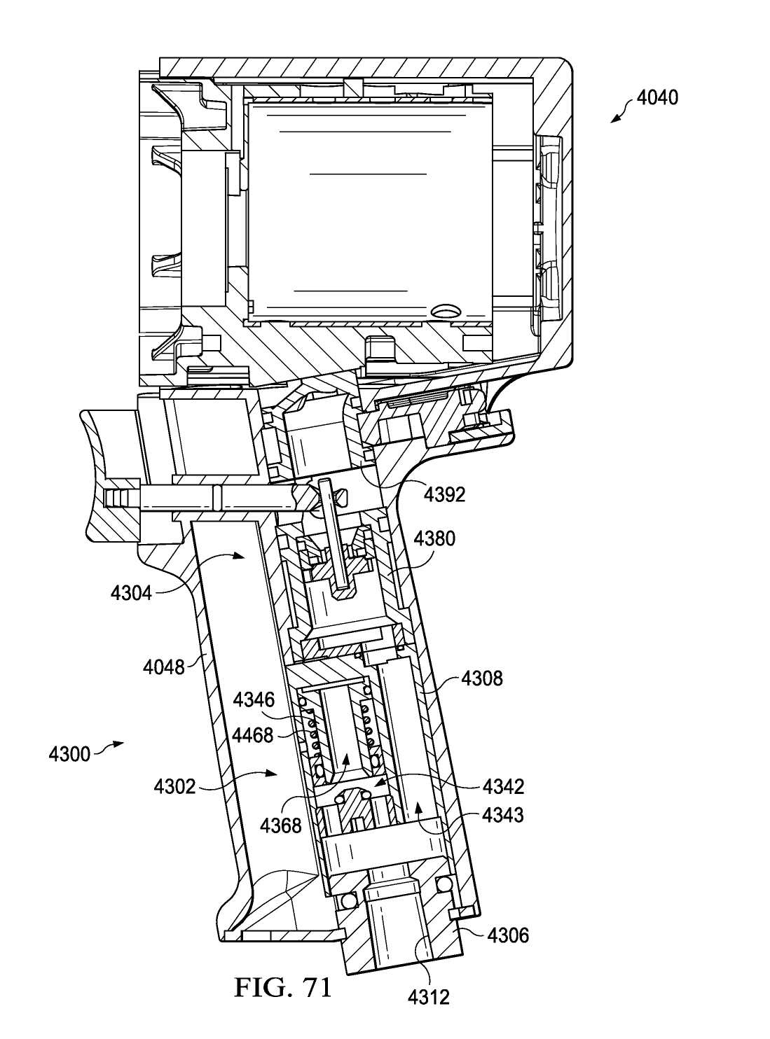

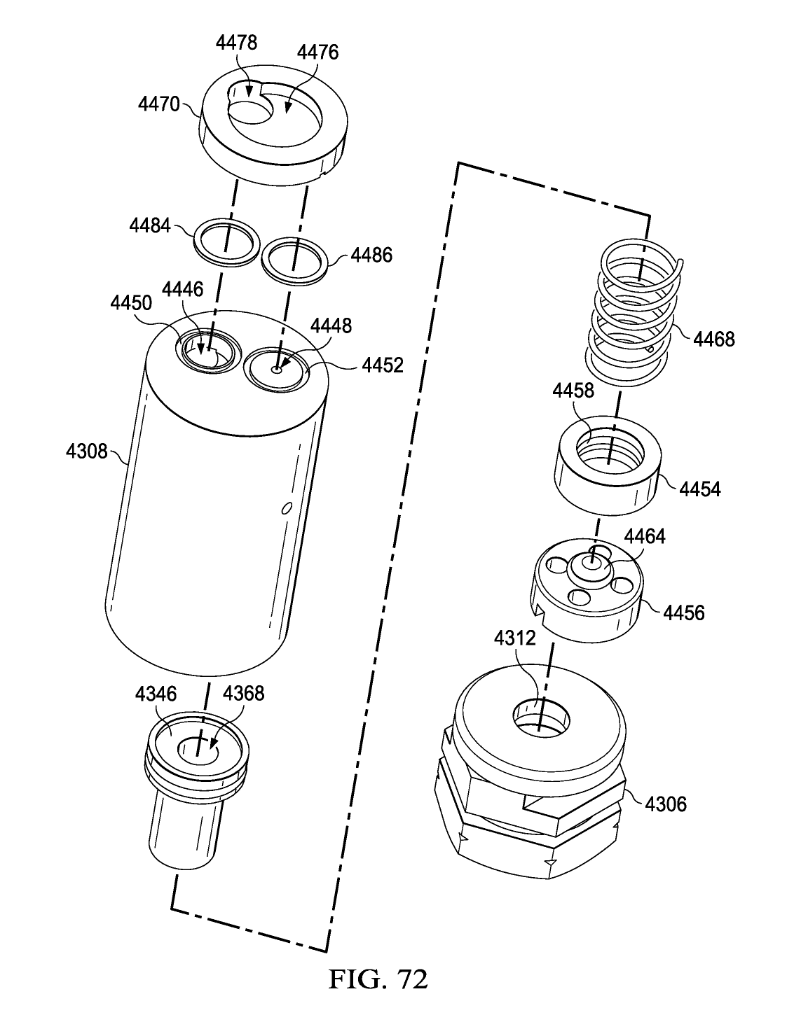

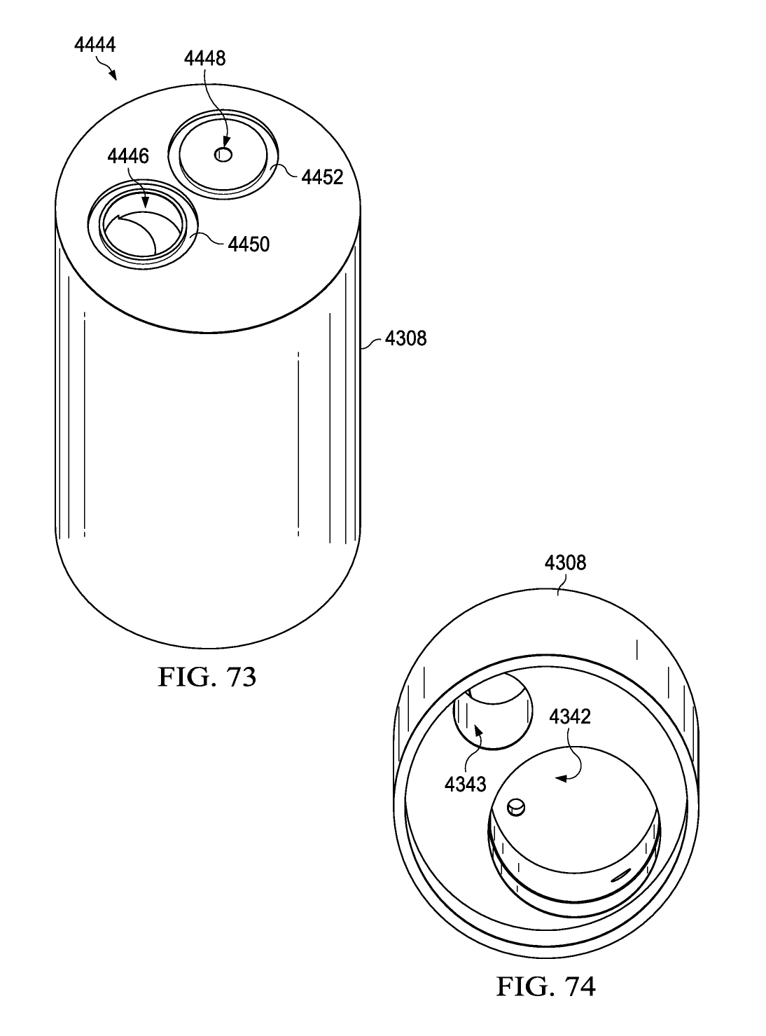

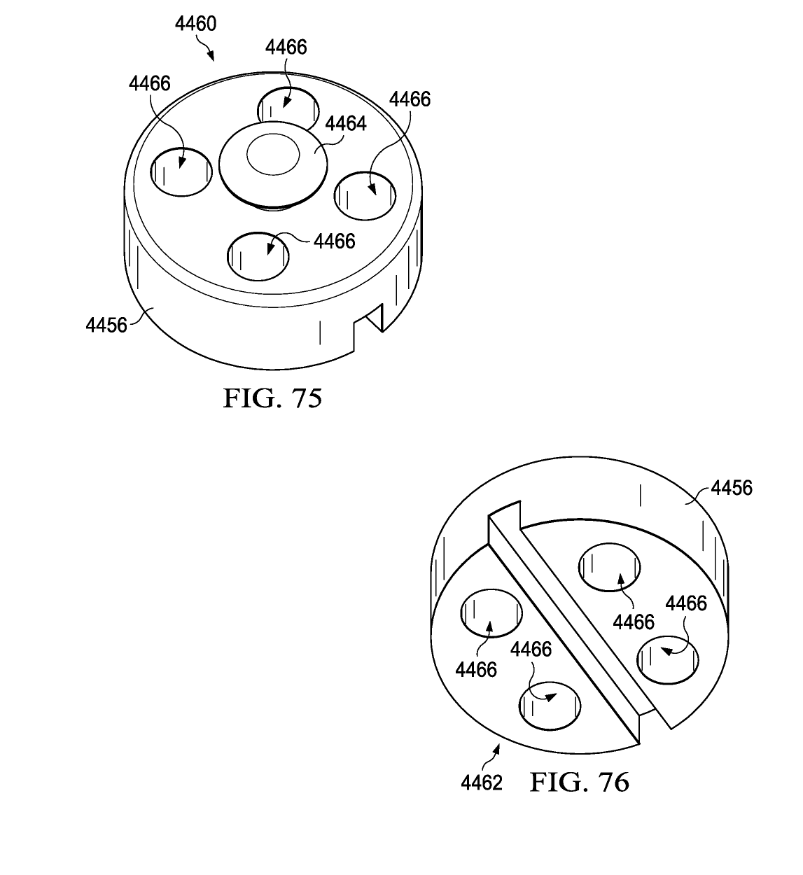

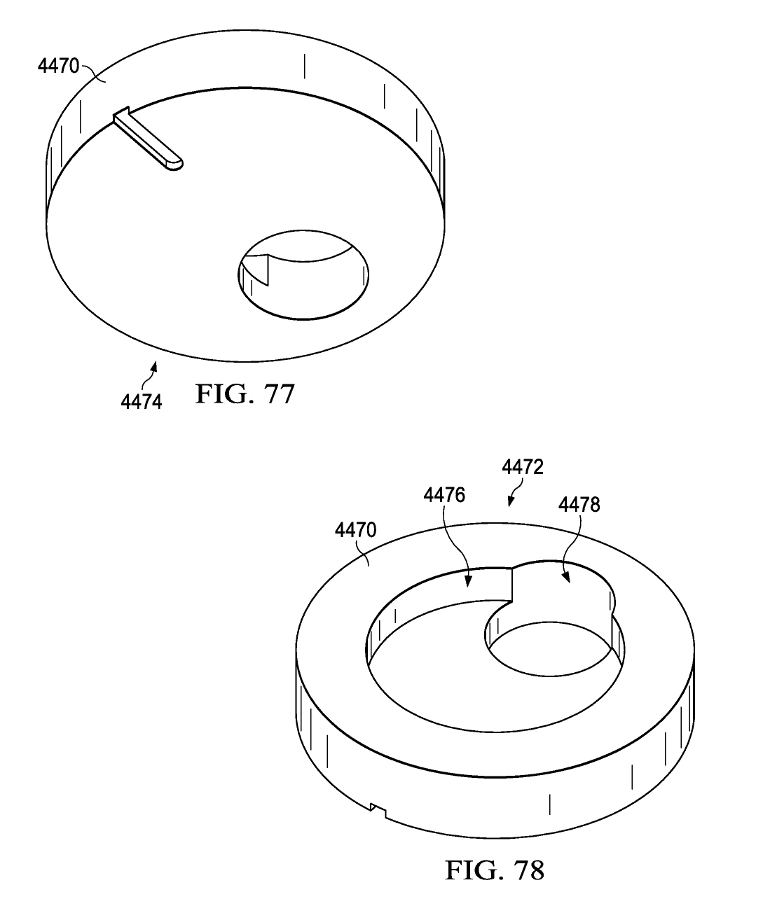

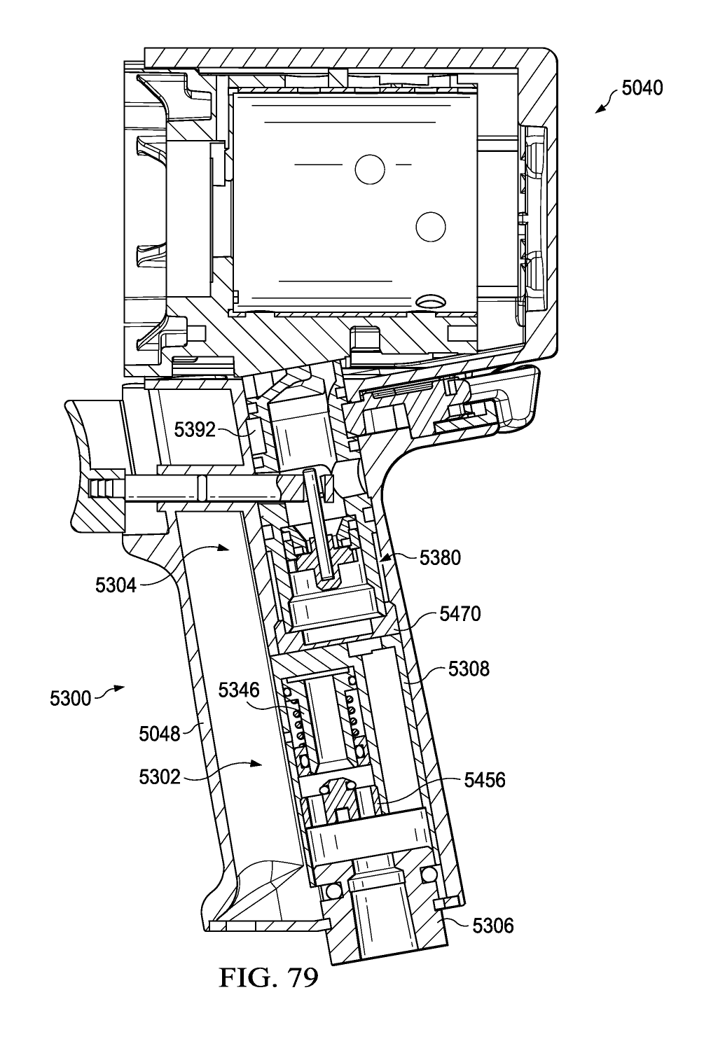

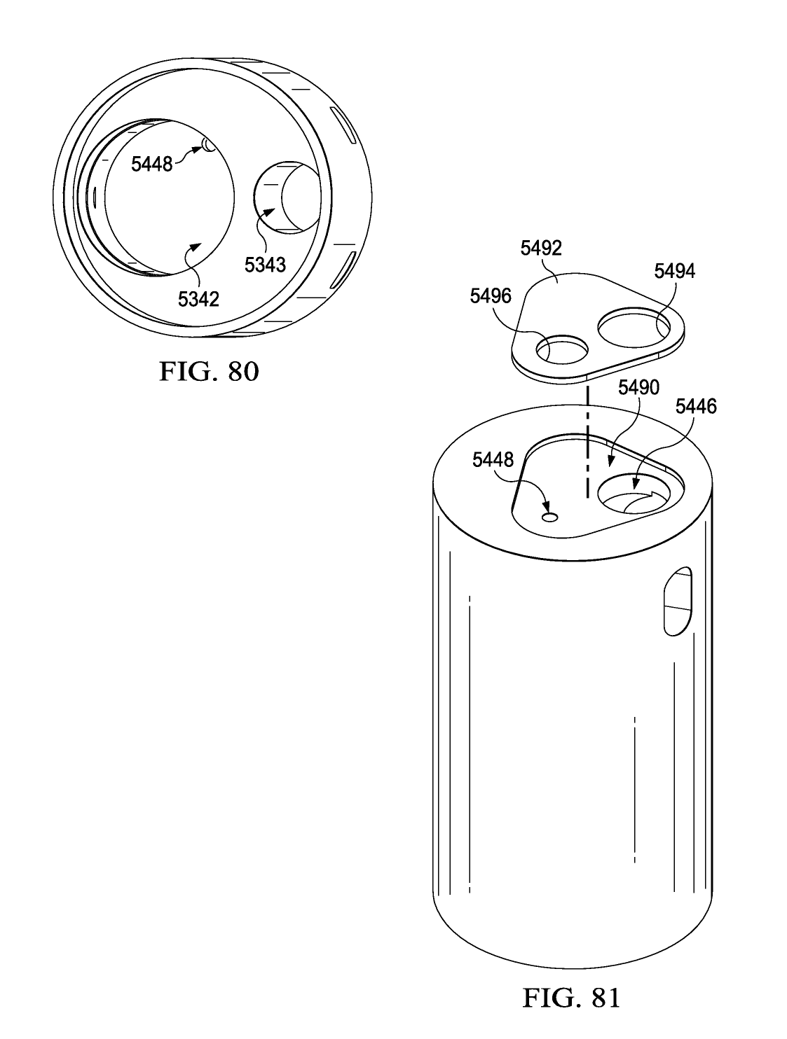

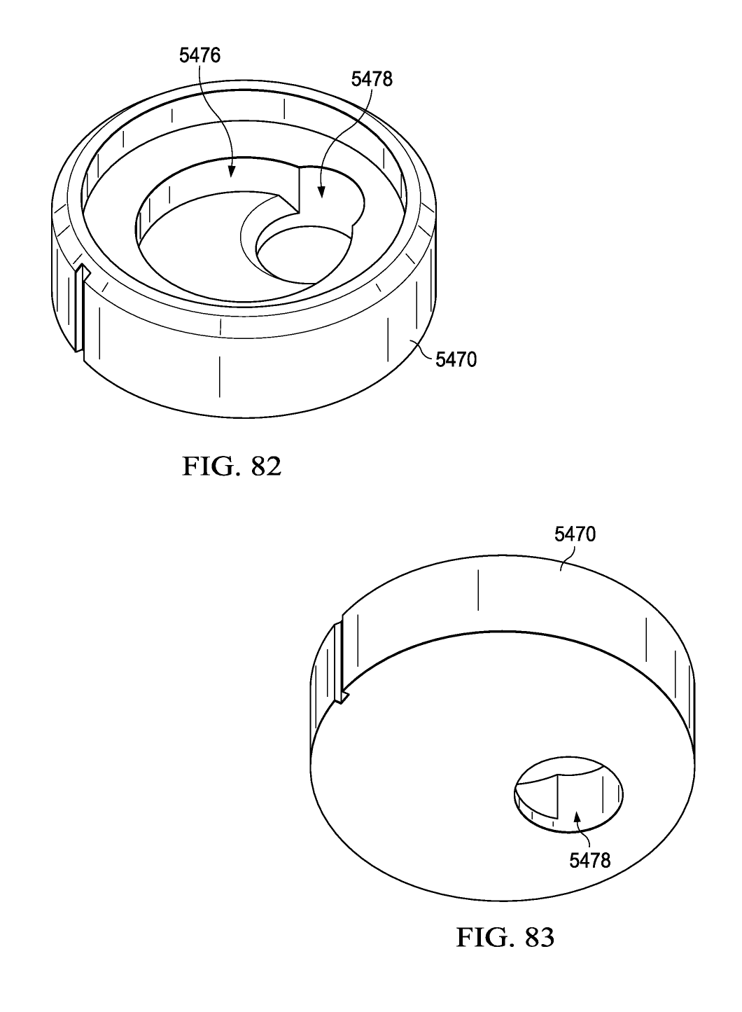

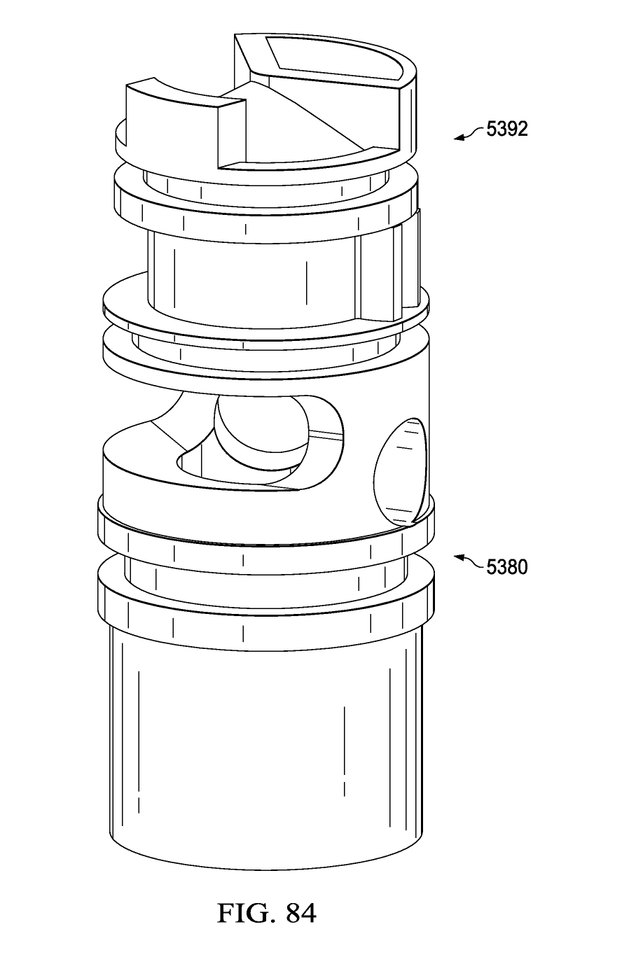

FIG. 49 is a front upper perspective view of the part of FIG. 48;

FIG. 50 is a cross-sectional view depicting a trigger valve assembly associated with a hollow hand grip in accordance with one embodiment;

FIG. 51 is an exploded view depicting some of the parts of the trigger valve assembly of FIG. 50;

FIG. 52 is a perspective view depicting one of the parts of the trigger valve assembly of FIGS. 50 and 51;

FIG. 53 is a lower perspective view depicting some of the parts of the trigger valve assembly of FIGS. 50 and 51;

FIG. 54 is an upper perspective view of the parts of FIG. 53;

FIG. 55 is a cross-sectional view taken along the line 55-55 in FIG. 54;

FIG. 56 is a cross-sectional view taken along the line 56-56 in FIG. 54;

FIG. 57 is a perspective view depicting one of the parts of the trigger valve assembly of FIGS. 50 and 51;

FIG. 58 is a cross-sectional view taken along the line 58-58 in FIG. 57;

FIG. 59 is a lower perspective view depicting some of the parts of the trigger valve assembly of FIGS. 50 and 51;

FIG. 60 is a cross-sectional view taken along the line 60-60 in FIG. 59;

FIG. 61 is an upper perspective view depicting one of the parts of the trigger valve assembly of FIGS. 50 and 51;

FIG. 62 is a lower perspective view of the part of FIG. 61;

FIG. 63 is a perspective view depicting a flapper valve of the trigger valve assembly of FIGS. 50 and 51 with a flapper portion shown in an opened position;

FIG. 64 is a perspective view depicting the flapper valve of FIG. 63 but with the flapper portion shown in a closed position;

FIG. 65 is a perspective view depicting the flapper valve of FIG. 63 in association with a motor casing;

FIG. 66 is a perspective view depicting some of the parts of the trigger valve assembly of FIGS. 50 and 51 with an outlet collar and a housing shown in a forward operating position;

FIG. 67 is a cross-sectional view taken along the line 67-67 in FIG. 66;

FIG. 68 is a perspective view depicting the parts of the trigger valve assembly of

FIG. 66 but with the outlet collar and the housing shown in a reverse operating position;

FIG. 69 is a cross-sectional view taken along the line 69-69 in FIG. 68;

FIG. 70 is a perspective view depicting one of the parts of the trigger valve assembly of FIGS. 50 and 51;

FIG. 71 is a cross-sectional view depicting a handheld impact driver in accordance with another embodiment;

FIG. 72 is an exploded view depicting some of the parts of the handheld impact driver of FIG. 71;

FIG. 73 is an upper perspective view depicting one of the parts of FIGS. 71 and 72;

FIG. 74 is a lower perspective view depicting the part of FIG. 73;

FIG. 75 is an upper perspective view depicting another one of the parts of FIGS. 71 and 72;

FIG. 76 is a lower perspective view depicting the part of FIG. 75;

FIG. 77 is a lower perspective view depicting another one of the parts of FIGS. 71 and 72;

FIG. 78 is an upper perspective view depicting the part of FIG. 77;

FIG. 79 is a cross-sectional view depicting a handheld impact driver in accordance with yet another embodiment;

FIG. 80 is a lower perspective view depicting one of the parts of the handheld impact driver of FIG. 79;

FIG. 81 is a partially exploded view depicting some of the parts of the handheld impact driver of FIG. 79;

FIG. 82 is an upper perspective view depicting another one of the parts of the handheld impact driver of FIG. 79;

FIG. 83 is a lower perspective view depicting the part of FIG. 82; and

FIG. 84 is a perspective view depicting another one of the parts of the handheld impact driver of FIG. 79.

### DETAILED DESCRIPTION

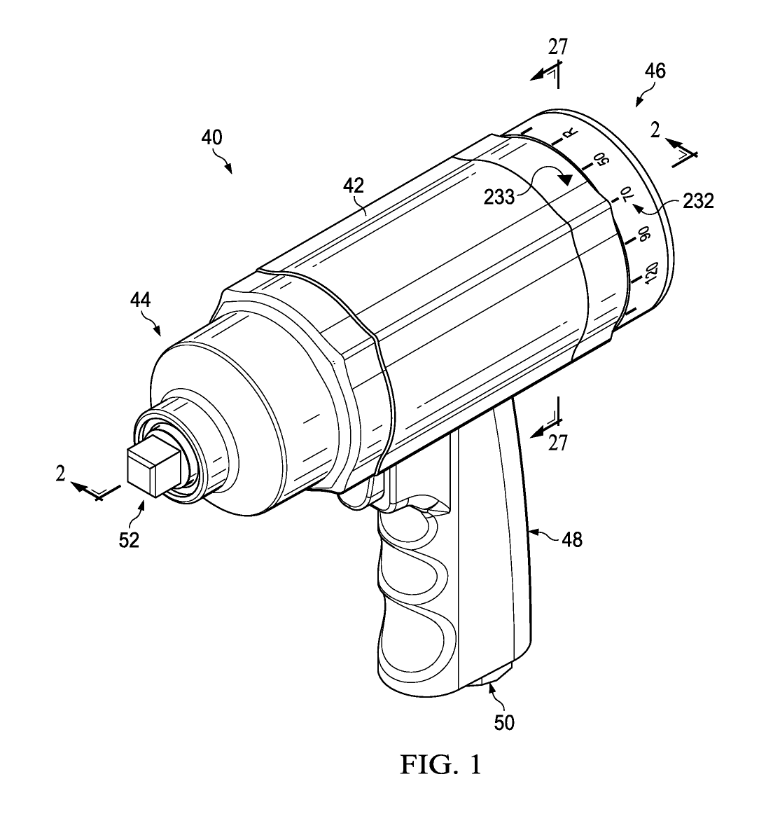

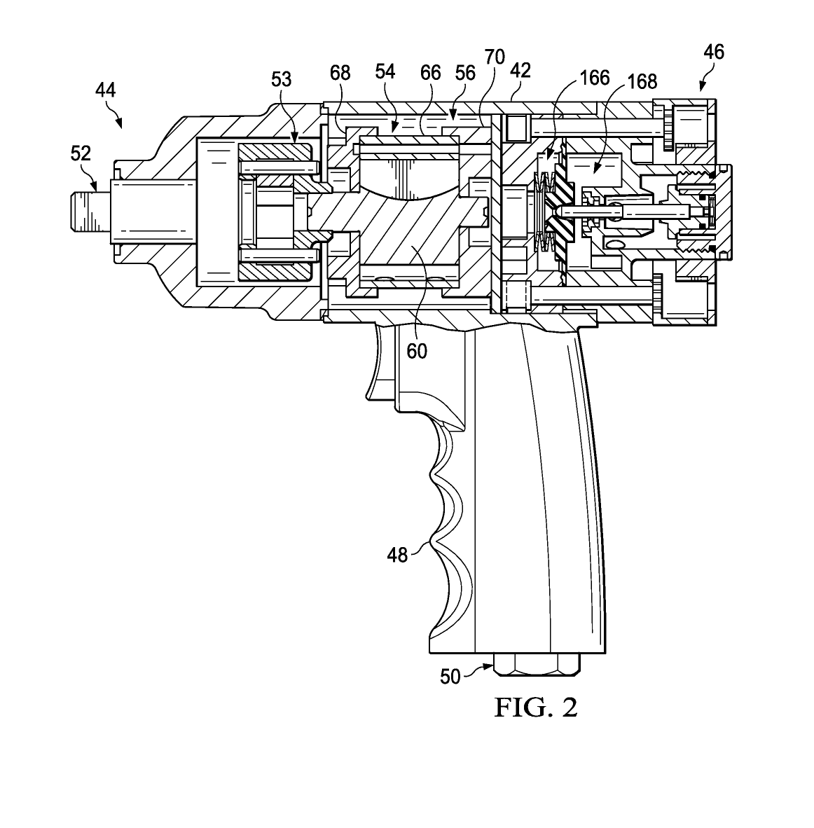

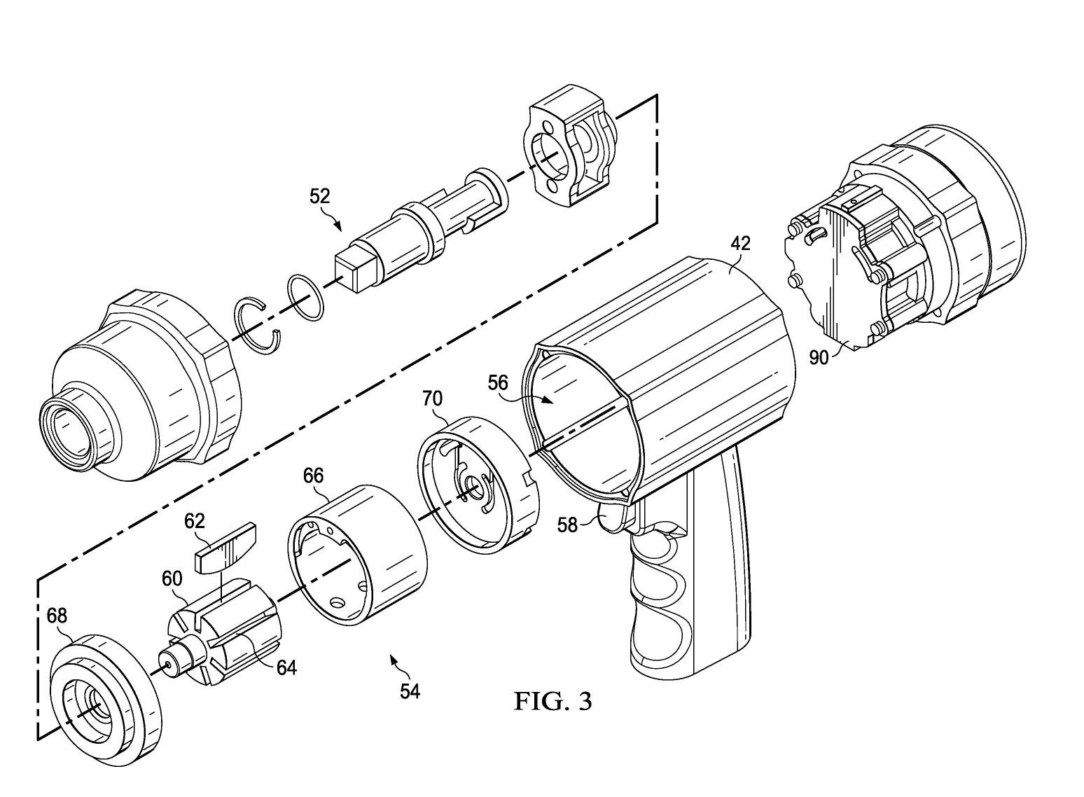

Embodiments are hereinafter described in detail in connection with the views and examples of FIGS. 1-84, wherein like numbers indicate the same or corresponding elements throughout the views. According to one embodiment, as illustrated in FIGS. 1 and 2, a handheld impact driver 40 (hereinafter “impact driver”) is provided that can include a casing 42 and can extend between a front end 44 and a rear end 46. Although an impact driver is shown and described herein, it will be appreciated that any of a variety of suitable alternative pneumatic tools can be provided. The casing 42 can be integral with a hollow handgrip 48. An air supply port 50 can be disposed at a bottom of the hollow handgrip 48 and can be fluidly coupled with an air compressor (not shown) or another external source of pressurized air or other fluid. The pressurized air provided into the air supply port 50 can facilitate selective powering of the impact driver 40 which can actuate a torquing member 52 for driving a fastener (not shown). The torquing member 52 can be configured to receive a bit, socket, or any of a variety of other suitable engagements for a fastener. As illustrated in FIG. 2, a hammer assembly 53 can be associated with the torquing member 52 and can selectively impact the torquing member 52 to facilitate driving of a fastener. The hammer assembly 53 can be a single hammer, a dual hammer, or any of a variety of other suitable hammer arrangements.

As illustrated in FIGS. 2 and 3, the impact driver 40 can include a rotary vane motor 54. The rotary vane motor 54 can be at least partially disposed within a motor compartment 56 defined by the casing 42. The rotary vane motor 54 can be in selective fluid communication with the air supply port 50 and can be selectively powered with pressurized air from the air supply port 50. The impact driver 40 can include a trigger 58 that is secured to the hollow handgrip 48. The trigger 58 can be selectively actuated to facilitate operation of the rotary vane motor 54. The trigger 58 can be associated with a trigger valve assembly (e.g., 3300 shown in FIGS. 50-51) that is disposed within the hollow handgrip 48. The trigger valve assembly can be selectively actuated by the trigger 58 to facilitate communication of pressurized air to the rotary vane motor 54. The hollow handgrip 48 can be configured to conform to a user's hand when grasping the hollow handgrip 48 (e.g., to operate the trigger 58).

The rotary vane motor 54 can include a rotor 60 that is drivingly coupled with the torquing member 52 to facilitate powering of the torquing member 52. A plurality of circumferentially spaced blades (e.g., 62) can be disposed within respective slots (e.g., 64) defined by the rotor 60. The rotor 60 and blades (e.g., 62) can be disposed within a motor housing 66. The rotor 60 and blades (e.g., 62) can be retained within the motor housing 66 by a front cap 68 and a rear cap 70.

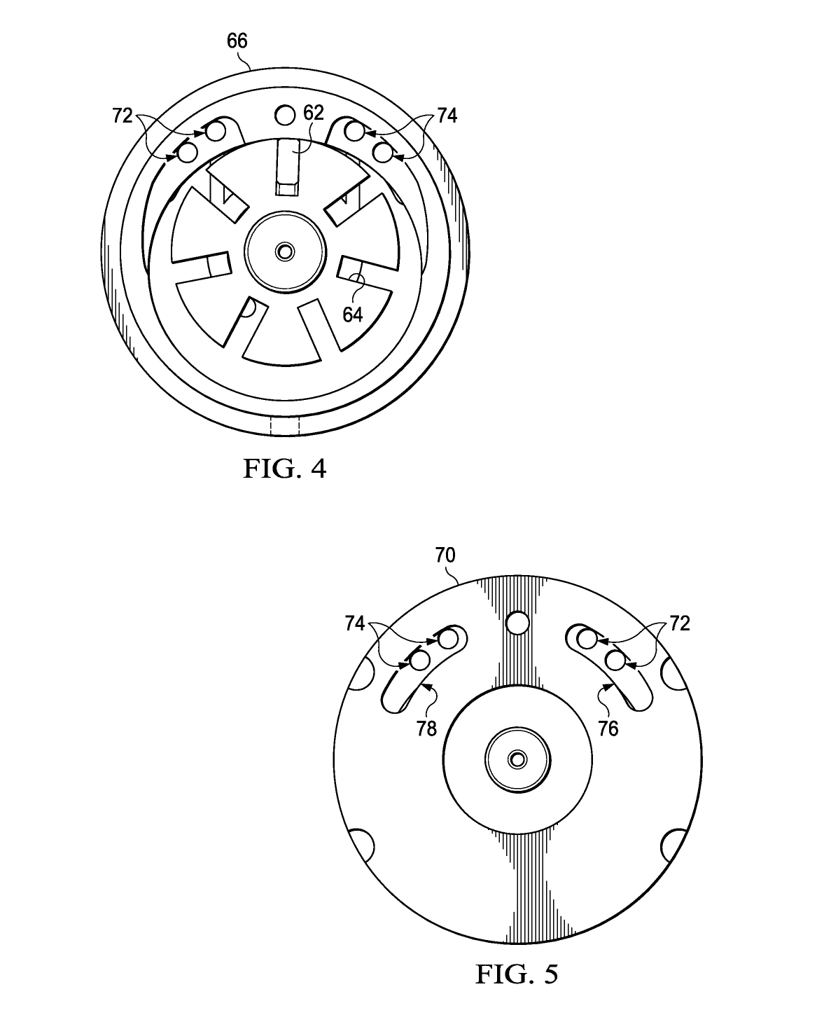

The rotary vane motor 54 can be configured such that the rotor 60 and the torquing member 52 rotate in either a clockwise direction or a counterclockwise direction (e.g., when viewing the impact driver 40 from the rear end 46). Clockwise and counterclockwise rotation of the rotary vane motor 54 can facilitate respective tightening and loosening of a right-handed fastener (not shown). As illustrated in FIGS. 4 and 5, the motor housing 66 is shown to define a first set of air passages 72 and a second set of air passages 74 which are in respective fluid communication with a first slot 76 and a second slot 78 defined by the rear cap 70. Pressurized air can be provided to either of the first slot 76 or the second slot 78 to rotate the rotor 60 in the clockwise and counterclockwise directions, respectively. For example, to rotate the rotor 60 in a clockwise direction, pressurized air can be provided to the first slot 76. The pressurized air can flow through the first set of air passages 72 and to the front cap 68 which can facilitate routing of the pressurized air to impinge on the blades (e.g., 62) thereby facilitating clockwise rotation of the rotor 60. Exhaust air can then be routed from the rotor 60 to the second set of air passages 74 (e.g., by the front cap 68) and exhausted from the second slot 78 of the rear cap 70. To rotate the rotor 60 in a counterclockwise direction, pressurized air can be provided to the second slot 78. The pressurized air can flow through the second set of air passages 74 and to the front cap 68 which can facilitate routing of the pressurized air to impinge on the blades (e.g., 62) thereby facilitating counterclockwise rotation of the rotor 60. Exhaust air can then be routed to the first set of air passages 72 (e.g., by the front cap 68) and exhausted from the first slot 76 of the rear cap 70.

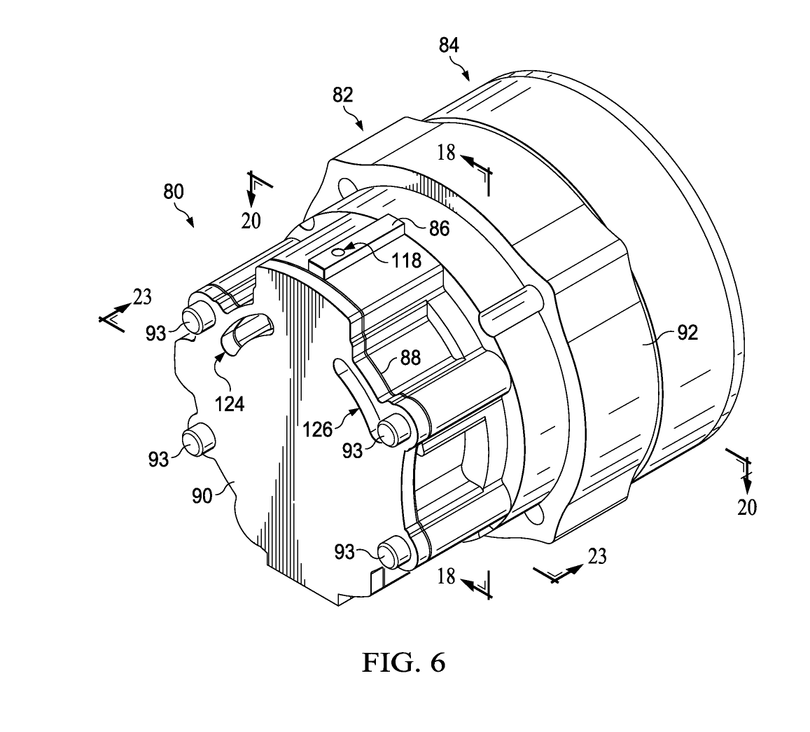

Referring now to FIG. 6, the impact driver 40 can include a manifold assembly 80, a pressure regulator 82, and a collar 84. The manifold assembly 80 can be positioned downstream of the air supply port 50, the pressure regulator 82 can be positioned downstream of the manifold assembly 80, and the rotary vane motor 54 can be positioned downstream of each of the manifold assembly 80 and the pressure regulator 82.

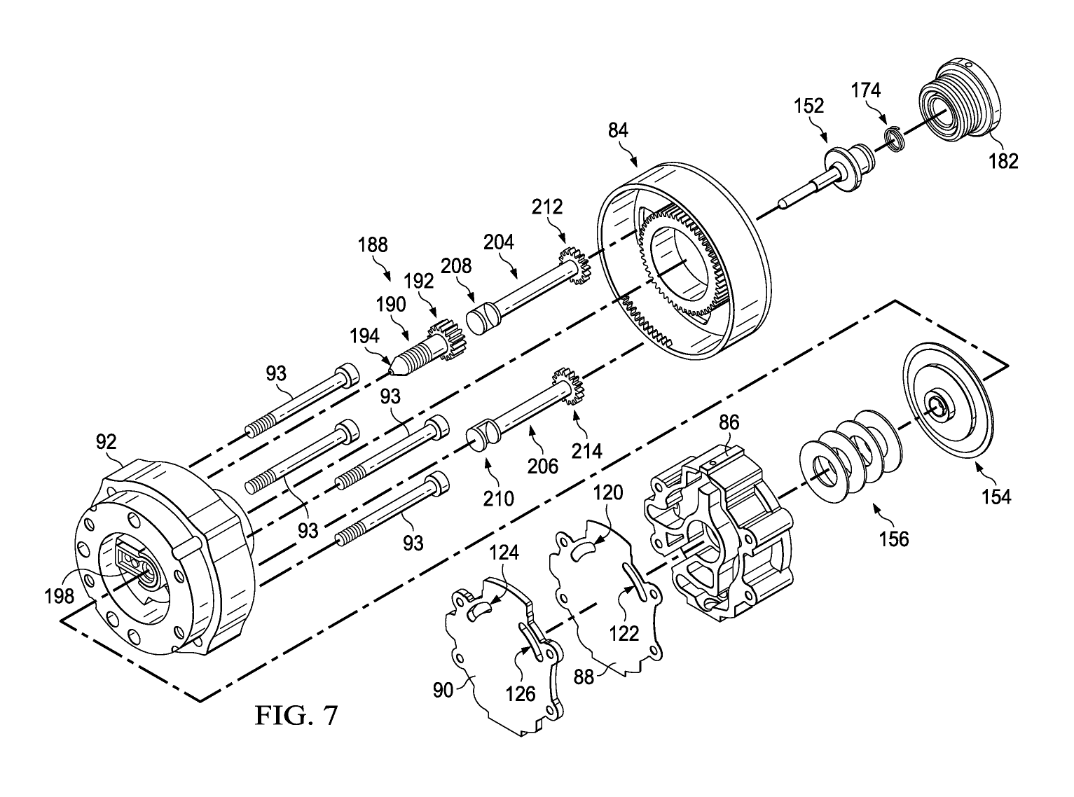

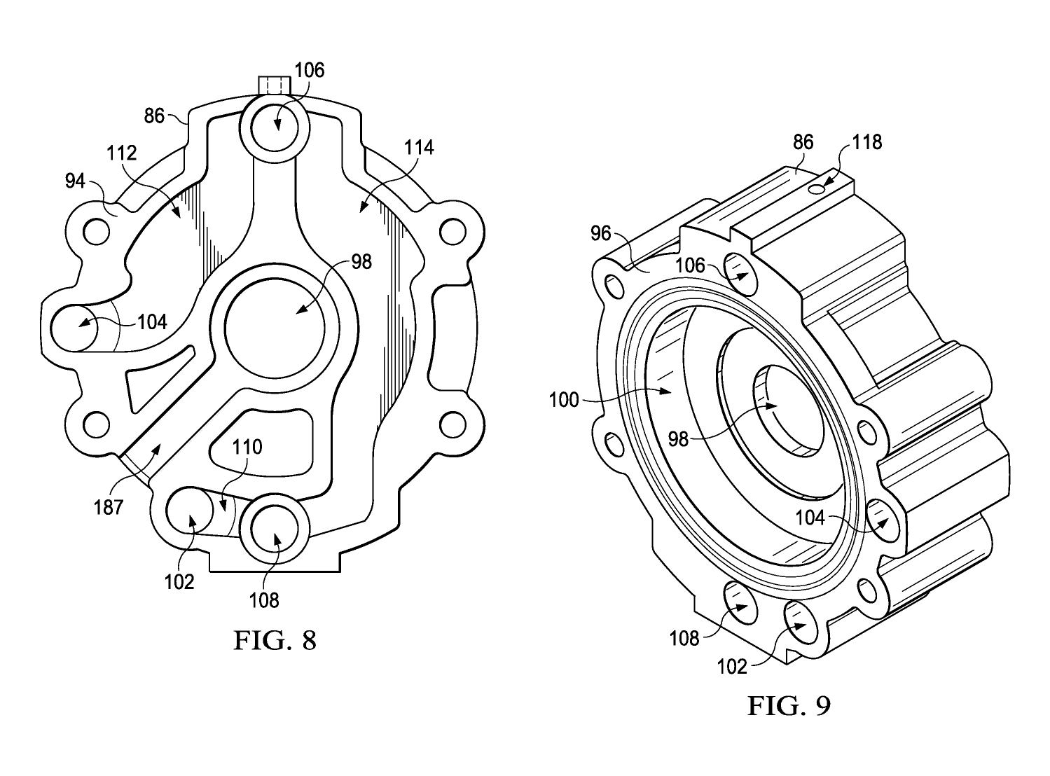

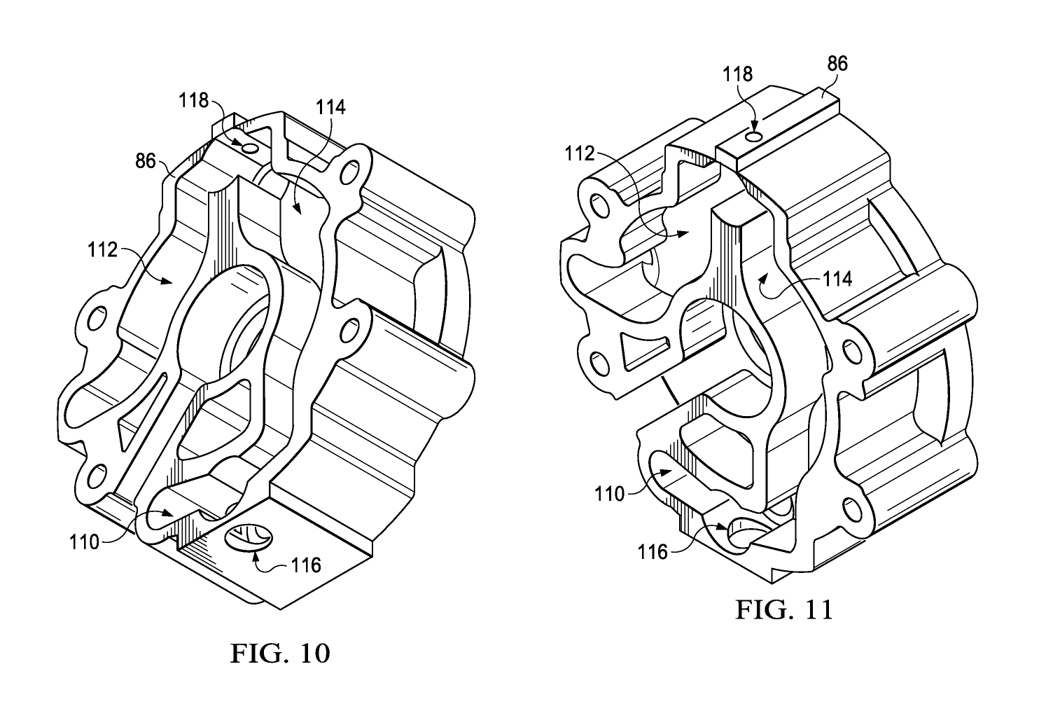

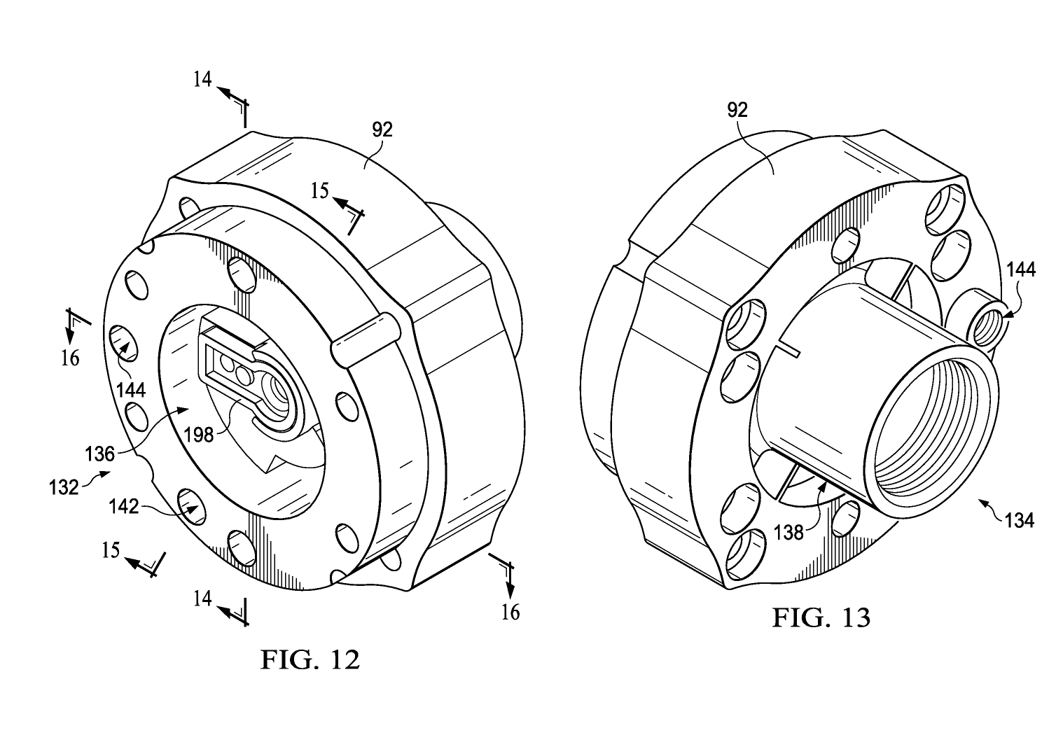

Referring now to FIGS. 6 and 7, the manifold assembly 80 can include a manifold 86, a manifold gasket 88, and a flange 90. The pressure regulator 82 can include a housing 92. The manifold 86, the manifold gasket 88, and the housing 92 are shown in FIGS. 2 and 6 to be sandwiched between the collar 84 and the flange 90. The manifold 86, the manifold gasket 88, the flange 90, and the housing 92 can be releasably attached to one another with a plurality of bolts 93. As will be described in further detail below, the manifold assembly 80, the pressure regulator 82, and the collar 84 can cooperate to route pressurized air from the air supply port 50 to the rotary vane motor 54 to facilitate actuation of the torquing member 52.

Referring now to FIGS. 8-11, the manifold 86 can include a front surface 94 (FIG. 8) and a rear surface 96 (FIG. 9). The manifold 86 can define a central bore 98 that extends into a recess 100 defined by the rear surface 96 such that the central bore 98 and the recess 100 are in fluid communication with one another. The manifold 86 can also define an inlet passage 102, an outlet passage 104, and upper and lower valve receptacles 106, 108. As illustrated in FIG. 8, each of the inlet and outlet passages 102, 104 can extend into, and can be in fluid communication with, respective first and second elongated pathways 110, 112. The first elongated pathway 110 can extend to the lower valve receptacle 108. The second elongated pathway 112 can extend to the upper valve receptacle 106. A third elongated pathway 114 can extend between the upper and lower valve receptacles 106, 108. The manifold 86 can also define an inlet port 116 (FIGS. 10 and 11) and an exhaust port 118 (FIGS. 9-11). The trigger 58 can facilitate selective fluid communication between the air supply port 50 and the inlet port 116.

Referring again to FIG. 7, the manifold gasket 88 can define a first slot 120 and a second slot 122. The flange 90 can define a third slot 124 and a fourth slot 126. The manifold gasket 88 can be positioned between the flange 90 and the manifold 86 such that first and third slots 120, 124 are substantially aligned and the second and fourth slots 122, 126 are substantially aligned. With the manifold gasket 88 sandwiched between the manifold 86 and the flange 90, the manifold gasket 88 overlies the first, second, and third elongated pathways 110, 112, 114 and cooperates with the manifold 86 to define respective first, second, and third fluid passages (not shown).

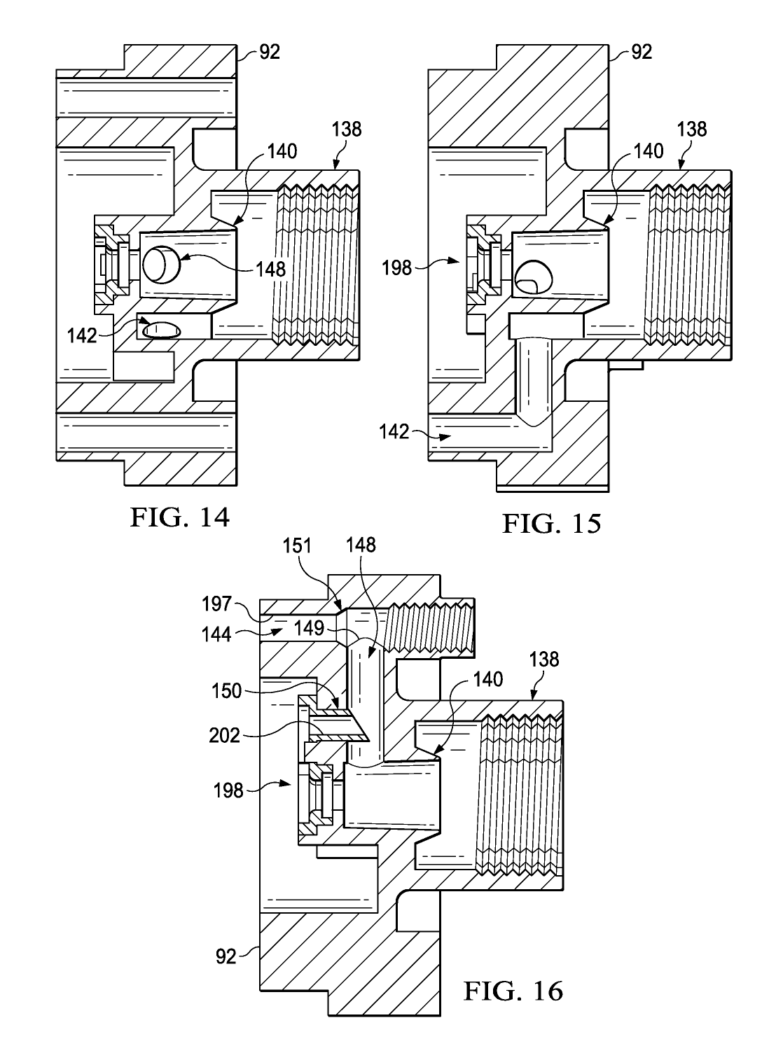

Referring now to FIGS. 12 and 13, the housing 92 of the pressure regulator 82 can comprise a front end 132 (FIG. 12) and a rear end 134 (FIG. 13). The front end 132 of the housing 92 can define a front recess 136, and an outer collar 138 can be disposed at the rear end 134. As illustrated in FIGS. 14-16, an interior collar 140 can be disposed within the outer collar 138. The outer collar 138 can extend beyond the interior collar 140 and can have a greater overall diameter than the interior collar 140. The housing 92 of the pressure regulator 82 can define an inlet passage 142 and an outlet passage 144. As illustrated in FIG. 15, the inlet passage 142 can extend from the front end 132 (FIG. 12) of the housing 92 to the outer collar 138 such that it is in fluid communication with the interior collar 140. As illustrated in FIG. 16, the outlet passage 144 can extend through the housing 92 between the front and rear ends 132, 134 (FIGS. 12 and 13). An interior collar passage 148 can extend from the interior collar 140 to the outlet passage 144. The intersection of the outlet passage 144 and the interior collar passage 148 can define an orifice 149 (FIG. 16). An internal passage 150 can extend from the interior collar passage 148 to the front recess 136, as shown in FIG. 12. With the manifold 86 and the housing 92 sandwiched together, as illustrated in FIG. 6, the inlet passages 102, 142 can be in fluid communication with each other, and the outlet passages 104, 144 can be in fluid communication with each other.

Referring now to FIGS. 7, 17 and 18, the pressure regulator 82 can include a regulator valve assembly 152, a diaphragm assembly 154, and a biasing member 156. In one embodiment, the diaphragm assembly 154 can include a generally central member 158 and an annular flexible member 160 comprising a radially inner portion 162 and a radially outer portion 164. The radially inner portion 162 can be secured to the generally central member 158.

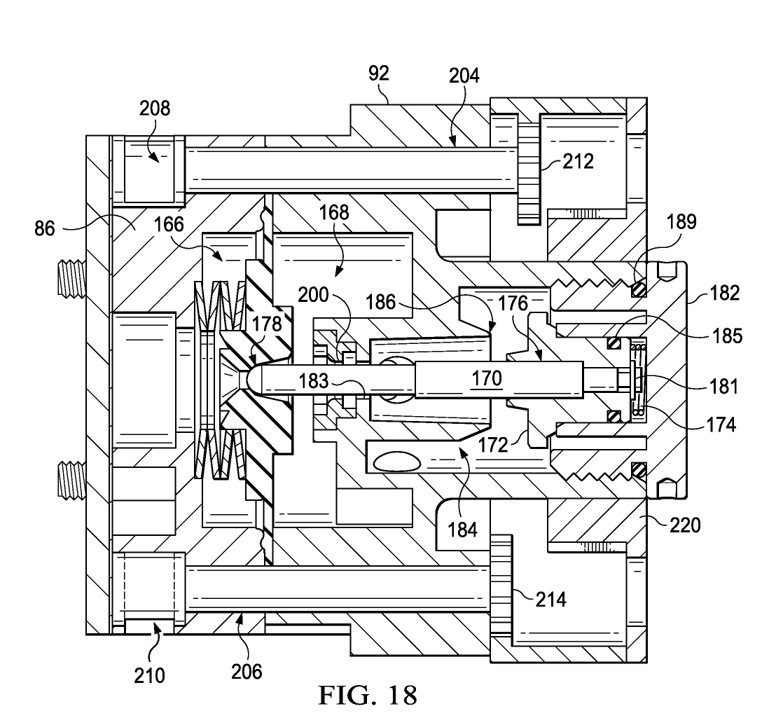

The diaphragm assembly 154 can be disposed between the manifold 86 and the housing 92 and secured to at least one of the manifold 86 and the housing 92. For example, as illustrated in in FIGS. 2, 7, and 18, the radially outer portion 164 of the diaphragm assembly 154 can be sandwiched between the manifold 86 and the housing 92 to provide an effective seal therebetween. The radially outer portion 164 can additionally or alternatively be secured to at least one of the manifold 86 and the housing 92 with any of a variety of suitable alternative securement methods. With the diaphragm assembly 154 sandwiched between the manifold 86 and the housing 92, the manifold 86 and the diaphragm assembly 154 can cooperate to define a vented chamber 166 and the housing 92 and the diaphragm assembly 154 can cooperate to define a discharge chamber 168, as illustrated in FIGS. 2 and 18. In such an arrangement, the flexible member 160 can be interposed between the vented chamber 166 and the discharge chamber 168.

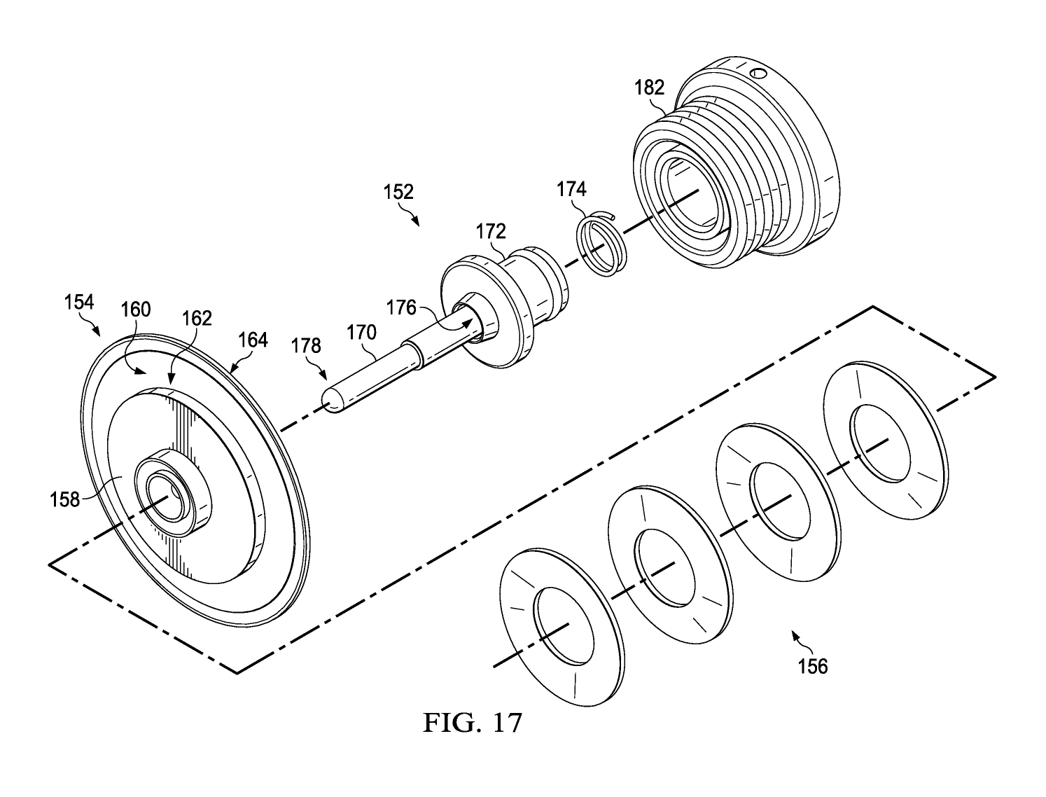

Referring now to FIGS. 17 and 18, the regulator valve assembly 152 can include a valve stem 170 and a valve plug 172 and can be associated with a return spring 174. The valve stem 170 can comprise a first end portion 176 and a second end portion 178. The first end portion 176 can be engaged with the valve plug 172 such as, for example, with a snap ring 181 (FIGS. 18-20). The second end portion 178 of the valve stem 170 can extend through a central bore 183 of the housing 92 and into engagement with the generally central member 158 of the diaphragm assembly 154. In one embodiment, the generally central member 158 can be a substantially rigid member. In another embodiment, the generally central member 158 can be an elastomeric material (e.g., rubber). An end cap 182 can be releasably secured to the outer collar 138, such as in threaded engagement, for example. As illustrated in FIGS. 18-20, the valve plug 172 can be disposed within the end cap 182 and an O-ring 185 can be provided between the valve plug 172 and the end cap 182. An O-ring 189 can be provided between the outer collar 138 and the end cap 182. The outer collar 138 of the housing 92 can cooperate with an end cap 182 to define an inlet chamber 184. The interior collar 140 can define a valve seat 186.

The regulator valve assembly 152 and the diaphragm assembly 154 can be sandwiched between the biasing member 156 and the return spring 174. The biasing member 156 can extend between the manifold 86 and the diaphragm assembly 154 such that it is disposed within the vented chamber 166. The biasing member 156 can exert a biasing force on the diaphragm assembly 154 that biases the diaphragm assembly 154 toward the discharge chamber 168. The return spring 174 can extend between the valve plug 172 and the end cap 182. The return spring 174 can exert a biasing force on the regulator valve assembly 152 that biases the regulator valve assembly 152 toward the vented chamber 166. In one embodiment, as illustrated in FIG. 17, the biasing member 156 is shown to comprise a plurality of Belleville springs and the return spring 174 is shown to comprise a coiled spring. It will be appreciated that in other embodiments, any of a variety of suitable alternative biasing arrangements can be used, such as more or less than four Belleville springs, for example, for exerting respective biasing forces on diaphragm assembly 154 and the regulator valve assembly 152.

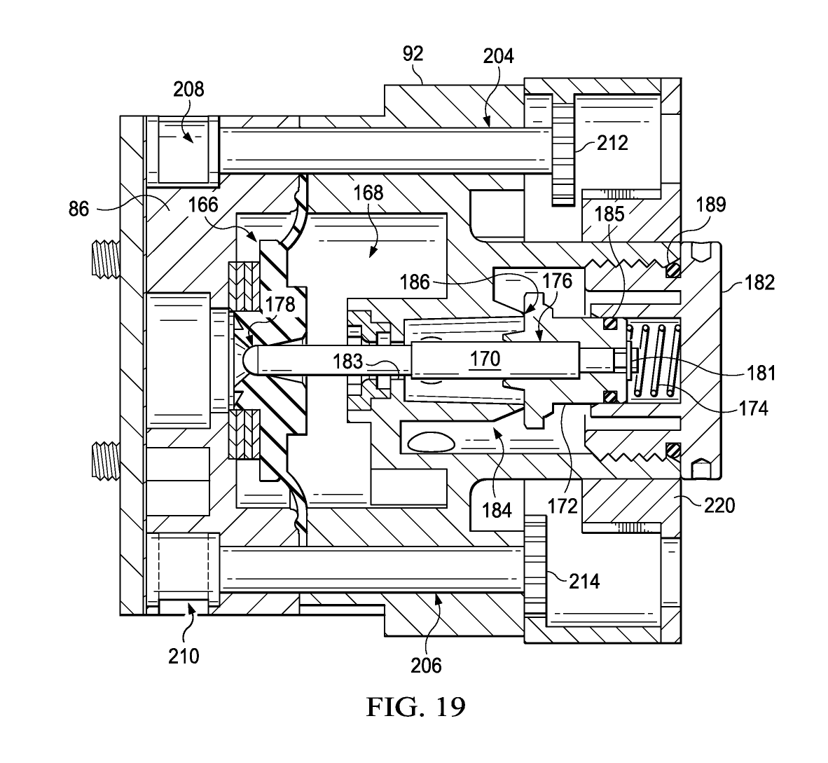

The diaphragm assembly 154 can be movably coupled with the housing 92. The diaphragm assembly 154 can move between a relaxed state, as illustrated in FIG. 18, and a fully deformed state, as illustrated in FIG. 19, in response to the respective biasing forces from the biasing member 156 and the return spring 174 as well as the difference in pressure between the inlet chamber 166 and the discharge chamber 168. The vented chamber 166 can be in fluid communication with the central bore 98 of the manifold 86 to permit exhaust air from the pressure regulator 82 as the pressure within the discharge chamber 168 changes. The exhaust air from the pressure regulator 82 can flow through an exhaust passage (187 in FIG. 8).

With the valve stem 170 coupled with the diaphragm assembly 154, the regulator valve assembly 152 can be movable together with the diaphragm assembly 154 and relative to the valve seat 186 between an opened position (FIG. 18) and a closed position (FIG. 19). Movement of the regulator valve assembly 152 between the opened and closed positions can cause the inlet chamber 184 and the discharge chamber 168 to be in intermittent fluid communication. For example, when the regulator valve assembly 152 is in the opened position (FIG. 18), the valve plug 172 and the valve seat 186 can be spaced from one another such that the discharge chamber 168 and the inlet chamber 184 are in fluid communication with one another. When the regulator valve assembly 152 is in the closed position (FIG. 19), the valve plug 172 can be seated upon the valve seat 186 to create a sealing interface such that the discharge chamber 168 and the inlet chamber 184 are fluidically uncoupled from one another.

The pressure regulator 82 can be configured to facilitate discharging of regulated, pressurized air at a substantially constant pressure from the discharge chamber 168. When unregulated pressurized air is provided to the inlet chamber 184 (e.g., from the air supply port 50 when the trigger 58 is actuated), the diaphragm assembly 154 can move between the relaxed and fully deformed state in response to the respective biasing forces from the biasing member 156 and the return spring 174 as well as the difference in pressure between the inlet chamber 184 and the discharge chamber 168 which can urge the movement of the regulator valve assembly 152 to a position that facilitates regulation of the pressure within the discharge chamber 168 to a substantially constant pressure. As such, the pressure regulator 82 can be configured as compact and fast-acting and can facilitate high-response pressure regulation with high repeatability.

The pressure regulator 82 is shown to be part of the impact driver 40 such that pressure regulation for the rotary vane motor 54 occurs onboard the impact driver 40. The rotary vane motor 54 and the pressure regulator 82 can be closely coupled such that the rotary vane motor 54 is not subjected to the substantial line drop oftentimes experienced by conventional off-board regulators (e.g., a line regulator located at the compressor). As a result, the operation of the rotary vane motor 54 can be more precise, predictable, and reliable than conventional arrangements. For example, if the pressurized air provided to the impact driver 40 (e.g., the to the air supply port 50) is between about 100 pounds per square inch (PSI) and about 150 PSI, and the pressure regulator 82 is set to about 50 PSI, the pressure regulator 82 can provide a consistent air pressure to the rotary vane motor 54 despite variations in pressure at the air supply port 50 (e.g., so long as the pressure at the air supply port 50 does not drop below about 50 PSI).

In one embodiment, the pressure regulator 82 can be configured as a fixed-type regulator such that the set point of the regulated pressure discharged from the discharge chamber 168 cannot be externally varied (e.g., by a user), such as by adjusting an external set screw or knob, as with some conventional regulator arrangements. Instead, the set point of the regulated pressure from the pressure regulator 82 can be established by certain characteristics, such as the respective spring constants of the biasing member 156 and/or the return spring 174 and/or the elasticity of the diaphragm assembly 154, for example.

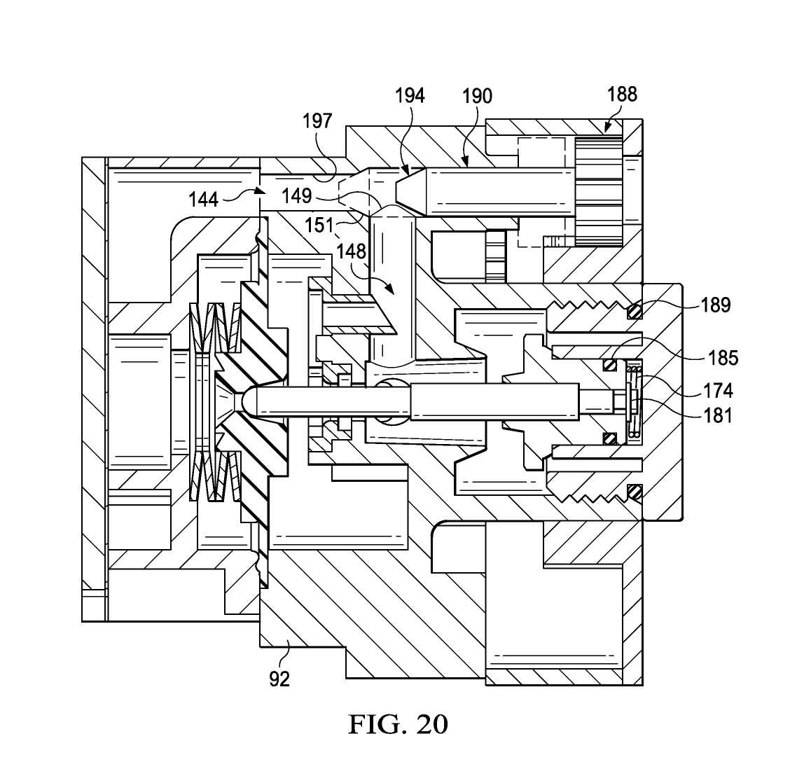

Referring now to FIGS. 7 and 20, the impact driver 40 can include a needle valve 188 that includes a restricting member 190 and a spur gear 192. The restricting member 190 can include a tapered portion 194. The restricting member 190 can be positioned downstream of the regulator valve assembly 152 and the discharge chamber 168 and upstream of the rotary vane motor 54. As illustrated in FIG. 20, the needle valve 188 can be movably coupled with the housing 92 along the rear end 134 (FIG. 13) of the housing 92. The restricting member 190 can extend into the outlet passage 144 such that the tapered portion 194 is adjacent to the orifice 149. The tapered portion 194 can selectively interface with a chamfered portion 151 of the housing 92 that is downstream of the orifice 149.

The needle valve 188 can move linearly with respect to the outlet passage 144 between a withdrawn position (shown in solid lines) and a blocking position (shown in dashed lines). In one embodiment, the restricting member 190 can be threadedly engaged with the outlet passage 144 such that rotation of the needle valve 188 facilitates linear movement (e.g., translation) of the needle valve 188 with respect to the outlet passage 144. Movement of the needle valve 188 between the withdrawn position and the blocking position can facilitate selective control of a flow rate of the regulated air that is discharged from the discharge chamber 168 to the outlet passage 144. For example, when the needle valve 188 is in the withdrawn position, the tapered portion 194 can be withdrawn from the orifice 149 and the chamfered portion 151 such that the flow rate of the pressurized air through the orifice 149 is substantially unobstructed. As the needle valve 188 moves towards the blocking position, the tapered portion 194 can move closer to the chamfered portion 151 and can increasingly obstruct the orifice 149 thereby decreasing the flow rate of the regulated air through the orifice 149. Decreasing the flow rate of the regulated air through the orifice 149 can reduce the flow rate of the pressurized air provided to the rotary vane motor 54. When the needle valve 188 is in the blocking position, the tapered portion 194 can interact with the chamfered portion 151 to substantially block air flow through the orifice 149. It will be appreciated that needle valve 188 and the pressure regulator 82 can have a closely coupled relationship such that the line pressure drop from the orifice 149 to the rotary vane motor 54 is substantially insignificant.

It will be appreciated that the speed of a rotary vane motor can be a function of the overall pressure and the flow rate of pressurized air to the motor. With the pressure of the pressurized air through the orifice 149 substantially fixed by the pressure regulator 82, as described above, the speed of the rotary vane motor 54 can accordingly be controlled by controlling the flow rate of the pressurized air through the orifice 149 with the needle valve 188. Since the available output torque of the torquing member 52 can be a function of the speed of the rotary vane motor 54, the available output torque of the impact driver 40 can be selected through use of the needle valve 188. Selection of the available output torque in this manner can be more cost effective and less complicated than conventional pneumatic impact drivers having a torque selection feature. In addition, since the pressure regulator 82 can provide a consistent air pressure to the rotary vane motor 54, as described above, the available output torque of the impact driver 40 can be repeatedly and consistently selected with the needle valve 188.

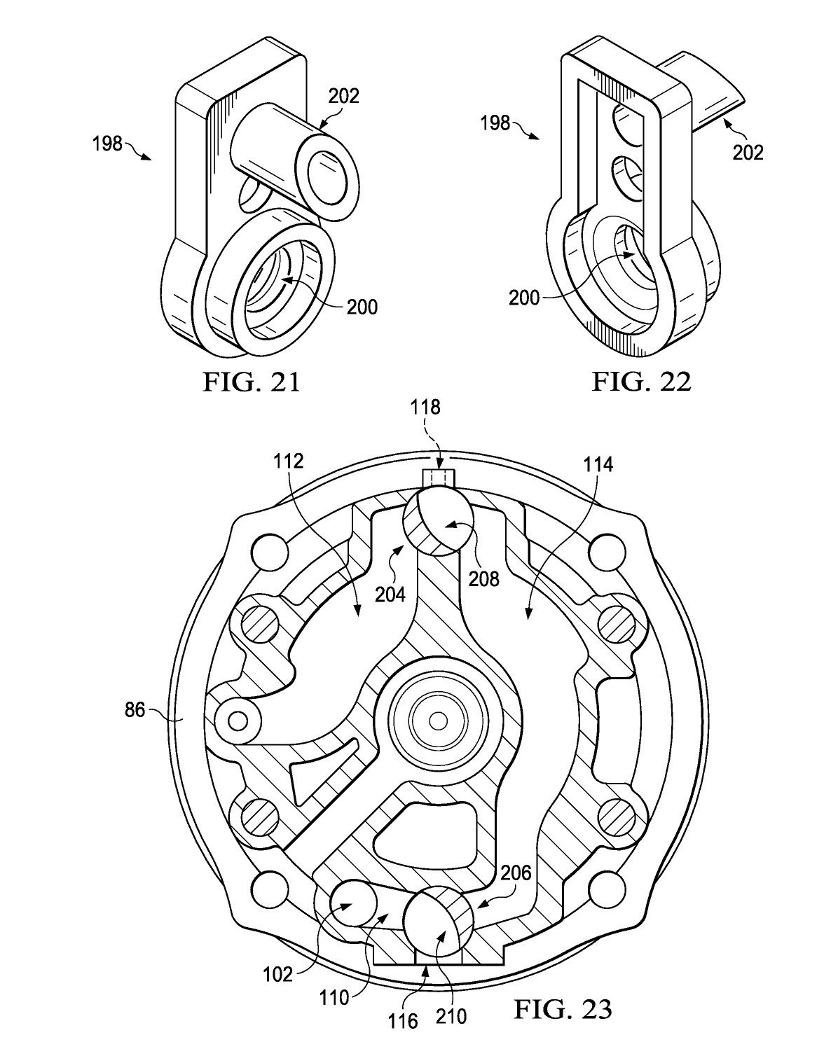

Referring now to FIGS. 12, 16 and 18-22, the pressure regulator 82 can comprise a flow distributor 198 that defines an aperture 200 and a distributor passage 202. The flow distributor 198 can be coupled with the housing 92 such that the distributor passage 202 is downstream of the regulator valve assembly 152 and in fluid communication with the discharge chamber 168. As illustrated in FIG. 12, the flow distributor 198 can be disposed within the front recess 136 of the housing 92 of the pressure regulator 82. As illustrated in FIG. 18, the aperture 200 can receive the valve stem 170 of the regulator valve assembly 152. As illustrated in FIG. 16, the flow distributor 198 can be coupled with the housing 92 such that the distributor passage 202 projects through the internal passage 150 and into the interior collar passage 148 to provide a direct flow path between the interior collar passage 148 and the discharge chamber 168. The distributor passage 202 can be in fluid communication with each of the discharge chamber 168 and the inlet chamber 184 when the regulator valve assembly 152 is open and can be fluidically uncoupled from the inlet chamber 184 when the regulator valve assembly 152 is closed. Pressurized air that flows through the interior collar passage 148 and over the distributor passage 202 can create a Bernoulli Effect within the discharge chamber 168 that enhances the pressure regulating capabilities of the pressure regulator.

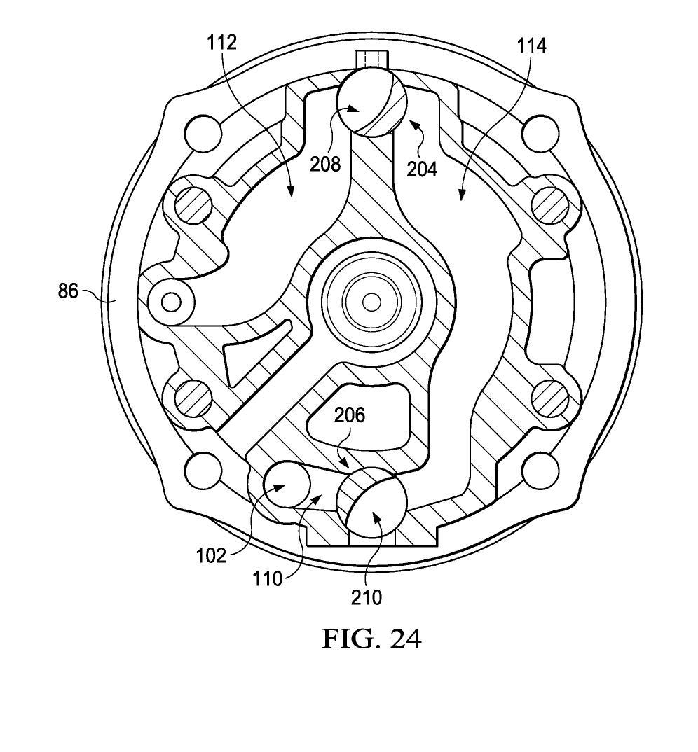

Referring now to FIGS. 7, 8, 18, and 23-24, the manifold assembly 80 can include an upper porting valve 204 and a lower porting valve 206. Each of the upper and lower porting valves 204, 206 can have a respective valve member (e.g., 208, 210) and spur gear (e.g., 212, 214) disposed at opposite ends of the upper and lower porting valves 204, 206, respectively. Each of the upper and lower porting valves 204, 206 can be rotatably coupled with the manifold 86. As illustrated in FIG. 18, the manifold 86 and the housing 92 can cooperate to rotatably support each of the upper and lower porting valves 204, 206. The upper porting valve 204 can extend through the upper valve receptacle 106 of the manifold 86 such that the valve member 208 of the upper porting valve 204 is disposed between the second and third elongated pathways 112, 114, as illustrated in FIGS. 23 and 24. The lower porting valve 206 can extend through the lower valve receptacle 108 such that the valve member 210 of the lower porting valve 206 is disposed between the first and third elongated pathways 110, 114.

The upper and lower porting valves 204, 206 can be rotatable between respective regulating positions (FIG. 23) and respective bypass positions (FIG. 24). When the upper and lower porting valves 204, 206 are in their respective regulating positions, as illustrated in FIG. 23, the pressurized air provided to the inlet port 116 (e.g., when the trigger 58 is actuated) can be regulated by the pressure regulator 82 and provided to the rotary vane motor 54 to facilitate rotation in the clockwise direction. For example, when the upper and lower porting valves 204, 206 are in their respective regulating positions, the valve member 210 of the lower porting valve 206 can be positioned such that the inlet port 116 is in fluid communication with the first elongated pathway 110 but is fluidically uncoupled from the third elongated pathway 114. The valve member 208 of the upper porting valve 204 can be positioned such that the exhaust port 118 is in fluid communication with the third elongated pathway 114 but is fluidically uncoupled from the second elongated pathway 112.

In this configuration, when the trigger 58 is actuated, pressurized air from the air supply port 50 can be provided to the inlet port 116. The valve member 210 of the lower porting valve 206 can route the pressurized air to the first elongated pathway 110 while blocking the pressurized air from entering the third elongated pathway 114. The pressurized air can then flow through the inlet passages 102, 142 and to the pressure regulator 82 where it is regulated to a substantially constant pressure. The regulated air from the pressure regulator 82 can then flow through the outlet passages 144, 104 and to the second elongated pathway 112 where it is delivered through the first and third slots 120, 124, respectively, to the rotary vane motor 54 and facilitates clockwise operation. The exhaust air can be routed through the fourth and second slots 126, 122 to the third elongated pathway 114 and exhausted through the exhaust port 118 while being simultaneously blocked by the upper porting valve 204 from entering the second elongated pathway 112.

When the upper and lower porting valves 204, 206 are in their respective bypass positions, as illustrated in FIG. 24, the pressurized air provided to the inlet port 116 can bypass the pressure regulator 82 and can be provided directly to the rotary vane motor 54 to facilitate counterclockwise rotation. For example, when the upper and lower porting valves 204, 206 are in their respective bypass positions, the valve member 210 of the lower porting valve 206 can be positioned such that the inlet port 116 is in fluid communication with the third elongated pathway 114 but is fluidically uncoupled from the first elongated pathway 110. The valve member 208 of the upper porting valve 204 can be positioned such that the exhaust port 118 is in fluid communication with the second elongated pathway 112 but is fluidically uncoupled from the third elongated pathway 114.

When pressurized air is provided to the inlet port 116, the valve member 210 of the lower porting valve 206 can route the air from the inlet port 116 to the third elongated pathway 114 while blocking the pressurized air from entering the first elongated pathway 110. The pressurized air can then flow through the second and fourth slots 122, 126 directly to the rotary vane motor 54 to facilitate counterclockwise operation. The exhaust air can be routed through the third and first slots 124, 120, to the second elongated pathway 112 and exhausted through the exhaust port 118 while being simultaneously blocked from entering the third elongated pathway 114.

The positions of the upper and lower porting valves 204, 206 can be selected to facilitate either tightening or loosening of a right handed fastener with the impact driver 40. For example, to facilitate tightening of a fastener, the upper and lower porting valves 204, 206 can be moved to their regulated positions to facilitate clockwise rotation of the rotary vane motor 54 and the torquing member 52. The available torque applied to the fastener can be controlled with the needle valve 188, as described above. To facilitate loosening of a fastener, the upper and lower porting valves 204, 206 can be moved to their bypass positions to facilitate counterclockwise rotation of the rotary vane motor 54 and the torquing member 52. Since the pressurized air provided to the rotary vane motor 54 during counterclockwise operation is not provided through the pressure regulator 82, the flow rate of the air to the rotary vane motor 54 can be greater than when operating the rotary vane motor 54 in the clockwise direction. As a result, more torque can be available from the impact driver 40 to aid in releasing the fastener when stuck or excessively tightened.

Referring now to FIGS. 7, 8, and 25-29, the collar 84 can be rotatably coupled with at least one of the manifold 86 and the housing 92 at the rear end 46 of the impact driver 40, as illustrated in FIG. 2, and can be rotatable relative to each of the manifold 86 and the housing 92. In one embodiment, the collar 84 can be rotatably coupled with the housing 92 and held in place (e.g., longitudinally) by the end cap 182. The collar 84 and the casing 42 can interface with each other in a friction fit that permits manual rotation of the collar 84 but helps prevent the collar 84 from otherwise rotating (e.g., due to vibration). The collar 84 can be formed of thermoplastic or other material that promotes lubricity between the collar 84 and the casing 42 to permit ease of manual rotation of the collar 84.

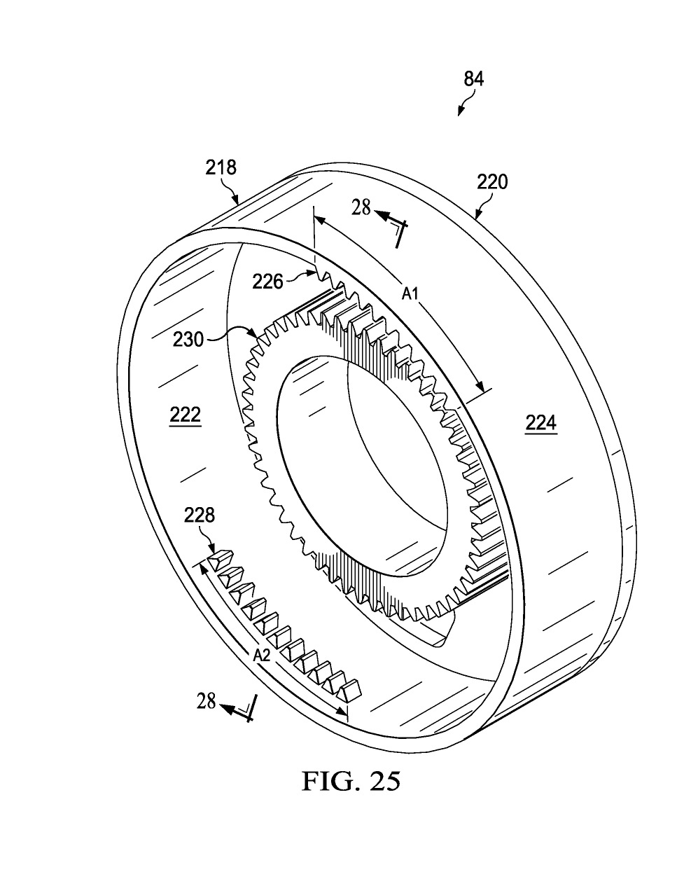

As illustrated in FIG. 25, the collar 84 can include an annular casing 218 and a back plate 220. The annular casing 218 can comprise an inner surface 222 and an outer surface 224. A first rack of internal gear teeth 226 and a second rack of internal gear teeth 228 can be integral with, and can extend inwardly from, the inner surface 222 of the annular casing 218. The back plate 220 can include a sun gear 230.

As illustrated in FIG. 25, each of the first and second racks of internal gear teeth 226, 228 can extend along only a portion of the inner surface 222 of the annular casing 218. The inner surface 222 of the annular casing 218 can comprise a circumference. The first rack of internal gear teeth 226 can extend circumferentially for a first arc length A1. The second rack of internal gear teeth 228 can extend circumferentially for a second arc length A2. Each of the first arc length A1 and the second arc length A2 can be less than the circumference of the inner surface 222 of the annular casing 218.

The first rack of internal gear teeth 226 and the second rack of internal gear teeth 228 are shown in FIG. 25 to be circumferentially spaced from one another. As such, the spur gears 212, 214 of the upper and lower porting valves 204, 206 can be selectively engaged with the second and first racks of internal gear teeth 228, 226, respectively, depending upon the position of the collar 84. In one embodiment, the each respective first and second arc lengths A1, A2 of the first and second racks of internal gear teeth 226, 228 can be about 54 degrees. In other embodiments, first and second racks of internal gear teeth can extend circumferentially for any of a variety of arc lengths.

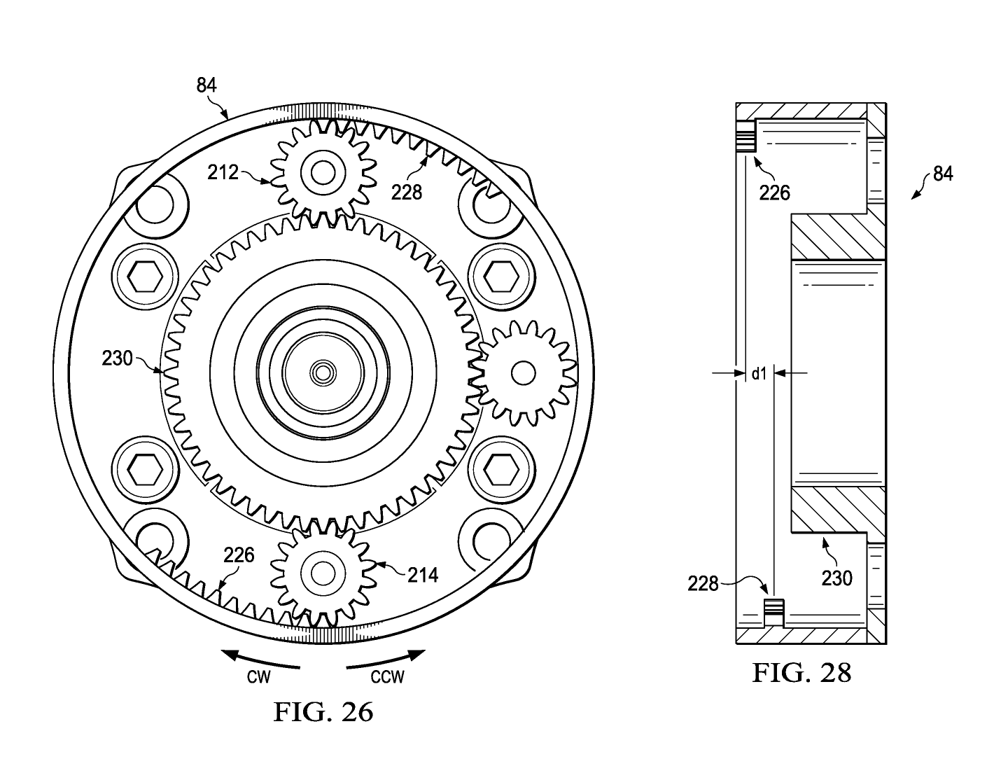

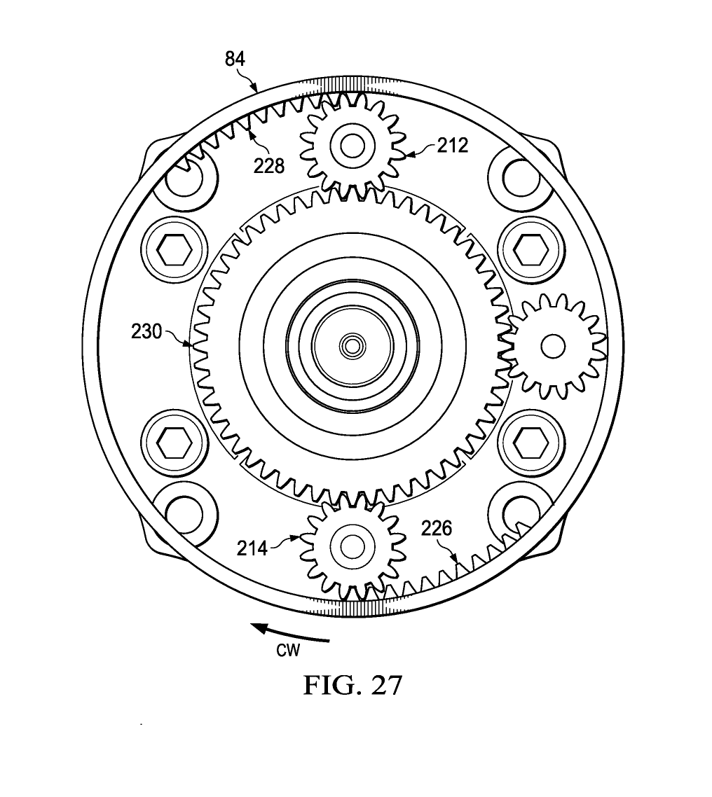

The collar 84 can be selectively engaged with each of the upper porting valve 204 and the lower porting valve 206 to facilitate selective control of the direction of rotation of the torquing member 52. As illustrated in FIG. 27, the first rack of internal gear teeth 226 can be intermeshed with the spur gear 214 of the lower porting valve 206, and the second rack of internal gear teeth 228 can be intermeshed with the spur gear 212 of the upper porting valve 204. When the spur gears 212, 214 are intermeshed with the second and first racks of internal gear teeth 228, 226 in this manner, rotation of the collar 84 can facilitate substantially simultaneous rotation of the upper and lower porting valves 204, 206 between their respective regulating and bypass positions. For example, when the spur gears 212, 214 are positioned with respect to the second and first racks of internal gear teeth 228, 226, as illustrated in FIG. 26, the upper and lower porting valves 204, 206 can be in their respective regulating positions. Rotation of the collar 84 in the counterclockwise (CCW) direction can move the upper and lower porting valves 204, 206 to their respective bypass positions. Conversely, rotation in the clockwise (CW) direction from the position shown in FIG. 26, can cause the spur gears 212, 214 to disengage from the second and first racks of internal gear teeth 228, 226, respectively, thereby preventing the upper and lower porting valves 204, 206 from being over-rotated beyond the regulating positions and thus improperly positioned. Once the spur gears 212, 214 are disengaged from the second and first racks of internal gear teeth 228, 226, respectively, respective detent members (not shown) associated with the upper and lower porting valves 204, 206 can facilitate retention of the upper and lower porting valves 204, 206 in their current position.

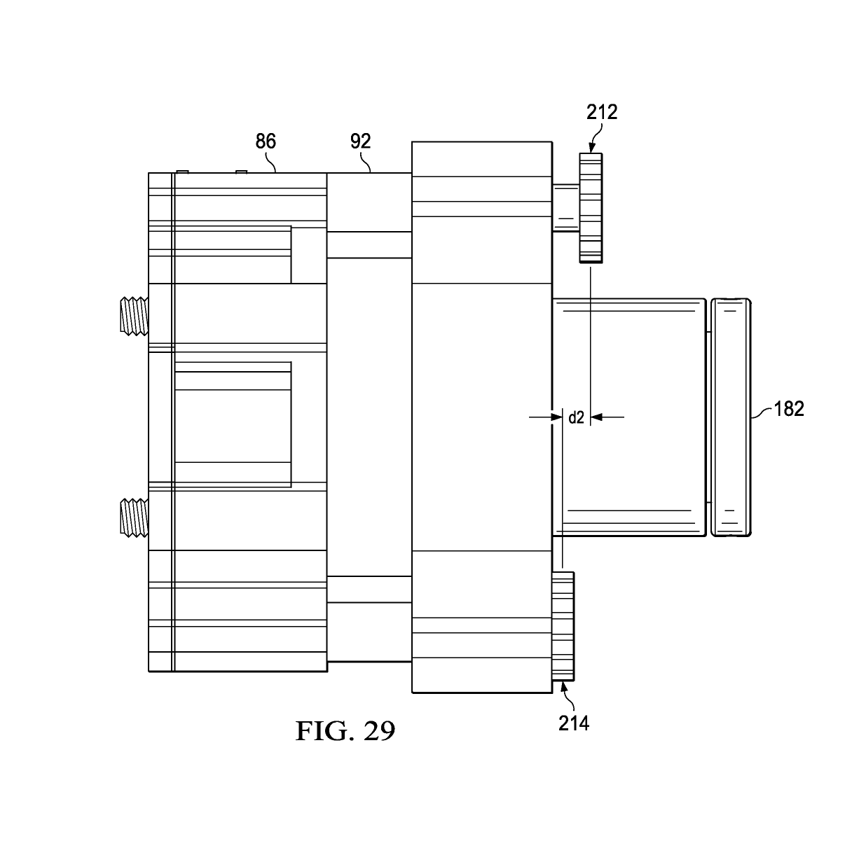

In one embodiment, as illustrated in FIG. 28, the first and second racks of internal gear teeth 226, 228 can be longitudinally spaced from one another by a distance d1 (FIG. 28). The spur gears 212, 214 of the upper and lower porting valves 204, 206 can be longitudinally spaced from each other by a distance d2 (FIG. 29) which can be substantially equal to d1. The spur gear 212 of the upper porting valve 204 can be substantially aligned with the second rack of internal gear teeth 228 and offset from the first rack of internal gear teeth 226. The spur gear 214 of the lower porting valve 206 can be substantially aligned with the first rack of internal gear teeth 226 and offset from the second rack of internal gear teeth 228. As such, when the collar 84 is rotated, the spur gear 212 of the upper porting valve 204 can intermesh with the second rack of internal gear teeth 228 but does not intermesh with the first rack of internal gear teeth 226. Similarly, the spur gear 214 of the lower porting valve 206 can intermesh with the first rack of internal gear teeth 226 but will not intermesh with the second rack of internal gear teeth 228. As illustrated in FIG. 18, the spur gears 212, 214 can each be longitudinally spaced from the sun gear 230 such that the sun gear 230 does not engage the spur gears 212, 214. It will be appreciated that multiple tracks of gear teeth can be provided in any of a variety of suitable alternative arrangements for interacting with a plurality of porting valves.

The collar 84 can be engaged with the needle valve 188 to facilitate selective control of the available output torque of the torquing member 52. As illustrated in FIG. 25, the sun gear 230 can be intermeshed with the spur gear 192 of the needle valve 188 such that rotation of the collar 84 can rotate the needle valve 188. Rotating the needle valve 188 can cause the needle valve 188 to translate (i.e., move linearly) relative to the pressure regulator 82 and the manifold 86 such that the needle valve 188 varies the flow rate of the regulated, pressurized air discharged from the discharge chamber 168. In one embodiment, the needle valve 188 can be in threaded engagement with the housing 92 such that rotation of the collar 84 in the counterclockwise direction can facilitate movement of the needle valve 188 towards the blocking position. In such an embodiment, when the needle valve 188 is in the blocking position, the collar 84 can be rotated in the clockwise direction to facilitate movement of the needle valve 188 towards the withdrawn position. In one embodiment, the sun gear 230 can have a continuous geared surface such that the spur gear 192 is continuously engaged with the sun gear 230 during rotation of the collar 84. It will be appreciated that, any of a variety of suitable alternative internal gear teeth arrangements can be provided for engaging and selectively rotating a needle valve.

The collar 84 can thus be operable for facilitating selective control of a direction of rotation of the torquing member 52 as well as selectively controlling the available torque output of the torquing member 52. For example, when the spur gears 212, 214 of the upper and lower porting valves 204, 206 are intermeshed with the second and first racks of internal gear teeth 228, 226, respectively, as illustrated in FIG. 26, the upper and lower porting valves 204, 206 can be in their respective regulating positions. Rotating the collar 84 counterclockwise from this position and into the position shown in FIG. 27 can move the upper and lower porting valves 204, 206 to their respective bypass positions.

When the upper and lower porting valves 204, 206 are in their respective bypass positions (i.e., with the collar 84 positioned as shown in FIG. 27), the needle valve 188 can be in the blocking position. As such, when the exhaust air from the rotary vane motor is provided to the second passageway 112, as discussed above, the tapered portion 194 can interact with (e.g., contact) the inner wall 197 such that the needle valve 188 blocks the exhaust air from back feeding into the discharge chamber 168. The interaction between the tapered portion 194 and the inner wall 197 can prevent further clockwise rotation of the needle valve 188 which can prevent the collar 84 from being rotated counterclockwise when the upper and lower porting valves 204, 206 are in their respective bypass positions. When the collar 84 is then rotated clockwise from the position shown in FIG. 27 to the position shown in FIG. 26 (i.e., to move the upper and lower porting valves 204, 206 from their bypass positions to their regulating positions), the needle valve 188 can be rotated counterclockwise and away from the blocking position enough to let pressurized air to begin to flow through the orifice 149. When the collar 84 is rotated further clockwise, the spur gears 212, 214 can disengage from the second and first racks of internal gear teeth 228, 226 and the needle valve 188 can rotate counterclockwise and further toward the withdrawn position. Further clockwise rotation of the collar 84 can move the needle valve 188 towards the withdrawn position thereby increasing the flow of pressurized air through the orifice 149 and increasing the available output torque of the torquing member 52. The direction of the torquing member 52 as well as the available torque output of the impact driver 40 can accordingly be controlled effectively and precisely from a single location on the impact driver 40.

Since the collar 84 can control the needle valve 188, the rotational position of the collar 84 can correlate to an available output torque for the impact driver 40. Referring now to FIG. 1, the impact driver 40 can include indicia 232 that are associated with the needle valve 188 and provide an indication of the available output torque for application to a work piece by the torquing member 52. In one embodiment, the indicia 232 can be applied to the collar 84 such that it is readily visible to a user during rotation of the collar 84. An arrow 233 can be applied to the casing 42 and can cooperate with the indicia 232 to indicate the available output torque selected for the impact driver 40. It will be appreciated that the indicia 232 can indicate any of a variety of units of torque, such as, for example, foot-pounds, inch-pounds, ounce-inches, or meter-kilograms.

During operation, and when the impact driver 40 is driving a fastener, the torquing member 52 can cease rotation once the selected torque has been reached. The impact driver 40 can additionally or alternatively include an indicator (not shown) that is configured to provide indication to a user when the selected torque has been reached. The indicator can be electrical or mechanical and can provide visual, audible, or other physical indication (e.g., vibration) to a user. In one embodiment, the impact driver 40 can include a plunger-type indicator that selectively projects from the casing 42 in response the selected torque being reached. In another embodiment, the impact driver 40 can include a plurality of different colored lights that can provide different visual indications to a user depending upon the applied torque relative to the selected torque. In such an embodiment, the lights can display a different color when the applied torque is below the selected torque, when the applied torque has reached the selected torque, and when the applied torque exceeds the selected torque, respectively. If a mechanical indicator is provided, the indicator can be powered by pressurized air from within the impact driver 40 or any of a variety of other suitable mechanical power sources. If an electrical indicator is provided, the indicator can be powered by a battery, through power scavenging, or any of a variety of other suitable electrical power sources.

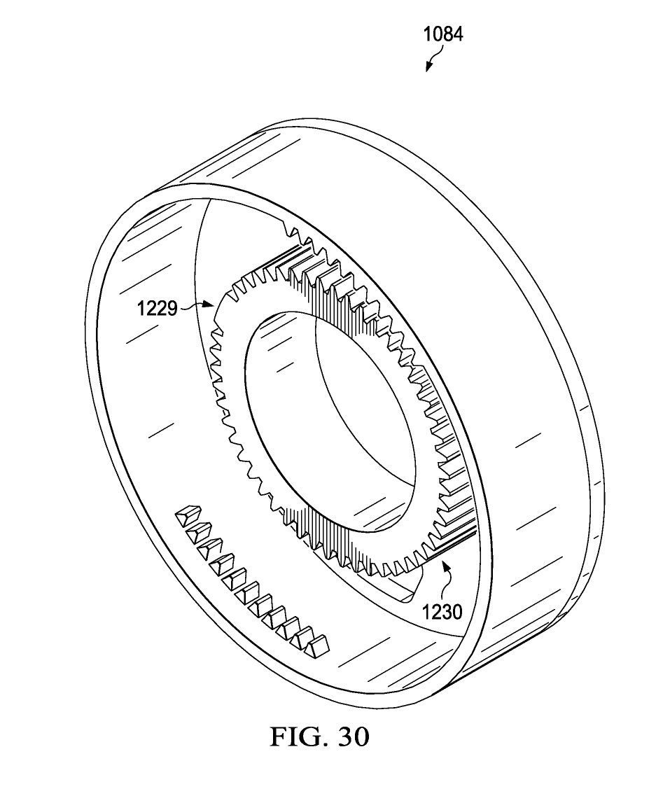

The collar 84 can be configured such that, when in use, it can rotate almost a full 360 degrees but can be prevented from making a complete rotation. In one embodiment, the collar 84 can be prevented from making a complete rotation by a stopping member (not shown). An alternative embodiment of a collar 1084 is illustrated in FIG. 30 and depicts one such stopping member. The collar 1084 is similar in many respects to the collar 84 illustrated in FIGS. 25-29. However, a stopping member 1229 can be defined along a sun gear 1230. The stopping member 1229 can selectively engage a spur gear (e.g., 192) of a needle valve (e.g., 188) to cease rotation of the collar 1084. For example, the spur gear (e.g., 192) can be continuously engaged with a sun gear 1230 of the collar 1084. Once the spur gear (e.g., 192) reaches the stopping member 1229, the spur gear (e.g., 192) is prevented from traversing the stopping member 1229 thereby preventing further rotation of the collar 1084. It will be appreciated that the impact driver 40 can be provided with any of a variety of stopping arrangements for preventing full rotation of the collar 84.

In some embodiments, the impact driver 40 can include a protective coating that can be applied to the impact driver 40 though any of a variety of suitable techniques such as, chemically, electrochemically, through spraying, and/or through powder coating, for example. The protective coating can enhance the durability, aesthetics, and comfort of the impact driver 40. In one embodiment, the protective coating can comprise an elastomeric coating such as a polyurethane/polyurea elastomer coating, for example. The elastomeric coating can mitigate the effects of sudden impact with the exterior of the impact driver 40, such as, for example, as a result of dropping the impact driver 40. The elastomeric coating can also reduce the potential for corrosion that might otherwise occur to some or all of the exposed surfaces of the impact driver 40. The elastomeric coating can be configured to enhance the tackiness of the exterior of the impact driver 40 which can improve a user's grip on the tool and/or can prevent the tool from being easily slid along a surface. During operation of the tool, the elastomeric coating can serve to dampen vibration from the rotary vane motor 54 that might otherwise be imparted to a user's hand and can also serve to reduce the overall noise emitted from the impact driver 40. The elastomeric coating can be applied in a manner that overlies certain external fasteners (not shown) such that the fasteners are less susceptible to inadvertently loosening such as from vibration or repeated sudden impact with external objects. The elastomeric coating can also provide an aesthetically pleasing appearance to the impact driver 40. It is to be appreciated that any of a variety of alternative pneumatic handheld tools can include a similar protective coating.

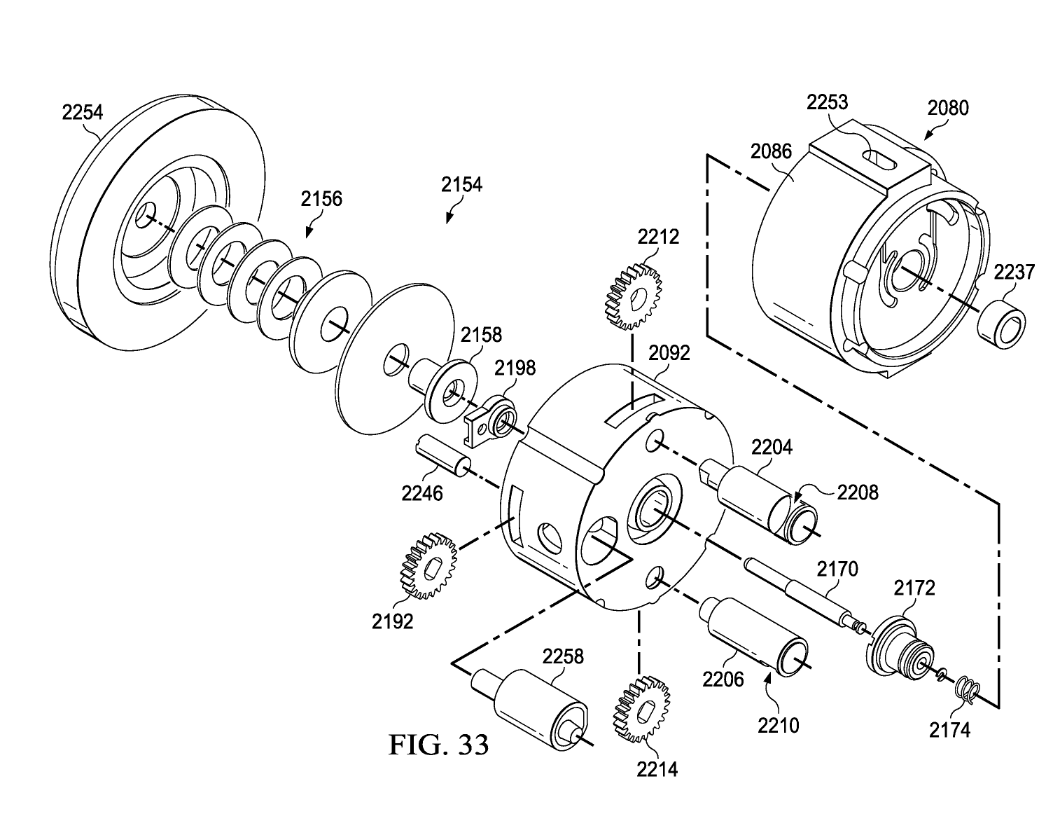

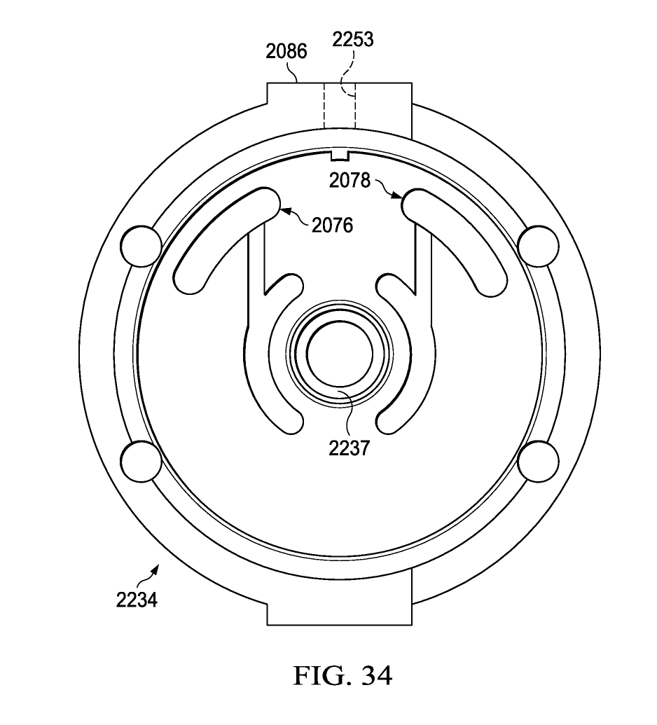

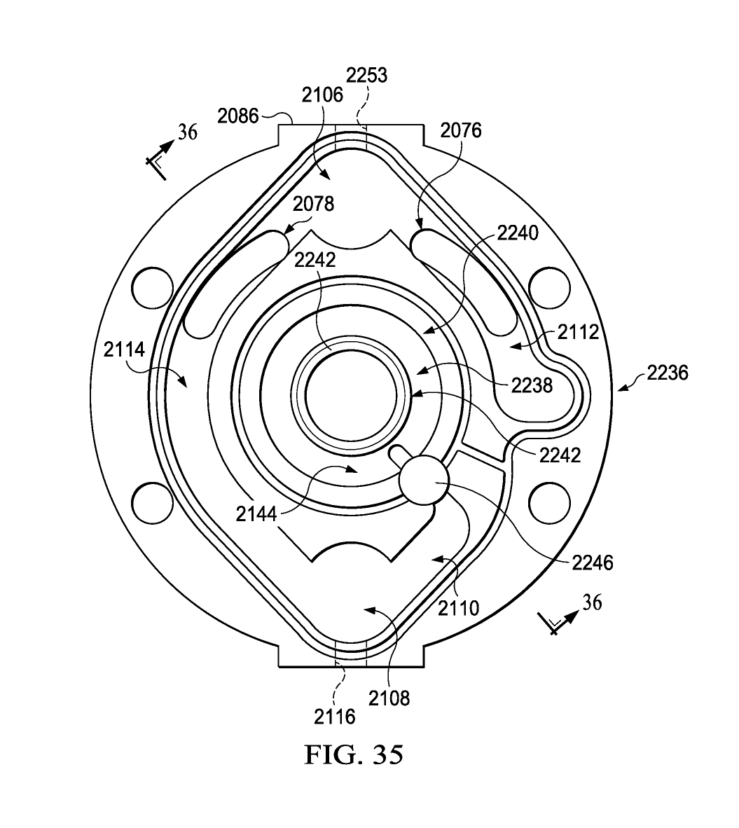

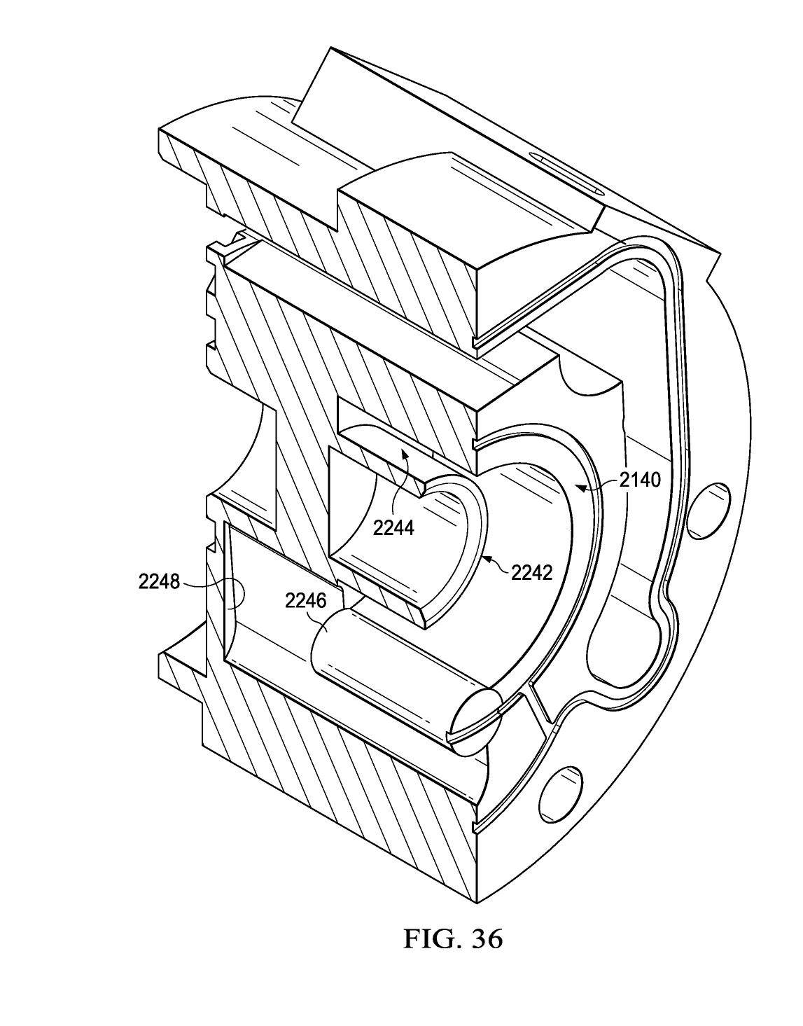

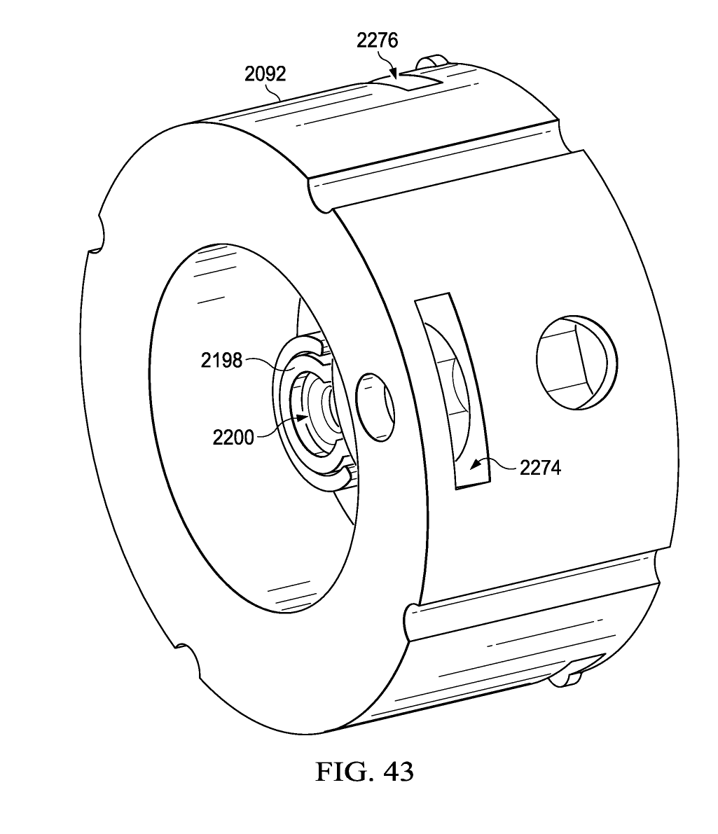

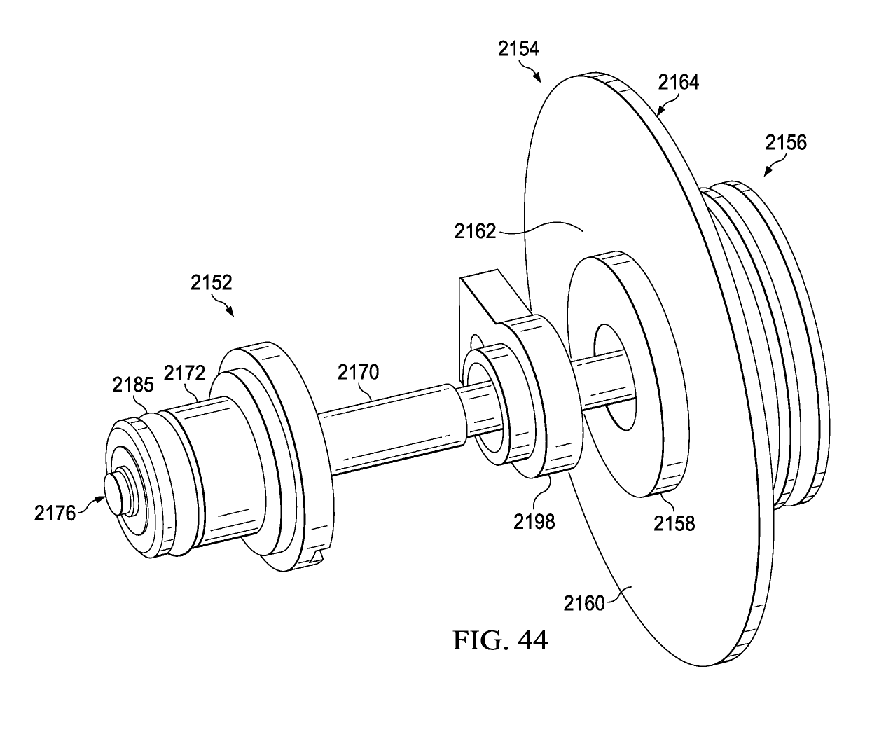

An alternative embodiment of an impact driver 2040 is illustrated in FIGS. 31-49. The impact driver 2040 can be similar to or the same as in many respects as the impact driver 40 shown in FIGS. 1-29. For example, as illustrated in FIG. 31, the impact driver 2040 can include a casing 2042, a rotary vane motor 2054, a manifold assembly 2080, a pressure regulator 2082, and a collar 2084. The rotary vane motor 2054 can provide motive force to a torquing member and a hammer assembly (not shown) in a similar manner as described above with respect to the torquing member 52 and the hammer assembly 53 of FIG. 2. As illustrated in FIGS. 33-37, the manifold assembly 2080 can include a manifold 2086 having a front end 2234 and a rear end 2236. The front end 2234 can be similar to, or the same as in many respects as the rear cap 70 shown in FIGS. 3-5. For example, as illustrated in FIGS. 34 and 35, the manifold 2086 can define a first slot 2076 and a second slot 2078 that extends between the front and rear ends 2234, 2236. Pressurized air can be provided to either of the first slot 2076 or the second slot 2078 to rotate the rotary vane motor 2054 in clockwise and counterclockwise directions, respectively. A needle roller bearing 2237 is shown to be provided at the front end 2234 to facilitate journaling of the rotary vane motor 2054 with respect to the manifold 2086.

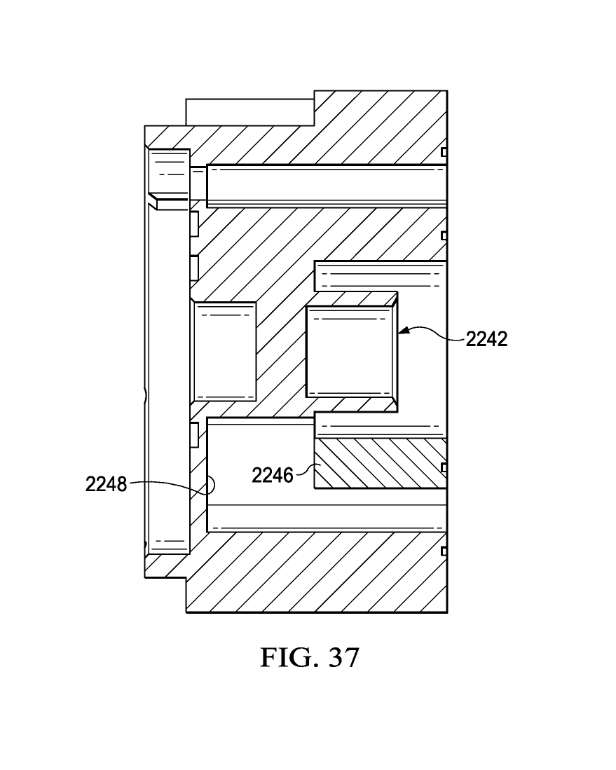

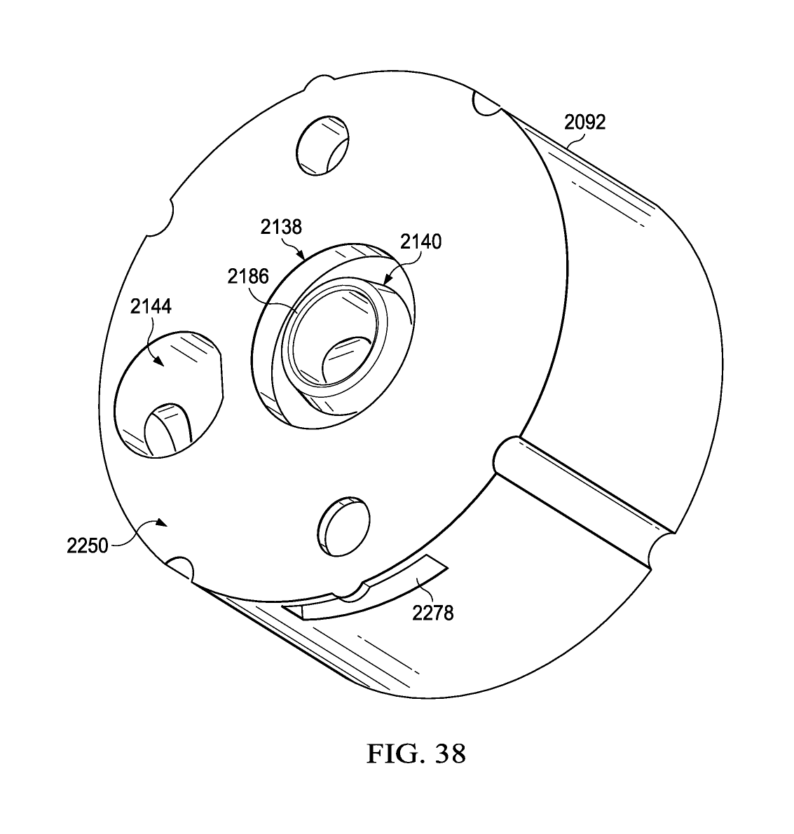

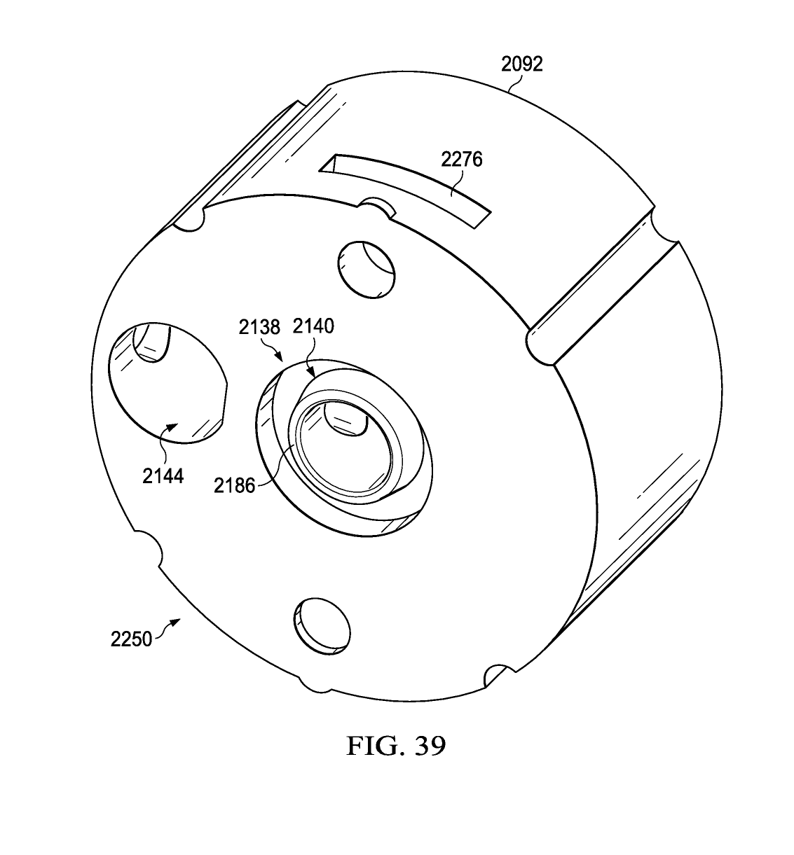

The rear end 2236 can define upper and lower valve receptacles 2106, 2108, first, second, and third elongated pathways 2110, 2112, 2114, and an inlet port 2116 that are similar to, or the same in many respects as, the upper and lower valve receptacles 106, 108, the first, second, and third elongated pathways 110, 112, 114 and the inlet port 116 of the manifold 86 shown in FIGS. 8 and 10-11. For example, the first elongated pathway 2110 can extend to the lower valve receptacle 2108. The second elongated pathway 2112 can extend to the upper valve receptacle 2106. The third elongated pathway 2114 can extend between the upper and lower valve receptacles 2106, 2108. The rear end 2236 can also have a central area 2238 that includes an outer wall portion 2240 and interior wall portion 2242 that cooperate together to define an annular pathway 2244. As illustrated in FIG. 35, the first elongated pathway 2110 can extend into the annular pathway 2244 such that the first elongated pathway 2110 and the annular pathway 2244 are in fluid communication with one another. In one embodiment, as illustrated in FIGS. 35-37, a manifold plug 2246 is shown to be provided in the manifold 2086 between a portion of the first elongated pathway 2110 and the annular pathway 2244. In such an embodiment, the manifold plug 2246 can at least partially fill a borehole caused by boring of the first elongated pathway 2110 into fluid communication with the annular pathway 2244. As illustrated in FIGS. 36 and 37, the manifold plug 2246 can be spaced from a front wall 2248 and the interior wall portion 2242 enough to permit airflow between the interior wall portion 2242 and the annular pathway 2244.

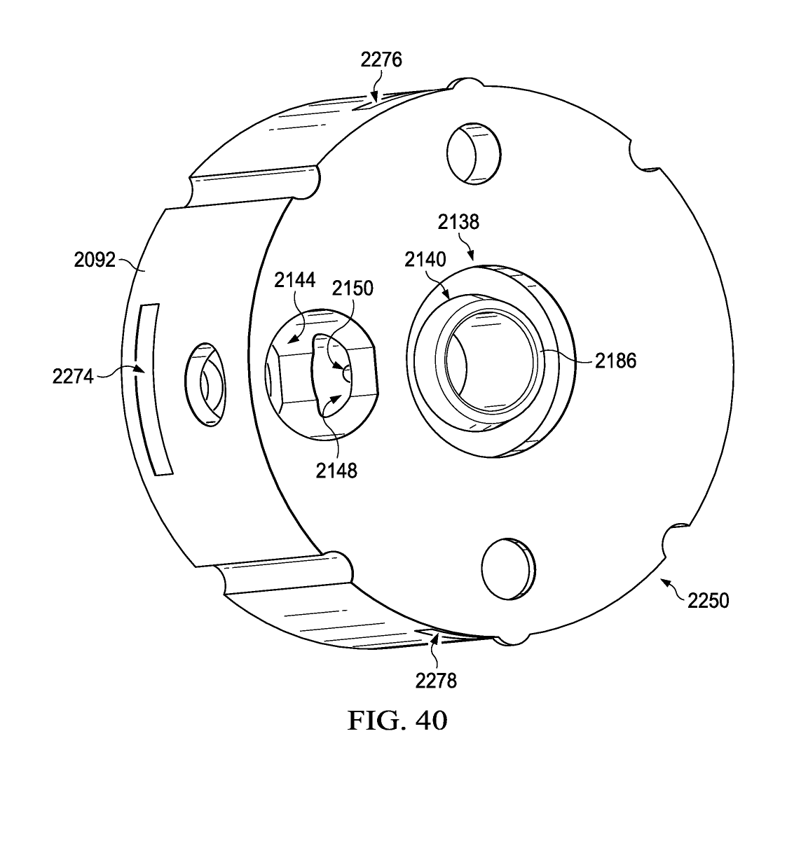

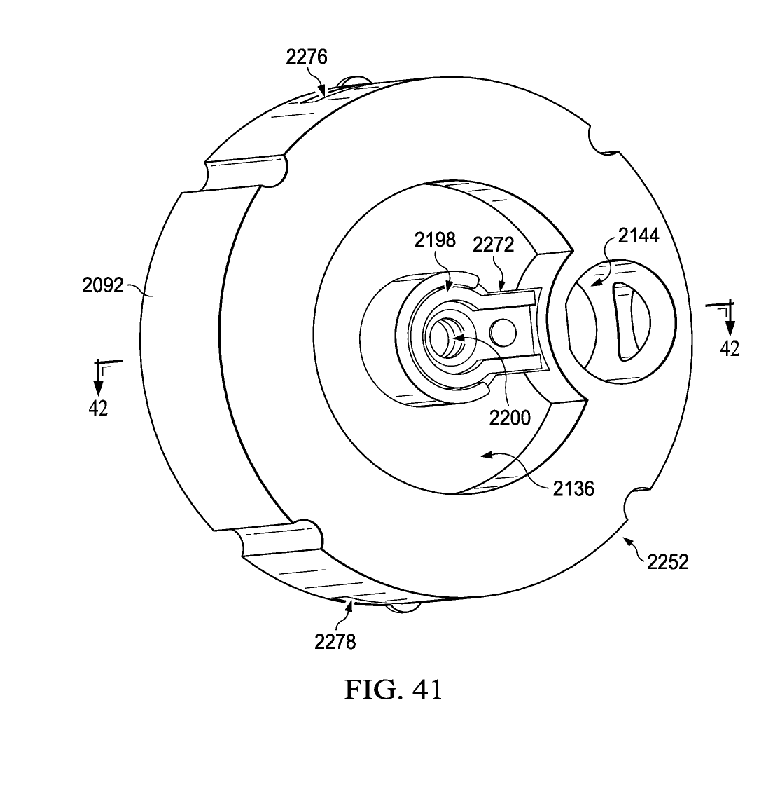

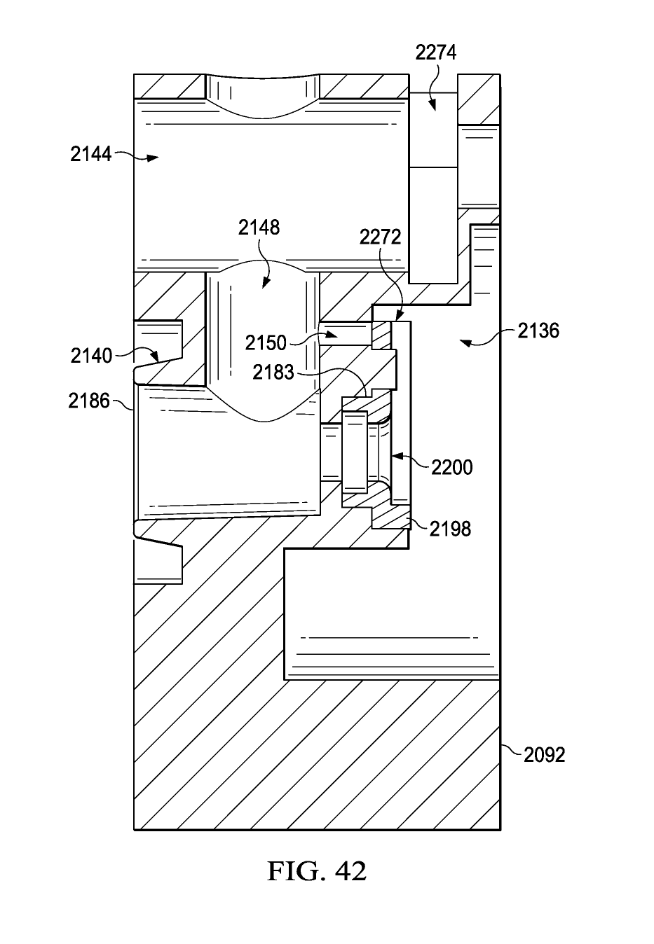

Referring now to FIGS. 31-32 and 38-43, the pressure regulator 2082 can include a housing 2092 that is similar in many respects to the housing 92 shown in FIGS. 11-16. For example, the housing 2092 can include an outer collar portion 2138 and an interior collar 2140. The interior collar 2140 can include a valve seat 2186. The housing 2092 can define an outlet passage 2144 that extends through front and rear ends 2250, 2252 (FIGS. 40 and 41, respectively) of the housing 2092. As illustrated in FIG. 42, an interior collar passage 2148 can extend from the interior collar 2140 to the outlet passage 2144. An internal passage 2150 (FIGS. 40 and 42) can extend from the interior collar passage 2148 to a recess 2136. The pressure regulator 2082, however, can be arranged with the outer collar portion 2138, the interior collar 2140, and the valve seat 2186 disposed at the front end 2250 of the manifold 2086 and with the recess 2136 disposed at the rear end 2252 of the manifold 2086. In addition, the housing 2092 can define an exhaust port 2253 that is in fluid communication with the second and third elongated pathways 2112, 2114 (FIG. 35).

Referring now to FIGS. 33, 44 and 45, the pressure regulator 2082 can include a regulator valve assembly 2152, a diaphragm assembly 2154, and a biasing member 2156 that is similar to, or the same as in many respects as, the regulator valve assembly 152, the diaphragm assembly 154, and the biasing member 156, respectively illustrated in FIGS. 7, 17, and 18. For example, the diaphragm assembly 2154 can include a generally central member 2158 and an annular flexible member 2160 comprising a radially inner portion 2162 and a radially outer portion 2164.

The regulator valve assembly 2152 can include a valve stem 2170 and a valve plug 2172. As illustrated in FIG. 45, the valve stem 2170 can comprise a first end portion 2176 and a second end portion 2178. The first end portion 2176 can be engaged with the valve plug 2172 and the second end portion 2178 can extend through a central bore 2183 of the housing 2092 and into engagement with the generally central member 2158 of the diaphragm assembly 2154. The valve plug 2172 can be at least partially disposed within an interior wall portion 2242 of the manifold 2086. A return spring 2174 can extend between the valve plug 2172 and the manifold 2086. An O-ring 2185 can be provided between the valve plug 2172 and the interior wall portion 2242. The diaphragm assembly 2154 can be disposed between the housing 2092 and an end cap 2254 and secured to at least one of the housing 2092 and the end cap 2254. For example, as illustrated in FIG. 45, the radially outer portion 2164 of the diaphragm assembly 2154 can be sandwiched between the housing 2092 and the end cap 2254. With the diaphragm assembly 2154 sandwiched between the housing 2092 and the end cap 2254, the end cap 2254 and the diaphragm assembly 2154 can cooperate to define a vented chamber 2166 and the housing 2092 and the diaphragm assembly 2154 can cooperate to define a discharge chamber 2168. The vented chamber 2166 can be in fluid communication with a vent port 2256 to permit the flow of exhaust air from the pressure regulator 2082 as the pressure within the discharge chamber 2168 changes. The regulator valve assembly 2152 can be movable together with the diaphragm assembly 2154 and relative to the valve seat 2186 between an opened position and a closed position to facilitate discharging of regulated, pressurized air at a substantially constant pressure from the discharge chamber 2168.

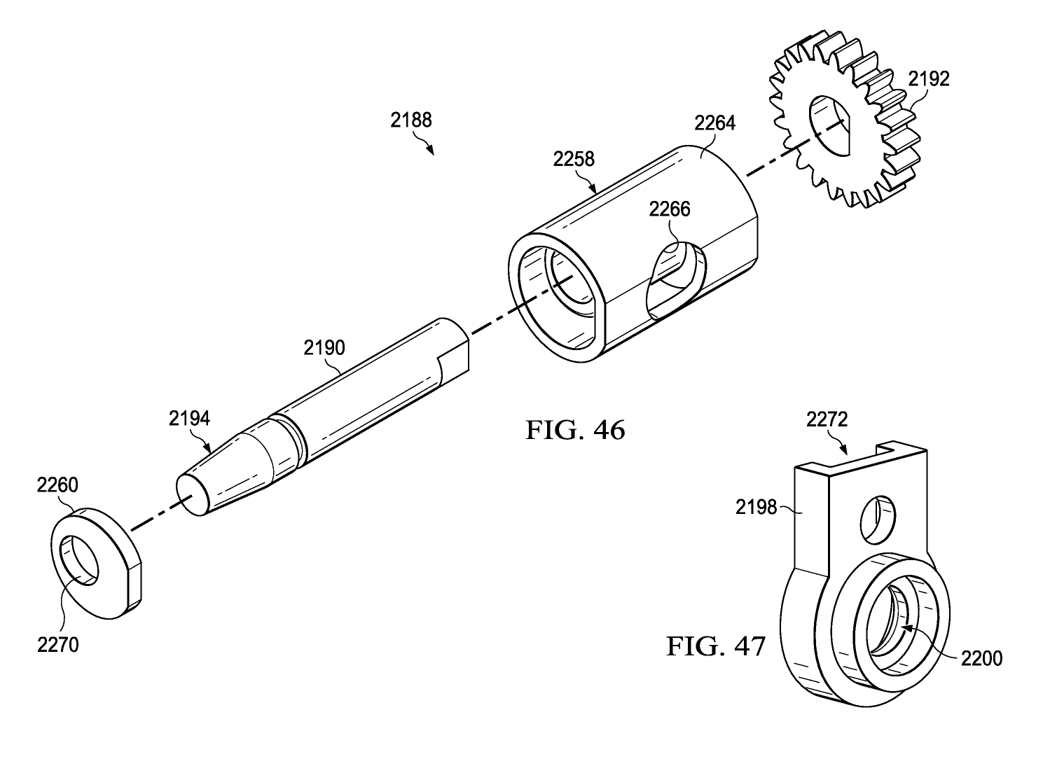

Referring now to FIGS. 33 and 46, the impact driver 2040 can include a needle valve 2188 that is similar to, or the same as in many respects as, the needle valve 188 illustrated in FIG. 20. For example, the needle valve 2188 can include a restricting member 2190 and a spur gear 2192. However, the needle valve 2188 can include a housing 2258 and an end plate 2260 that cooperate together to at least partially surround the restricting member 2190. The housing 2258 can be rigidly coupled with the housing 2092 of the pressure regulator 2082. As illustrated in FIGS. 45 and 46, the housing 2258 can include an inner wall 2262 and an outer wall 2264. The inner wall 2262 can be in contacting engagement with the restricting member 2190 and the outer wall 2264 can define a port 2266. Respective portions of the inner and outer walls 2262, 2264 can be spaced from each other such that an interior annular pathway 2268 (FIG. 45) is defined between the inner and outer walls 2262, 2264. The restricting member 2190 can move linearly with respect to the end plate 2260 such that a tapered portion 2194 can move with respect to an aperture 2270 of the end plate 2260 to facilitate selective control of a flow rate of the regulated air from the discharge chamber 2168, through the port 2266, through the interior annular pathway 2268, through the aperture 2270, and to the manifold 2086.

Referring now to FIGS. 41-45 and 47, the pressure regulator 2082 can comprise a flow distributor 2198 that is similar to, or the same as in many respects as, the flow distributor 198. For example, the flow distributor 2198 can define an aperture 2200 and can be disposed within the recess 2136 of the housing 2092. However, as illustrated in FIG. 42, an end portion 2272 of the flow distributor can overlie the internal passage 2150. Pressurized air that flows through the interior collar passage 2148 and over the internal passage 2150 can create a Bernoulli Effect within the discharge chamber 2168 that enhances the pressure regulating capabilities of the pressure regulator 2082.

Referring now to FIG. 33, the manifold assembly 2080 can include upper and lower porting valves 2204, 2206 that are similar to, or the same in many respects as, upper and lower porting valves 204, 206, respectively, shown in FIGS. 7, 8, 18, and 23-24. For example, each of the upper and lower porting valves 2204, 2206 can have a respective valve member (e.g., 2208, 2210) and spur gear (e.g., 2212, 2214) disposed at opposite ends of the upper and lower porting valves 2204, 2206, respectively. The upper porting valve 2204 can extend through the manifold 2092 and into the upper valve receptacle 2106 of the manifold 2086 such that the valve member 2208 of the upper porting valve 2204 is disposed between the second and third elongated pathways 2112, 2114. The lower porting valve 2206 can extend through the manifold 2092 and into the lower valve receptacle 2108 such that the valve member 2210 of the lower porting valve 2206 is disposed between the first and third elongated pathways 2110, 2114.

The upper and lower porting valves 2204, 2206 of FIG. 33 can be rotatable between respective regulating positions and respective bypass positions in a similar manner as described above with respect to the upper and lower porting valves 204, 206 of FIGS. 7, 8, 18, and 23-24. When the upper and lower porting valves 2204, 2206 are in their respective regulating positions, pressurized air provided to the inlet port 2116 (e.g., when the trigger 58 is actuated) can be regulated by the pressure regulator 2082, can flow through the first slot 2076 and to the rotary vane motor 2054 to facilitate rotation in the clockwise direction. The exhaust air can be routed through the second slot 2078 and directed through the exhaust port 2253 by the upper porting valve 2204. The upper porting valve 2204 can also block the exhaust air from entering the second elongated pathway 2112. When the upper and lower porting valves 2204, 2206 are in their respective bypass positions, pressurized air provided to the inlet port 2116 can bypass the pressure regulator 2082 and can be provided directly to the rotary vane motor 2054 through the second slot 2078 to facilitate counterclockwise rotation of the rotary vane motor 2054. Exhaust air can be exhausted through the first slot 2076 and the exhaust port 2253.

The positions of the upper and lower porting valves 2204, 2206 and the needle valve 2188 can be selected through rotation of the collar 2084 in a similar manner as described with respect to collar 84 illustrated in FIGS. 7, 8, and 25-29. As illustrated in FIGS. 48 and 49, the collar 2084 can include an annular casing 2218 having an inner surface 2222 and an outer surface 2224. First, second and third racks of internal gear teeth 2280, 2282, 2284 can be integral with, and can extend inwardly from, the inner surface 2222 of the annular casing 2218. The first rack of internal gear teeth 2280 can extend along substantially the entire inner circumference of the collar 2084. The second rack of internal gear teeth 2282 can be spaced from the first rack of internal gear teeth 2280 and can extend along only a portion of the inner surface 2222 of the annular casing 2218 for an arc length that is less than the circumference of the inner surface 2222 of the annular casing 2218. The third rack of internal gear teeth 2284 can extend longitudinally from the first rack of internal gear teeth 2280.

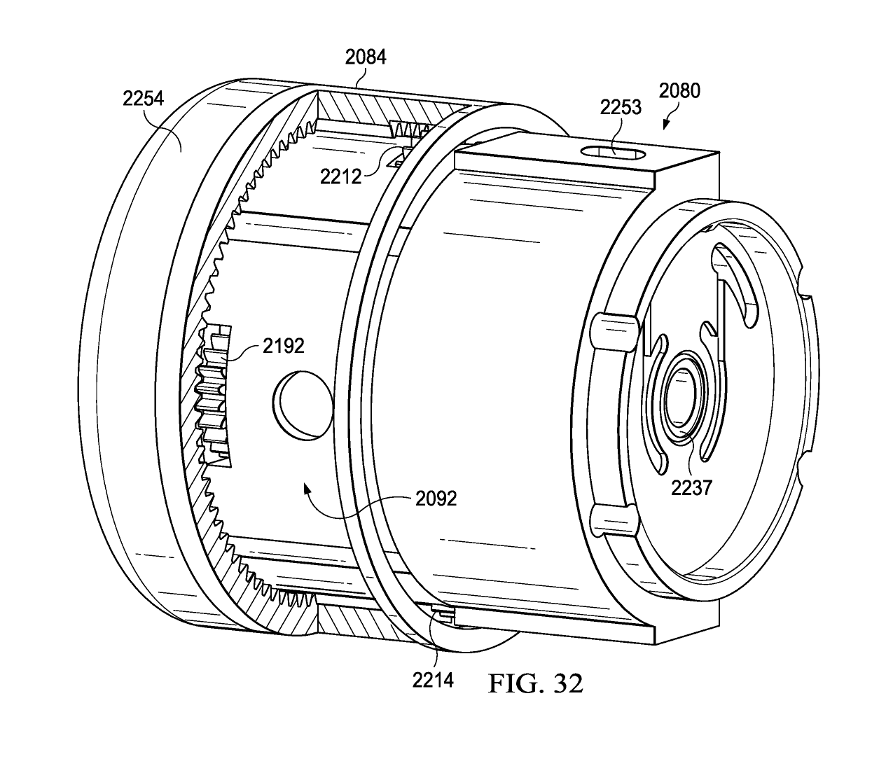

Referring now to FIGS. 32 and 33, the collar 2084 can overlie the manifold 2092 and the manifold 2092 can define slots 2274, 2276, 2278. The spur gear 2192 of the needle valve 2188 can protrude through the slot 2274 and can intermesh with the first rack of internal gear teeth 2280. The spur gear 2212 of the upper porting valve 2204 can protrude through the slot 2276 and can selectively intermesh with the second rack of internal gear teeth 2282. The spur gear 2214 of the lower porting valve 2206 can protrude through the slot 2278 and can selectively intermesh with the third rack of internal gear teeth 2284. When the spur gears 2212, 2214 are intermeshed with the second and third racks of internal gear teeth 2282, 2284, rotation of the collar 2084 can facilitate substantially simultaneous rotation of the upper and lower porting valves 2204, 2206 between their respective regulating and bypass positions. Once the spur gears 2212, 2214 are disengaged from the second and third racks of internal gear teeth 2282, 2284, respectively, the upper and lower porting valves 2204, 2206 can be maintained in their current positions. The collar 2084 can include indicia 2232 that provide an indication of the available output torque for application to a work piece by the impact driver 2040.

Rotation of the collar 2084 can also rotate the restricting member 2190 to cause the restricting member 2190 to translate (i.e., move linearly) relative to the housing 2258 in a similar manner as the needle valve 188 relative to the pressure regulator 82 described above and illustrated in FIG. 20. However, once the needle valve 2188 has been withdrawn completely from the end plate 2260 (e.g., in a fully withdrawn position), further rotation of the needle valve 2188 in the withdrawn direction can rotate the housing 2258 from the intake position to the exhaust position in order to provide the port 2266 into fluid communication with the exhaust port 2253 and block the interior collar passage 2148 thereby facilitating operation of the rotary vane motor 2054 in the reverse direction.

Referring now to FIGS. 50-61, one embodiment of a trigger valve assembly 3300 is provided as part of an impact driver 3040. It will be appreciated that the trigger valve assembly 3300 can be provided for any of a variety of other pneumatic tools. The trigger valve assembly 3300 can facilitate selective dispensation and regulation of pressurized air from a fluid supply source to a motive power source (e.g., a rotary vane motor or a pneumatic linear motor). The trigger valve assembly 3300 is shown to be disposed within a hollow handgrip 3048 and associated with a motor casing 3041 having a motive power source (not shown) disposed therein. It will be appreciated that in some embodiments, the trigger valve assembly 3300 can be provided in lieu of a manifold assembly (e.g., 80, 2080) and a pressure regulator (e.g., 82, 2082) disposed within a head of an impact driver (e.g., 40, 2040).

As illustrated in FIGS. 50 and 51, the trigger valve assembly 3300 can include a regulator portion 3302 and a trigger portion 3304. The regulator portion 3302 can include a regulator plug 3306, a regulator body 3308, and a regulator sleeve 3310. As illustrated in FIGS. 50-52, the regulator plug 3306 can define an inlet port 3312 (FIG. 50), an outlet slot 3314, and a threaded passage 3316 that are all in fluid communication with each other. A coupling arrangement, such as a quick release coupling, can be threaded into the inlet port 3312 to facilitate selective, releasable coupling of a fluid source to the regulator plug 3306. In one embodiment, as illustrated in FIGS. 50 and 51, a threaded reducer 3318 can be threaded into the inlet port 3312 to provide a different internal thread dimension.

The regulator body 3308 can be provided upstream of the regulator plug 3306. As illustrated in FIGS. 50 and 51, the regulator sleeve 3310 can be disposed circumferentially about the regulator body 3308. A portion of the regulator sleeve 3310 can extend over the regulator plug 3306 to facilitate coupling of the regulator plug 3306, regulator body 3308, and the regulator sleeve 3310 together. An O-ring 3320 can provide an effective seal between the regulator plug 3306 and the regulator sleeve 3310. The regulator body 3308 and the regulator sleeve 3310 can cooperate to define an outer elongate pathway 3321 between the regulator body 3308 and the regulator sleeve 3310.

As illustrated in FIGS. 53 and 54, the regulator body 3308 can define a radial pathway 3322 and a longitudinal pathway 3324. As illustrated in FIG. 55, the radial pathway 3322 can be in fluid communication with a valve chamber 3344 defined by the regulator body 3308. As illustrated in FIG. 56, the longitudinal pathway 3324 can be in fluid communication with a piston chamber 3342 defined by the regulator body 3308. As illustrated in FIG. 55, a piston 3346 can be disposed in the piston chamber 3342 and a biasing member 3348 can be sandwiched between the piston 3346 and the regulator plug 3306. The biasing member 3348 can bias the piston 3346 away from the regulator plug 3306. In one embodiment, the biasing member 3348 can comprise a pair of Belleville springs. A set screw 3349 can be threaded into the threaded passage 3316 of the regulator plug 3306. The set screw 3349 can extend through the biasing member 3348 and into contact with the piston 3346. The set screw 3349 can be rotated with respect to the regulator plug 3306 can vary the travel distance of the piston 3346 to thereby change the regulated pressure discharged from the regulator portion 3302. A bushing 3350 can be provided between the biasing member 3348 and the set screw 3349 to allow the biasing member 3348 to move with respect to the set screw 3349. In another embodiment, the set screw 3349 can engage the biasing member 3348 and can be rotated with respect to the regulator plug 3306 to vary the spring constant of the biasing member 3348 to thereby change the regulated pressure of the regulator portion 3302.

As illustrated in FIG. 55, a regulator valve stem 3352 can be coupled at a first end 3354 to the piston 3346 and slidably coupled at a second end 3356 to a spring cap 3358. The second end 3356 can be slidable with respect to the spring cap 3358 to allow the piston 3346 to slide within the piston chamber 3342. The second end 3356 can cooperate with the spring cap 3358 to define an interior chamber 3359. A biasing member 3360 can be provided between the second end 3356 of the regulator valve stem 3352 and the spring cap 3358. The biasing member 3360 can bias the regulator valve stem 3352 away from the spring cap 3358. It is to be appreciated that the regulator valve stem 3352 can cooperate with other features of the regulator body 3308 to define an interior chamber 3359.

Referring now to FIGS. 57 and 58, the regulator valve stem 3352 can define a pair of inner lateral pathways 3366 and an inner longitudinal pathway 3368 that are all in communication with each other. The inner lateral pathways 3366 can be in fluid communication with the piston chamber 3342 and the inner longitudinal pathway 3368 can be in fluid communication with the interior chamber 3359.

With the regulator valve stem 3352 coupled with the piston 3346, the regulator valve stem 3352 can be movable together with the piston 3346 and relative to the spring cap 3358 between an opened position (not shown) and a closed position (FIG. 55). Movement of the regulator valve stem 3352 between the opened and closed positions can cause the piston chamber 3342 and the valve chamber 3344 to be in intermittent fluid communication. For example, when the regulator valve stem 3352 is in the closed position, as illustrated in FIG. 55, the regulator valve stem 3352 can be seated upon a valve seat 3361 (FIG. 55) of the regulator body 3308 to create a sealing interface such that the piston chamber 3342 and the valve chamber 3344 are fluidically uncoupled from one another. In one embodiment, an elastomeric material (not shown) can be provided as the sealing interface between the regulator valve stem 3352 and the valve seat 3361. When the regulator valve stem 3352 is in the opened position (not shown), the regulator valve stem 3352 can be spaced from the valve seat 3361 such that the piston chamber 3342 and the valve chamber 3344 are in fluid communication with one another.

The regulator portion 3302 can be configured to facilitate discharging of regulated, pressurized air at a substantially constant pressure from piston chamber 3342. When unregulated pressurized air is provided to the valve chamber 3344 (e.g., from the inlet port 3312 when the trigger is actuated), the regulator valve stem 3352 can move between the opened and closed positions to facilitate regulation of the air pressure within the piston chamber 3342. When the piston chamber 3342 is pressurized, the pressurized air can flow through the inner lateral pathways 3366 and the inner longitudinal pathway 3368 of the regulator valve stem 3352 to similarly pressurize the interior chamber 3359. The regulator valve stem 3352 can move to a position that facilitates regulation of the pressure within the piston chamber 3342 to a substantially constant pressure in response to the respective biasing forces from the biasing members 3348, 3360 as well as the difference in pressure between the valve chamber 3344 and the interior chamber 3359. The regulated pressurized air from the piston chamber 3342 can flow through the longitudinal pathway 3324 of the regulator body 3308 and to the trigger portion 3304. As such, the regulator portion 3302 can be compact and fast-acting and can facilitate high-response pressure regulation with high repeatability. It is to be appreciated that the regulator portion 3302 can be provided on a handheld pneumatic tool in lieu of other on-board regulators, such as pressure regulators 82 and 2082 described above.

Referring now to FIGS. 50, 51, 59 and 60, the trigger portion 3304 can be positioned upstream of the regulator portion 3302 and can include a valve member 3372, a valve seat 3374, a shoulder 3376, and a valve spring 3378 that are at least partially surrounded by a housing 3380. The housing 3380 can define a pair of upper notches (e.g., 3381 shown in FIGS. 51 and 59). As illustrated in FIGS. 59 and 60, the housing 3380 can include a lower shoulder portion 3385 that at least partially defines a lower circumferential notch 3383. The valve member 3372 can include a base portion 3382 and a valve stem 3384 that extends from the base portion 3382. The valve spring 3378 can be coupled with the valve member 3372 and can bias the valve member 3372 into a released position (shown in FIG. 50). In one embodiment, a portion of the valve spring 3378 can be wound around the base portion 3382 to facilitate coupling of the valve member 3372 and the valve spring 3378 together. When the valve member 3372 is in the released position (e.g., a closed position), the base portion 3382 can interact with an O-ring 3386 interposed between the valve seat 3374 and the shoulder 3376 to substantially prevent pressurized air from passing through the trigger portion 3304 to a motive power source (e.g., a rotary vane motor). Another O-ring 3379 can be provided between the valve seat 3374 and the housing 3380 to provide an effective seal therebetween. A sealing member 3387 can be provided between the regulator portion 3302 and the housing 3380 to provide an effective seal therebetween. In one embodiment, the sealing member 3387 can be affixed to the housing 3380.

As illustrated in FIGS. 50 and 51, the valve stem 3384 of the valve member 3372 can be coupled to a trigger 3058 by a trigger stem 3388. When the trigger 3058 is depressed, the trigger stem 3388 can interact with the valve stem 3384 to move the valve member 3372 into an opened position by urging the base portion 3382 away from the O-ring 3386 enough to permit pressurized air to flow through the housing 3380.

Referring again to FIG. 50, the trigger stem 3388 is shown to extend through an aperture 3390 defined by the housing 3380 and into engagement with the valve stem 3384. An outlet collar 3392 can be located upstream from the housing 3380 and can be configured to facilitate routing of pressurized air from the trigger portion 3304 to a motive power source. In one embodiment, as illustrated in FIGS. 61 and 62, the outlet collar 3392 can include an upper end 3394 (FIG. 61) and a lower end 3396 (FIG. 62). The lower end 3396 can define an inlet opening 3397 and a pair of cleats 3398. The upper end 3394 can include an upper shoulder 3399 and a sloped upper surface 3404. The upper shoulder 3399 can define an upper outlet opening 3400. The outlet collar 3392 can include a geared outer surface 3406 that is disposed between the upper end 3394 and the lower end 3396.

Referring now to FIGS. 63 and 64, the trigger valve assembly 3300 can include a flapper valve 3410 can include a body 3412 and a flapper portion 3416 hingedly coupled with the body 3412. The flapper portion 3416 can be pivotable with respect to the body 3412 between an opened position (FIG. 63) and a closed position (FIG. 64). In one embodiment, the flapper portion 3416 can be hingedly coupled with the body 3412 by a living hinge. The body 3412 can define a passageway 3413 and can include a lip 3414 that is adjacent to the flapper portion 3416 and interacts with the flapper portion 3416 when the flapper portion 3416 is in the closed position. The flapper portion 3416 can define a through hole 3418.

Referring now to FIG. 65, the motor casing 3041 can include a first port 3420 and a second port 3422 that are each in fluid communication with the motive power source. The first port 3420 and the second port 3422 can allow fluid to be provided to, and exhausted from the motive power source to facilitate operation of the motive power source. The flapper valve 3410 can inserted into the first port 3420 such that the body 3412 extends into the first port 3420 and the flapper portion 3416 is flush with the area of the motor casing 3041 surrounding the first port 3420.

Referring now to FIGS. 66-69, the outlet collar 3392 can be pivotable between a forward operating position (FIGS. 66 and 67) and a reverse operating position (FIGS. 68 and 69) to facilitate operation of the motive power source in a forward direction and a reverse direction, respectively. It is to be appreciated that the housing 3380 of the trigger portion 3304 and the outlet collar 3392 can be sandwiched together such that the pair of cleats 3398 project into the respective upper notches (e.g., 3381 shown in FIGS. 51 and 59) to couple the housing 3380 and the outlet collar 3392 together. As a result, the housing 3380 can be pivotable together with the outlet collar 3392 between the forward operating position and the reverse operating position.

The flapper portion 3416 of the flapper valve 3410 can be movable between the closed position and the opened position in response to pivoting of the outlet collar 3392 between the forward operating position and the reverse operating position, respectively. For example, when the outlet collar 3392 is in the forward operating position, as illustrated in FIGS. 66 and 67, the upper shoulder 3399 of the outlet collar 3392 can underlie the flapper valve 3410 and can urge the flapper portion 3416 into the closed position. The second port 3422 of the motor casing 3041 can overlie the sloped upper surface 3404. When the trigger 3058 is depressed and the valve member 3372 moves to the opened position, regulated pressurized air can flow through the upper outlet opening 3400, through the through hole 3418 of the flapper valve 3410, through the first port 3420 of the motor casing 3041, and to the motive power source to operate the motive power source in the forward direction. Exhaust air from the motive power source can be exhausted out of the second port 3422 of the motor casing 3041 and to the sloped upper surface 3404. The sloped upper surface 3404 can then route the exhaust air away from the trigger portion 3304 and to an exhaust chamber 3442 (FIG. 50) defined by the hollow handgrip 3048. The hollow handgrip 3048 can include a vent (not shown) in fluid communication with the exhaust chamber 3442 to allow the exhaust air to vent from the hollow handgrip 3048.

When the outlet collar 3392 is in the reverse operating position, as illustrated in FIGS. 68 and 69, the sloped upper surface 3404 can underlie the flapper valve 3410 such that the flapper portion 3416 is no longer obstructed by the upper shoulder 3399 of the outlet collar 3392 and is thus free to move to the opened position. The upper shoulder 3399 of the outlet collar 3392 can underlie the second port 3422 of the outlet collar 3392. When the trigger 3058 is depressed and the valve member 3372 moves to the opened position, unregulated pressurized air can flow through the upper outlet opening 3400, through the second port 3422 of the motor casing 3041 and to the motive power source to operate the motive power source in the reverse direction. Exhaust air from the motive power source can be exhausted out of the first port 3420 of the motor casing 3041, through the passageway 3413 of the flapper valve 3410, and to the sloped upper surface 3404 which can route the exhaust air to the exhaust chamber 3442 of the hollow handgrip 3048.

The flow of regulated or unregulated air to the motive power source can be affected by whether the outlet collar 3392 is in the forward operating position of the reverse operating position. For example, when the outlet collar 3392 is in the forward operating position, the flow of the pressurized air to the motive power source is restricted enough by the flapper valve 3410 (e.g., the through hole 3418) to cause air to flow through the regulator portion 3302 such that regulated air is provided to the motive power source. When the outlet collar 3392 is in the reverse operating position, the flow of pressurized air is no longer restricted by the flapper valve 3410. The pressurized air can bypass the regulator portion 3302 (e.g., taking the path of least resistance) such that unregulated air is provided to power the motive power source in the reverse direction. Since the pressurized air provided to the motive power source during reverse operation is not provided through the regulator portion 3302, the flow rate of the air to the motive power source can be greater than when operating in the forward direction. As a result, more torque can be available from the impact driver 3040 when in reverse to aid in releasing a fastener when stuck or excessively tightened. It is to be appreciated that the size of the through hole 3418 can be selected to achieve a desired flow rate of air through the regulator portion 3302. Setting the flow rate in this manner can aid in consistent control of the regulated pressure from the regulator portion 3302 (e.g., with the set screw 3349).

Referring now to FIG. 70, the trigger valve assembly 3300 can include an actuator 3430 that is configured to facilitate pivoting of the outlet collar 3392 between the forward operating position and the reverse operating position. The actuator 3430 can include a body 3434, a lever 3436, and a pin member 3440 located at a bottom portion of the body 3434. The actuator 3430 can be releasably, pivotally coupled with the hollow handgrip 3048 by a support member 3438. The support member 3438 can interact with the pin member 3440 to facilitate pivoting of the actuator 3430 about the pin member 3440 between a forward position (FIGS. 66 and 67) and a reverse position (FIGS. 68 and 69). The geared surface 3432 can be meshingly engaged with the geared outer surface 3406, as illustrated in FIGS. 66 and 68, such that pivoting of the actuator 3430 between the forward position and the reverse position causes the outlet collar 3392 to pivot between the forward operating position and the reverse operating position, respectively. The lever 3436 can be accessible to a user's hand when gripping the hollow handgrip 3048 such that the user can actuate the lever 3436 to facilitate selection between operation of the motive power source in either a forward direction or a reverse direction. In one embodiment, the lever 3436 can extend from a rear end of the hollow handgrip 3048.

Another embodiment of an impact driver 4040 is shown in FIGS. 71-78. The impact driver 4040 can be similar to, or the same in many respects as, the impact driver 3040 shown in FIGS. 50-70. For example, the impact driver 4040 can include a trigger valve assembly 4300 having a regulator portion 4302 and a trigger portion 4304 disposed within a hollow hand grip 4048. The regulator portion 4302 can include a regulator plug 4306 and a regulator body 4308 located upstream from the regulator plug 4306. The regulator portion 4302 can also include a piston 4346 that defines an inner longitudinal pathway 4368, as illustrated in FIGS. 71 and 72. The trigger portion 4304 can include a housing 4380 and an outlet collar 4392 located upstream from the housing 4380. The housing 4380 and the outlet collar 4392 can be pivotable between a forward operating position and a reverse operating position.

However, referring now to FIGS. 73 and 74, the regulator body 4308 can define a piston chamber 4342 and a longitudinal flow path 4343 adjacent to the piston chamber 4342. An upper end 4444 of the regulator body 4308 can define a bore 4446 and a through hole 4448. The bore 4446 can extend into the longitudinal flow path 4343 and the through hole 4448 can extend into the piston chamber 4342. A first annular groove 4450 can surround the bore 4446 and the second annular groove 4452 can surround the through hole 4448.

As illustrated in FIGS. 71 and 72, the piston 4346 can be associated with a seal member 4454 and a piston stop 4456. The seal member 4454 can be a substantially annular and can have an internal O-ring 4458. As illustrated in FIG. 71, each of the piston 4346, the seal member 4454 and the piston stop 4456 can be disposed within the piston chamber 4342. The seal member 4454 can be interposed between the regulator body 4308 and the piston 4346 to create and effective seal therebetween.

Referring now to FIGS. 75 and 76, the piston stop 4456 can include an upper end 4460 and a lower end 4462, and a plug member 4464 disposed at the upper end 4460 (see FIG. 75). The piston stop 4456 can define a plurality of passageways 4466 that extend between the upper end 4460 and the lower end 4462. The passageways 4466 can be disposed circumferentially about the plug member 4464.

The piston 4346 can be movable between an opened position (FIG. 71) and a closed position (not shown). Movement of the piston 4346 between the opened and closed positions can cause the inner longitudinal pathway 4368 of the piston 4346 and an inlet port 4312 (FIGS. 71 and 72) of the regulator body 4308 to be in intermittent fluid communication. For example, when the piston 4346 is in the closed position, the piston 4346 can be seated upon the plug member 4464 to create a sealing interface such that the inner longitudinal pathway 4368 and the inlet port 4312 are fluidically uncoupled from one another. In one embodiment, an elastomeric material (not shown) can be provided as the sealing interface between the piston 4346 and the plug member 4464. When the piston 4346 is in the opened position (FIG. 71), the piston 4346 can be spaced from the plug member 4464 such that the inner longitudinal pathway 4368 and the inlet port 4312 are in fluid communication with one another. A biasing member 4468 can be interposed between the piston 4346 and the seal member 4454 and can bias the piston 4346 into the opened position.

When unregulated pressurized air is provided to the inlet port 4312 (FIGS. 71 and 72) of the regulator body 4308, the unregulated pressurized air can flow through the passageways 4466 of the piston stop 4456, into the piston chamber 4342, and through the longitudinal pathway 4368 of the piston 4346. The piston 4346 can move between the opened and closed positions to facilitate regulation of the air pressure within the piston chamber 4342. For example, the piston 4346 can move to a position that facilitates regulation of the pressure within the piston chamber 4342 to a substantially constant pressure in response to the biasing force from the biasing member 4468, as well as the downward force applied to the piston 4346 from the pressurized fluid through the longitudinal pathway 4368 of the piston 4346.

Referring again to FIGS. 71 and 72, the trigger portion 4304 can include a spring base 4470 that is sandwiched between the housing 4380 and the regulator body 4308. As illustrated in FIGS. 77 and 78, the spring base 4470 can have an upper end 4472 and a lower end 4474. The upper end 4472 can define a recess 4476 into which a spring (not shown) of the trigger portion 4304 can be received. The spring base 4470 can define a bore 4478 that extends between the recess 4476 and the lower end 4474. A first and second sealing members 4484, 4486 (FIG. 72) can be disposed within the respective first and second annular grooves 4450, 4452 of the housing 4308 and sandwiched between the housing 4308 and the spring base 4470. The first and second sealing members 4484, 4486 can be any of a variety of suitable materials, such as an elastomeric material or polytetrafluoroethylene, for example.

The spring base 4470 can be coupled with the housing 4380 (e.g., frictionally coupled) such that the spring base 4470 is pivotable together with the housing 4380 and the outlet collar 4392 between the forward operating position and the reverse operating position. When the housing 4380 and the outlet collar 4392 are in the forward operating position, the bore 4478 of the spring base 4470 can be in fluid communication with the through hole 4448 of the regulator body 4308. When the trigger portion 4304 is actuated, regulated pressurized air can flow through the through hole 4448, and to the motive power source (not shown) to operate the motive power source in the forward direction. When the housing 4380 and the outlet collar 4392 are in the reverse operating position, the bore 4478 of the spring base 4470 can be in fluid communication with the longitudinal flow path 4343 of the regulator body 4308. When the trigger portion 4304 is actuated, unregulated pressurized air can flow through the longitudinal flow path 4343, and to the motive power source (not shown) to operate the motive power source in the reverse direction.

Another embodiment of an impact driver 5040 is shown in FIGS. 79-84. The impact driver 5040 can be similar to, or the same in many respects as, the impact driver 4040 shown in FIGS. 71-78. For example, the impact driver 5040 can include a trigger valve assembly 5300 having a regulator portion 5302 and a trigger portion 5304 disposed within a hollow hand grip 5048. The regulator portion 5302 can include a regulator plug 5306, a regulator body 5308, a piston 5346, a piston stop 5456, and a spring base 5470. As illustrated in FIG. 80, the regulator body 5308 can define a piston chamber 5342 and a longitudinal flow path 5343 adjacent to the piston chamber 5342. As illustrated in FIG. 81, the regulator body 5308 can define a bore 5446 and a through hole 5448. As illustrated in FIG. 82, the spring base 5470 can define a recess 5476 and a bore 5478.

However, referring again to FIG. 81, the regulator body 5308 can define an upper recess 5490 that is in fluid communication with the bore 5446 and the through hole 5448. A sealing member 5492 can be disposed within the upper recess 5490 and can define a first bore 5494 and a second bore 5496. The first bore 5494 can be in fluid communication with the bore 5446 of the regulator body 5308. The second bore 5496 can be in fluid communication with the through hole 5448. The sealing member 5492 can provide an effective seal between the regulator body 5308 and the spring base 5470.

In one embodiment, the regulator plug 5306 can be press fit into the regulator body 5308 to create an effective seal therebetween. In another embodiment, an O-ring (not shown) can be provided between the regulator plug 5306 and the regulator body 5308. The regulator body 5308 can be permitted to slide relative to the hollow hand grip 5048. In such an embodiment, when pressurized air is provided into the regulator plug 5306, the regulator body 5308 can slide upwardly and against the trigger portion to enhance the sealing therebetween.

Referring again to FIG. 79, the trigger portion 5304 can include a housing portion 5380 and an outlet collar portion 5392 that can be similar to, or the same in many respects as, the housing 4380 and the outlet collar portion 4392 of FIGS. 71-72 above. However, the housing portion 5380 and the outlet collar portion 5392 can be provided in a one-piece construction.

It will be appreciated that some of the features described above, such as the pressure regulators (e.g., 82 and 2082) and/or trigger valve assemblies (e.g., 3300, 4300, 5300) can be provided on any of a variety of other types of pneumatic-type impact drivers or other types of pneumatic hand-tools. The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

1. A handheld impact driver comprising:
an air supply port configured for connection to an external source of pressurized air;
a manifold assembly positioned downstream of the air supply port, the manifold assembly comprising a manifold, the manifold defining a manifold inlet port, the manifold inlet port being in selective fluid communication with the air supply port; and
a pressure regulator positioned downstream of the manifold assembly, the pressure regulator comprising a housing and a diaphragm assembly movably coupled with the housing, the housing and the diaphragm assembly cooperating to define a discharge chamber, the housing at least partially defining an inlet chamber, the inlet chamber and the discharge chamber being in at least intermittent fluid communication; wherein:
when the manifold assembly is in a first configuration, the manifold inlet port is in fluid communication with the inlet chamber defined by the pressure regulator to permit the flow of pressurized air to the inlet chamber, the pressure regulator being operable to regulate the pressurized air and discharge regulated, pressurized air at a substantially constant, predetermined pressure; and
when the manifold assembly is in a second configuration, the pressure regulator is bypassed.

2. The handheld impact driver of claim 1, wherein:
the manifold assembly further comprises a first porting valve and a second porting valve, each of the first porting valve and the second porting valve being rotatably coupled with the manifold and being rotatable between a first position and a second position;
when the manifold assembly is in the first configuration, each of the first porting valve and the second porting valve is in the first position; and
when the manifold assembly is in the second configuration, each of the first porting valve and the second porting valve is in the second position.

3. The handheld impact driver of claim 2, wherein:
the manifold further defines a manifold exhaust port;
the manifold assembly further comprises a flange and a manifold gasket, each of the flange and the manifold gasket being attached to the manifold, the manifold gasket being positioned between the flange and the manifold, and defining a first slot and a second slot, the flange defining a third slot and a fourth slot, the third slot being aligned with the first slot, the fourth slot being aligned with the second slot;
the manifold gasket and the manifold cooperate to define a first passage, a second passage, and a third passage;
the first passage is in fluid communication with the inlet chamber defined by the pressure regulator and extends to the first porting valve;
the second passage extends between the first porting valve and the second porting valve;
the third passage is in fluid communication with the discharge chamber defined by the pressure regulator and extends to the second porting valve;
when the manifold assembly is in the first configuration:
the first passage is in fluid communication with the manifold inlet port;
the second passage is in fluid communication with the manifold exhaust port, the second slot defined by the manifold gasket, and the fourth slot defined by the flange, the second passage being fluidically uncoupled from the manifold inlet port by the first porting valve; and
the third passage is in fluid communication with the first slot defined by the manifold gasket and the third slot defined by the flange, the third passage being fluidically uncoupled from the manifold exhaust port by the second porting valve.

4. The handheld impact driver of claim 3 wherein, when the manifold assembly is in the second configuration:
the first passage is fluidically uncoupled from the manifold inlet port by the first porting valve;
the second passage is in fluid communication with the manifold inlet port, the second slot defined by the manifold gasket, and the fourth slot defined by the flange, and is fluidically uncoupled from the manifold exhaust port by the second porting valve; and
the third passage is in fluid communication with the first slot defined by the manifold gasket, the third slot defined by the flange and the manifold exhaust port.

5. The handheld impact driver of claim 1, wherein:
the pressure regulator further comprises a regulator valve assembly coupled with the diaphragm assembly for movement between an opened position and a closed position; and
the inlet chamber and the discharge chamber defined by the pressure regulator are in fluid communication when the regulator valve assembly is in the opened position and are fluidically uncoupled when the regulator valve assembly is in the closed position.

6. The handheld impact driver of claim 5, wherein:
the regulator valve assembly comprises a valve stem, a valve plug, and a return spring;
the housing of the pressure regulator defines a valve seat;
the valve stem comprises a first end portion engaged with the diaphragm assembly, and a second end portion engaged with the valve plug;
the valve stem and the valve plug are movable together with the diaphragm assembly relative to the valve seat;
the pressure regulator further comprises a flow distributor, the flow distributor defining an aperture and a distributor passage;
the aperture receives the valve stem of the regulator valve assembly;
the distributor passage is downstream of the regulator valve assembly;
the distributor passage is in fluid communication with each of the inlet chamber and the discharge chamber when the regulator valve assembly is open; and
the distributor passage is fluidically uncoupled from the inlet chamber when the regulator valve assembly is closed.

7. The handheld impact driver of claim 5, wherein:
the diaphragm assembly comprises a generally central member and an annular flexible member comprising a radially inner portion secured to the generally central member, and a radially outer portion secured to at least the housing of the diaphragm assembly.

8. The handheld impact driver of claim 7, wherein:
the housing of the pressure regulator defines a valve seat;
the regulator valve assembly comprises a valve stem and a valve plug;
the valve stem comprises a first end portion engaged with the generally central member of the diaphragm assembly, and a second end portion engaged with the valve plug; and
the valve stem and the valve plug are movable together with the diaphragm assembly relative to the valve seat.

9. The handheld impact driver of claim 8, wherein:
the manifold is releasably attached to the housing of the pressure regulator;
the manifold and the diaphragm assembly cooperate to define a vented chamber;
the radially outer portion of the flexible member of the diaphragm assembly is positioned between, and secured to, the manifold and the housing of the diaphragm assembly, the flexible member being interposed between the vented chamber and the discharge chamber defined by the housing and the diaphragm assembly;
the pressure regulator further comprises at least one biasing member extending between the manifold and the diaphragm assembly, within the vented chamber, the biasing member exerting a biasing force on the diaphragm assembly; and
the diaphragm assembly is movable in response to the biasing force and a pressure differential between the vented chamber and the discharge chamber.

10. The handheld impact driver of claim 5, further comprising:
a needle valve comprising a first end portion, the first end portion comprising a restricting member, the restricting member being positioned downstream of the discharge chamber defined by the pressure regulator; wherein
the needle valve facilitates selective control of a flow rate of regulated, pressurized air discharging from the discharge chamber.

11. The handheld impact driver of claim 10, further comprising:
a rotary vane motor comprising a rotor, the restricting member of the needle valve being upstream of the rotary vane motor; and
a torquing member, the rotor of the rotary vane motor being drivingly coupled with the torquing member; wherein
the rotor of the rotary vane motor comprises a plurality of circumferentially spaced blades;
the rotary vane motor is configured such that the rotor and the torquing member operably rotate in a first direction in response to regulated, pressurized air, which discharges from the pressure regulator and through the manifold assembly, impinging upon the circumferentially spaced blades; and
the rotary vane motor is configured such that the rotor and the torquing member operably rotate in a second direction in response to pressurized air, which has bypassed the pressure regulator and discharges from the manifold assembly, impinging upon the circumferentially spaced blades, the second direction being opposite the first direction.

12-59. (canceled)

60. A handheld pneumatic tool comprising:
a hollow hand grip;
a trigger valve assembly comprising a trigger valve that is movable between one of a closed position and an opened position;
a trigger coupled with the trigger valve, the trigger being configured to facilitate selective operation of the trigger valve in one of the closed position and the opened position; and
a regulator assembly disposed within the hollow hand grip, the regulator assembly being upstream of the trigger valve and configured to discharge pressurized regulated air to the trigger valve assembly.

61. The handheld pneumatic tool of claim 60 wherein the regulator assembly comprises a piston that is slidably coupled with the hollow hand grip.

62. The handheld pneumatic tool of claim 61 wherein the regulator assembly comprises a regulator body and the piston is slidably coupled with the regulator body.

63. The handheld pneumatic tool of claim 63 wherein:
the regulator body defines a first chamber and a second chamber;
the piston is disposed within the second chamber;
the regulator further comprises a regulator valve stem that is coupled with the piston and slidably coupled with the regulator body;
the regulator valve stem is movable together with the piston between an opened position and a closed position; and
movement of the regulator valve stem between the opened and the closed position facilitates at least intermittent fluid communication between the first chamber and the second chamber.

64. The handheld pneumatic tool of claim 63 wherein:
the regulator valve stem cooperates with the regulator body to define an interior chamber; and
the regulator valve stem is movable between the opened position and the closed position at least in response to a difference in pressure between the first chamber and the interior chamber.

65. The handheld pneumatic tool of claim 64 wherein the regulator body further comprises an end cap and the regulator valve stem cooperates with the end cap to define an interior chamber

66. The handheld pneumatic tool of claim 63 wherein the regulator valve stem defines an internal pathway that is in fluid communication with each of the first chamber and the second chamber.

67. The handheld pneumatic tool of claim 63 wherein the piston is associated with a biasing member.

68. The handheld pneumatic tool of claim 66 wherein the biasing member comprises a plurality of Belleville washers.

69. The handheld pneumatic tool of claim 60 wherein the trigger valve assembly further comprises an outlet collar positioned downstream of the trigger valve, the outlet collar being movable between a first position and a second position to facilitate forward operation of the handheld pneumatic tool and reverse operation of the handheld pneumatic tool, respectively.

70. The handheld pneumatic tool of claim 69 wherein the trigger valve assembly further comprises a flapper valve having a flapper portion that is movable between a first position and a second position in response to movement of the outlet collar between the first position and the second position, respectively.

71. The handheld pneumatic tool of claim 70 wherein the flapper portion is pivotable between the first position and the second position.

72. The handheld pneumatic tool of claim 71 wherein the flapper portion is pivotally coupled with a body of the flapper valve with a living hinge.

73. The handheld pneumatic tool of claim 70 wherein the flapper portion defines a through hole through which pressurized air flows when the flapper portion is in the first position with the outlet collar in the first position.

74. The handheld pneumatic tool of claim 73 further comprising a motor casing and a motive power source disposed within the motor casing, the motor casing defining a first port and a second port, wherein:
the outlet collar defines a first opening and includes an upper surface;
the flapper valve is associated with the first port;
the flapper valve overlies the first opening when the actuator collar is in the first position; and
the flapper valve overlies the upper surface when the actuator collar is in the second position.

75. The handheld pneumatic tool of claim 74 wherein:
when the outlet collar is in the first position, pressurized air flows through the first opening, through the through hole of the flapper valve, and through the first port to the motive power source, and exhaust air flows from the motive power source, through the second port, and to the upper surface such that the motive power source operates in a first direction; and
when the outlet collar is in the second position, pressurized air flows through the second opening and through the second port to the motive power source, and exhaust air flows from the motive power source, through the first port, through the flapper valve, and to the upper surface such that the motive power source operates in a second direction that is different from the first direction.

76. The handheld pneumatic tool of claim 75 wherein the hollow hand grip defines an exhaust chamber through which the exhaust air flows.

77-82. (canceled)
